(19) United States
(12) Patent Application Publication
(10) Pub. No.: US 2004/0073773 A1
(43) Pub. Date: Apr. 15, 2004

(54) Vector processor architecture and methods performed therein

(76) Inventor: Victor Demjanenko, Pendleton, NY (US)

Correspondence Address: SIMPSON & SIMPSON, PLLC, 5555 MAIN STREET, WILLIAMSVILLE, NY, 14221-5406, US

(21) Appl. No.: 10/467,225

(22) PCT Filed: Feb. 6, 2002
(86) PCT No.: PCT/US02/20645

(51) Int. Cl. G06F 15/00

(52) U.S. Cl. 712/7; 712/23

(57) ABSTRACT

A novel vector processor architecture, and hardware and processing features associated therewith, provide both vector processing and superscalar processing features.

This non-provisional patent application claims the benefit of priority under 35 U.S.C. Section 119(e) of U.S. Provisional Patent Application No. 60/266,706, filed on Feb. 6, 2001 and Provisional Patent Application No. 60/275,296, filed on Mar. 13, 2001, both of which are incorporated herein by reference.

### FIELD OF THE INVENTION

The present invention relates to vector processors.

### BACKGROUND OF THE INVENTION

Conventional computer architectures include pipelined processors, VLIW processors, superscalar processors, and vector processors. The characteristic features and limitations of these architectures are described in “Advanced Computer Architectures: A Design Space Approach,” D. Sima et al., Addison-Wesley, 1997, the entirety of which is incorporated herein by reference for its teachings regarding the features of the aforementioned conventional architectures.

### SUMMARY OF THE INVENTION

The present invention involves a novel vector processor architecture, and hardware and processing features associated therewith. In general terms, the invention may be understood to pertain to a vector processing architecture that provides both vector processing and superscalar processing features.

A vector processor as described herein may perform both vector processing and superscalar register processing. In general this processing may comprise fetching instructions from an instruction stream, where the instruction stream comprises vector instructions and register instructions. The type of a fetched instruction is determined, and if the fetched instruction is a vector instruction, the instruction is routed to decoders of the vector processor in accordance with functional units used by the vector instruction. If the fetched instruction is a register instruction, a vector element slice of the vector processor that is associated with the register instruction is determined, one or more functional units that are associated with the register instruction are determined, and the register instruction is routed to the functional units of the vector element slice. These functional units may be instruction decoders associated with said functional units and said vector element slice.

A vector processor as described above may comprise a plurality of vector element slices, each comprising a plurality of functional units, and a plurality of instruction decoders, each associated with a functional unit of one of the vector element slices, for providing instructions to an associated functional unit. The vector processor may further comprise a vector instruction router for routing a vector instruction to all instruction decoders associated with functional units used by said vector instruction, and a register instruction router for routing a register instruction to instruction decoders associated with a vector element slice and functional units associated with the register instruction.

A vector processor as described herein may also create Very Long Instruction Words (VLIW) from component instructions. In general this processing may comprise fetching a set of instructions from an instruction stream, the instruction stream comprising VLIW component instructions, and identifying VLIW component instructions according to their respective functional units. The processing may further comprise determining a group of VLIW component instructions that may be assigned to a single VLIW, and assigning the component instructions of the group to a specific positions of a VLIW instruction according to their respective functional units. Identifying VLIW component instructions may be preceded by determining whether each of fetched instructions is a VLIW component instruction. Determining whether a fetched instruction is a VLIW component instruction may be based on an instruction type and an associated functional unit of the instruction, and instruction types may include vector instructions, register instructions, load instructions or control instructions. The component instructions may include vector instructions and register instructions.

A vector processor that forms Very Long Instruction Words (VLIW) from VLIW component instructions of an instruction stream as described herein may be designed by defining a set of VLIW component instructions, each component instruction being associated with a functional unit of the vector processor, defining grouping rules for VLIW component instructions that associate component instructions that may be executed in parallel, and defining associations between VLIW component instructions and specific positions of a VLIW instruction based on the functional unit of the component instruction.

A vector processor as described herein that forms Very Long Instruction Words (VLIW) from VLIW component instructions of an instruction stream may comprise a plurality of vector element slices, each comprising a plurality of functional units, and a plurality of instruction decoders, each associated with a functional unit of one of the vector element slices, for providing instructions to an associated functional unit. The processor may further include a plurality of routers, each associated with a type of said functional units, for routing instructions to a decoder associated with a functional unit of the routed instruction, a plurality of pipeline registers, each corresponding to a type of said functional units, for storing instructions provided by instruction decoders corresponding to the same type of functional unit, and a plurality of instruction grouping decoders, for receiving instructions from an instruction stream and providing groups of VLIW component instructions of said stream to said plurality of routers. The VLIW instruction is comprised of the instructions stored in the respective pipeline registers.

A processor as described herein may also implement a method to deliver an instruction window, comprising a set of instructions, to a superscalar instruction decoder. The method may comprise fetching two adjacent lines of instructions that together contain a set of instructions to be delivered to the superscalar instruction decoder, each of the lines being at least the size of the set of instructions to be delivered, and reordering the positions of instructions of the two adjacent lines so as to position first and subsequent elements of the set of instructions to be delivered into first and subsequent positions corresponding to first and subsequent positions of the superscalar instruction decoder. Reordering the positions of the instructions may involve rotating the positions of said instructions within the two adjacent lines. The first line may comprise a portion of the set of instructions and the second line may comprise a remaining portion of the set of instructions.

Alternatively, the method may obtain a line of instructions containing at least a set of instructions to be provided to the superscalar instruction decoder, provide the line of instructions to a rotator network along with a starting position of said set of instructions within the line, the rotator network having respective outputs coupled to inputs of a superscalar instruction decoder, and control the rotator network in accordance with the starting position of the set of instructions to output the first and subsequent instructions of the set of instructions to first and subsequent inputs of the superscalar decoder.

In a further alternative, the method may obtain at least a portion of a first line of instructions containing at least a portion of a set of instructions to be delivered to the superscalar instruction decoder, obtain at least a portion of a second line of instructions containing at least a remaining portion of said set of instructions, provide the first and second lines of instructions to a rotator network along with a starting position of the set of instructions, the rotator network having respective outputs coupled to inputs of a superscalar instruction decoder, and control the rotator network in accordance with the starting position of the set of instructions to output the first and subsequent instructions of the set of instructions to first and subsequent inputs of the superscalar decoder. Each line may contain the same number of instruction words as contained in an instruction window, or may contain more instruction words than contained in an instruction window.

Similarly, a processor as described herein may comprise a memory storing lines of superscalar instructions, a rotator for receiving at least portions of two lines of superscalar instructions that together contain a set of instructions, and a superscalar decoder having a set of inputs for receiving corresponding first and subsequent instructions of a superscalar instruction window, the rotator network providing the first and subsequent superscalar instructions of the instruction window from within the at least portions of two lines of instructions to the corresponding inputs of the superscalar decoder. The rotator may comprise a set of outputs corresponding in number to the number of superscalar instructions in a superscalar instruction window, and further corresponding to positions of instructions within the at least portions of two lines of instructions within the rotator. The rotator network may reorder the instructions of the at least portions of two lines of superscalar instructions within the rotator network to associate the first and subsequent superscalar instructions of the superscalar instruction window with first and subsequent outputs of the rotator network coupled to corresponding inputs of the superscalar decoder. The rotator network may reorder the positions of the instructions by rotating the instructions of the at least portions of two lines within the rotator. The reordering may be performed in accordance with a known position of a first instruction of the instruction window within the at least portions of two lines.

A processor as described herein may also implement a method to address a memory line of a non-power of 2 multi-word wide memory in response to a linear address. The method may involve shifting the linear address by a fixed number of bit positions, and using high order bits of a sum of the shifted linear address and the unshifted linear address to address a memory line. The linear address may be shifted to the right or the left to achieve the desired position.

In an alternative method, the method may involve shifting the linear address by a fixed number of bit positions, adding the shifted linear address to the unshifted linear address to form an intermediate address, retaining a subset of high order address bits of the intermediate address as a modulo index, and using low order address bits of the intermediate address and the modulo index in a conversion process to obtain a starting position within a selected memory line. The conversion process may use a look-up table or a logic array.

In a further alternative method, the method may involve shifting the linear address by a fixed number of bit positions, adding the shifted linear address to the unshifted linear address to form an intermediate address, retaining a subset of low order address bits of the intermediate address as a modulo index, and using the modulo index in a conversion process to obtain a starting position within a selected memory line.

In another alternative method, the method may involve isolating a subset of low order address bits of the linear address as a modulo index, and using the modulo index in a conversion process to obtain a starting position within a selected memory line.

A processor as described herein may further perform an operation on first and second operand data having respective operand formats. The device may comprise a first hardware register specifying a type attribute representing an operand format of the first data, a second hardware register specifying a type attribute representing an operand format of the second data, an operand matching logic circuit determining a common operand format to be used for both of the first and second data in performing the operation based on the first type attribute of the first data and the second type attribute of the second data, and a functional unit that performs the operation in accordance with the common operand type.

A related method as described herein may include specifying an operation type attribute representing an operation format of the operation, specifying in a hardware register an operand type attribute representing an operand format of data to be used by the operation, determining an operand conversion to be performed on the data to enable performance of the operation in accordance with the operation format based on the operation format and the operand format of the data, and performing the determined operand conversion. The operation type attribute may be specified in a hardware register or in a processor instruction. The operation format may be an operation operand format or an operation result format.

A related method as described herein may include specifying in a hardware register an operation type attribute representing an operation format, specifying in a hardware register an operand type attribute representing a data operand format, and performing the operation in a functional unit of the computer in accordance with the specified operation type attribute and the specified operand type attribute. The operation format may be an operation operand format or an operation result format A related method as described herein may provide an operation that is independent of data operand type. The method may comprise specifying in a hardware register an operand type attribute representing a data operand format of said data operand, and performing the operation in a functional unit of the computer in accordance with the specified operand type attribute. Alternatively, the method may comprise specifying in a first hardware register an operand type attribute representing an operand format of a first data operand, specifying in a second hardware register an operand type attribute representing an operand format of a second data operand, determining in an operand matching logic circuit a common operand format to be used for both of the first and second data in performing the operation based on the first type attribute of the first data and the second type attribute of the second data, and performing the operation in a functional unit of the computer in accordance with the determined common operand.

A related method for performing operand conversion in a computer device as described herein may comprise specifying in a hardware register an original operand type attribute representing an original operand format of operand data, specifying in a hardware register a converted operand type attribute representing a converted operand format to which the operand data is to be converted, and converting the data from the original operand format to the converted operand format in an operand format conversion logic circuit in accordance with the original operand type attribute and the converted operand type attribute. The operand conversion may occur automatically when a standard computational operation is requested. The operand conversion may implement sign extension for an operand having an original operand type attribute indicating a signed operand, zero fill for an operand having an original operand type attribute indicating an unsigned operand, positioning for an operand having an original operand type attribute indicating operand position, positioning for an operand in accordance with a converted operand type attribute indicating a converted operand position, or one of fractional, integer and exponential conversion for an operand according to the original operand type attribute or the converted operand type attribute.

Another method in a device as described herein may conditionally perform operations on elements of a vector. The method may comprise generating a vector enable mask comprising a plurality of bits, each bit corresponding to a respective element of a vector, generating a vector conditional mask comprising a plurality of bits, each bit corresponding to a respective element of a vector, and, for each of the elements, applying logic to the vector enable mask bit and vector conditional mask bit that correspond to that element to determine if an operation is to be performed for that element. The logic may require the vector enable bit corresponding to an element to be set to enable an operation on the corresponding element to be performed.

A related method as described herein may nest conditional controls for elements of a vector. The method may comprise generating a vector enable mask comprising a plurality of bits, each bit corresponding to a respective element of a vector, generating a vector conditional mask comprising a plurality of bits, each bit corresponding to a respective element of a vector, saving the vector enable mask to a temporary storage location, generating a nested vector enable mask comprising a logical combination of the vector enable mask with the vector conditional mask, and using the nested vector enable mask as a vector enable mask for a subsequent vector operation. The logical combination may use a bitwise “and” operation, a bitwise “or” operation, a bitwise “not” operation, or a bitwise “pass” operation.

An alternative method may comprise generating a vector enable mask comprising a plurality of bits, each bit corresponding to a respective element of a vector, generating a vector conditional mask comprising a plurality of bits, each bit corresponding to a respective element of a vector, saving the vector enable mask to a temporary storage location, generating a nested vector enable mask by performing a bitwise “and” of the vector enable mask with the vector conditional mask, and using the nested vector enable mask as a vector enable mask for a subsequent vector operation.

A further alternative method may comprise generating a vector enable mask comprising a plurality of bits, each bit corresponding to a respective element of a vector, generating a vector conditional mask comprising a plurality of bits, each bit corresponding to a respective element of a vector, saving the vector enable mask to a temporary storage location, generating a nested vector enable mask by performing a bitwise “and” of the vector enable mask with a bitwise “not” of the vector conditional mask, and using the nested vector enable mask as a vector enable mask for a subsequent vector operation.

A device as described herein may also implement a method to improve responsiveness to program control operations. The method may comprise providing a separate computational unit designed for program control operations, positioning the separate computational unit early in the pipeline thereby reducing delays, and using the separate computation unit to produce a program control result early in the pipeline to control the execution address of a processor.

A related method may improve the responsiveness to an operand address computation. The method may comprise providing a separate computational unit designed for operand address computations, positioning said separate computational unit early in the pipeline thereby reducing delays, and using said separate computation unit to produce a result early in the pipeline to be used as an operand address.

A vector processor as described herein may further comprise a vector of multipliers computing multiplier results; and an array adder computational unit computing an arbitrary linear combination of the multiplier results. The array adder computational unit may have a plurality of numeric inputs that are added, subtracted or ignored according to a control vector comprising the numeric values 1, −1 and 0, respectively. The array adder computational unit may comprise at least 4 or at least 8 inputs, and may comprise at least 4 outputs.

A device as described herein may further provide an indication of a processor attempt to access an address yet to be loaded or stored. The device may comprise a current bulk transfer address register storing a current bulk transfer address, an ending bulk transfer address register storing an ending bulk transfer address, a comparison circuit coupled to the current bulk transfer address register and the ending bulk transfer address register, and to the processor, to provide a signal to the processor indicating whether an address received from the processor is between the current bulk transfer address and the ending bulk transfer address. The device may further produce a stall signal for stalling the processor until transfer to the address received from the processor is complete, or an interrupt signal for interrupting the processor to inform the processor that data at the address is unavailable.

A related device may comprise a current bulk transfer address register storing a current bulk transfer address, and a comparison circuit coupled to the current bulk transfer address register and to the processor to provide a signal to the processor indicating whether a difference between the current bulk transfer address and an address received from the processor is within a specified stall range. The signal produced by the device may be a stall signal for stalling the processor until transfer to the address received from the processor is complete, or an interrupt signal for interrupting the processor to inform the processor that data at the address is unavailable.

A device as described herein may further implement a method of controlling processing, comprising receiving an instruction to perform a vector operation using one or more vector data operands, and determining a number of vector data elements of the one or more vector data operands to be processed by the vector operation based on a number of vector data elements that constitute each vector data operand and a number of hardware elements available to perform the vector operation. Where multiple operations are involved, the method may comprise receiving instructions to perform a plurality of vector operations, each vector operation using one or more vector data operands, for each of the plurality of vector operations, determining a number of vector data elements of each of the one or more vector data operands to be processed by the vector operation based on a number of vector data elements that constitute each vector data operand of the operation and a number of hardware elements available to perform the vector operation, and determining a number of vector data elements to be processed by all of the plurality of operations by comparing the number of vector data elements to be processed for each respective vector operation.

A device as described herein may also implement a method for performing a vector operation on all data elements of a vector, comprising: setting a loop counter to a number of vector data elements to be processed, performing one or more vector operations on vector data elements of the vector, determining a number of vector data elements processed by the vector operations, subtracting the number of vector data elements processed from the loop counter, determining, after subtraction, whether additional vector data elements remain to be processed, and if additional vector data elements remain to be processed, performing further vector operations on remaining data elements of the vector. The method may further include reducing a number of vector data elements processed by the vector processor to accommodate a partial vector of data elements on a last loop iteration.

A related method for reducing a number of operations performed for a last iteration of a processing loop may comprise setting a loop counter to a number of vector data elements to be processed, performing one or more vector operations on data elements of the vector, determining a number of vector data elements processed by the vector operations, subtracting the number of vector data elements processed from the loop counter, determining, after subtraction, whether additional vector data elements remain to be processed, and if additional vector data elements remain to be processed, and the number of additional vector data elements to be processed is less than a full vector of data elements, reducing one of available elements used to perform the vector operations and vector data elements available for the last loop iteration.

A device as described herein may also implement a method for controlling processing in a vector processor that comprises performing one or more vector operations on data elements of a vector, determining a number of data elements processed by the vector operations, and updating an operand address register by an amount corresponding to the number of data elements processed.

A device as described herein may also implement a method for performing a loop operation. The method may comprise storing, in a match register, a value to be compared to a monitored register, designating a register as the monitored register, comparing the value stored in the match register with a value stored in the monitored register, and responding to a result of the comparison in accordance with a program-specified condition by one of branching or repeating a desired sequence of program instructions, thereby forming a program loop. The program specified condition may be one of equal to, not equal to, less than, less than or equal to, greater than, or greater than or equal to. The register to be monitored may be an address register. The program-specified condition may be an absolute difference between the value stored in the match register and the value stored in the address register, and responding to the result of the comparison may further comprise reducing a number of vector data elements to be processed on a last iteration of a loop.

A device as described herein may also implement a method of processing interrupts. The method may comprise monitoring an interrupt line for a signal indicating an interrupt to the superscalar processor, upon detection of an interrupt signal, fetching a group of instructions to be executed in response to the interrupt, and inhibiting in hardware an address update of a program counter, and executing the group of instructions. The group of instructions may include an instruction to disable further interrupts and an instruction to call a routine.

A device as described herein may therefore perform a method comprising receiving an instruction, determining whether a vector satisfies a condition specified in the instruction, and, if the vector satisfies the condition specified in the instruction, branching to a new instruction. The condition may comprise a vector element condition specified in at least one of a vector enable mask and a vector condition masks.

A device as described herein may also implement a method of providing a vector of data as a vector processor operand. The method may comprise obtaining a line of data containing at least a vector of data to be provided as the vector processor operand, providing the line of data to a rotator network along with a starting position of said vector of data within the line, the rotator network having respective outputs coupled to vector processor operand data inputs, and controlling the rotator network in accordance with the starting position of the vector of data to output the first and subsequent data elements of the vector of data to first and subsequent operand data inputs of the vector processor.

A related method may comprise obtaining at least a portion of a first line of vector data containing at least a portion of a vector processor operand, obtaining at least a portion of a second line of vector data containing at least a remaining portion of said vector processor operand, providing the at least a portion of said first line of vector data and the at least a portion of said second line of vector data to a rotator network along with a starting position of said vector data, the rotator network having respective outputs coupled to vector processor operand data inputs, and controlling the rotator network in accordance with the starting position of the vector data to output the first and subsequent vector data elements to first and subsequent operand data inputs of the vector processor.

A device as described herein may also implement a method to read a vector of data for a vector processor operand. The method may comprise reading into a local memory device a series of lines from a larger memory, obtaining from the local memory device at least a portion of a first line containing a portion of a vector processor operand, obtaining from the local memory device at least a portion of a second line containing a remaining portion of the vector processor operand, providing the at least a portion of the first line of vector data and the at least a portion of the second line of vector data to a rotator network along with a starting position of the vector data, the rotator network having respective outputs coupled to vector processor operand data inputs, and controlling the rotator network in accordance with the starting position of the vector data to output first and subsequent vector data elements to first and subsequent vector processor operand data inputs.

A variety of additional hardware and process implementations in accordance with embodiments of the invention will be apparent from the following detailed description.

### BRIEF DESCRIPTION OF THE SEVERAL VIEWS OF THE DRAWINGS

FIG. 1 shows a L-Hardware Element Vector Processor or L-Slice Super-Scalar Processor;

FIG. 2 shows the Main Functional Units;

FIG. 3 shows the Processor Pipeline;

FIG. 4 shows the Placement Positions;

FIG. 5 shows a VMU Element Pair,

FIG. 6 shows High Word Detect Logic;

FIG. 7 shows Basic Multiplier Cell;

FIG. 8 shows a Summation Network;

FIG. 9 shows an Array Adder Element,

FIG. 10 shows an Array Adder Element Segments and Placement;

FIGS. 11a and 11b show an AAU Operand Promotion;

FIG. 12 shows an Optimized Array Adder Element;

FIG. 13 shows a VALU Element;

FIG. 14 shows a VALU Element Segments and Placement;

FIGS. 15a and 15b show a VALU Operand Promotion;

FIG. 16 shows a Demotion/Promotion Process;

FIG. 17 shows a Fractional/Integer Value Demotion;

FIG. 18 shows a Size Demotion Hardware;

FIG. 19 shows the Packer,

FIG. 20 shows the Spreader,

FIG. 21 shows a Size Promotion Hardware;

FIG. 22 shows the Detailed Processor Pipeline;

FIG. 23 shows the Overall Processor Data Flows;

FIG. 24 shows a Double Clocked Memory Access Plan;

FIG. 25 shows the Vector Prefetch and Load Units;

FIG. 26 shows the Detailed Vector Prefetch and Load Units;

FIG. 27 shows a Vector Rotator and Alignment;

FIG. 28 shows a Vector Rotator Control;

FIG. 29 shows a Vector Operand Alignment Examples;

FIG. 30 shows a Vector Operand Prefetch;

FIG. 31 shows a Processor Pipeline Operation;

FIG. 32 shows a Processor Pipeline Operation;

FIG. 33 shows a Bulk Memory Transfer Hazard Detection;

FIG. 34 shows the Instruction Prefetch and Fetch Units;

FIG. 35 shows the Instruction Fetch Alignment;

FIG. 36 shows the Detailed Instruction Prefetch and Fetch Units;

FIG. 37 shows an Instruction Rotator;

FIG. 38 shows an Instruction Rotator Control;

FIGS. 39a and 39b show an Instruction Grouping, Routing and Decoding;

FIG. 40 shows a Non-Power of 2 Memory Access;

FIG. 41 shows a Non-Power of 2 Memory Access Alternative Implementation 1;

FIG. 42 shows a Non-Power of 2 Memory Access Alternative Implementation 2;

FIG. 43 shows a Full 16 Element Rotator;

FIG. 44 shows 11 Element to 10 Position Rotator.

FIG. 45 shows a Fractional Memory Alignment.

### Definitions

Functional Unit—Dedicated hardware defined for certain tasks (functions). May refer to individual functional unit elements or to a vector of functional units.

Computational Unit—Dedicated hardware (functional unit) designed for arithmetic operations. For example, the VALU is a computational unit with its main purpose being arithmetic operations.

Execution Unit—Same as a computational unit.

Element—Hardware or a vector can be broken down into word size units. These units are referred to as elements.

Hardware Element—A computational/execution unit is composed of duplicated hardware blocks called hardware elements. For example, the VALU can add 8 words because it has 8 duplicated hardware elements that each add a word. Hardware elements are always 32 bits.

Data Element—Refers to data components of a data vector. Data elements may be in all the different sizes supported by the processor, 8, 16 or 32 bit.

Slice—A set of hardware related to a particular element of the vector processor. In Register Mode, a slice is usually selected by a particular destination register (R_{d}).

Segment—A portion of a hardware element of the vector processor that allows processing of a smaller width operand. A single segment is used to operate on 8-bit elements (12-bits with guard). A pair of segments are used together are used to operate on 1 bit elements (24-bits with guard). Finally, all four segments are used to operate on a 32-bit element (48-bits with guard).

Integer—An ordinary number (natural number) that may be all positive values (unsigned) or have both positive and negative values (signed).

Fractional—A common representation used to express numbers in the range of [−1, 1) as a signed fractional number or [0, 2) as an unsigned fractional number. The most significant bit of the fractional number contains either a sign bit (f r a signed fractional number) or an integer bit (for an unsigned fractional number). The next most two significant bits represent the fractions ½ and ¼ respectively and so on.

Exponential—A conventional floating-point number in IEEE single or double precision format. (The conventional name, “float” is not used as the single letter representation “F” is used for Fractional, hence, the name Exponential is used.)

### Conventions

L—Usually refers to the hardware vector length. May refer to a Low piece of data when used as a subscript.

H—Refers to a High piece of data when used as a subscript.

G—Refers to the Guard bits in the extended precision registers.

[n:m]—Represents a range of registers or bits arranged from the most significant, “a”, to the least significant, “m”.

### DETAILED DESCRIPTION OF THE INVENTION

A preferred embodiment of the invention and various design alternatives are disclosed herein. In this disclosure, the preferred embodiment is referred to by its commercial name “Tolon Vector Engine (TOVEN)” or “TOVEN”.

### Section 1. Introduction

1.1 Overview

The Tolon Vector Engine (TOVEN) processor family uses an expandable base architecture optimized for digital signal processing (DSP) and other numeric intensive applications. Specifically the vector processor has been optimized for neural networks, FFT's, adaptive filters, DCT's, wavelets, Virterbi trellis, Turbo decoding, and in general linear algebra intensive algorithms. Through the use of super-scalar instruction execution, control operations common in the physical layer processing for applications such as 802.11afb/g wireless, GPRS and XDSL (ADSL, HDSL and VDSL) may be accommodated with a complementary performance increase. Multi-channel algorithm implementations for speech and wireline modems are supported through the consistent use of guarded operations.

The TOVEN processor family is implemented as a super-scalar pipelined parallel vector processor using RISC-like instruction encoding. RISC instructions are generally regular, easy to decode, and can be quickly categorized by TOVEN decoder. Certain instruction categories may require more complex decoding than others and this is provided after the grouping. All instructions (with encoded operands) are currently 16 bits. Some non-vector instructions may specify an optional 16 or 32-bit constant following the instruction.

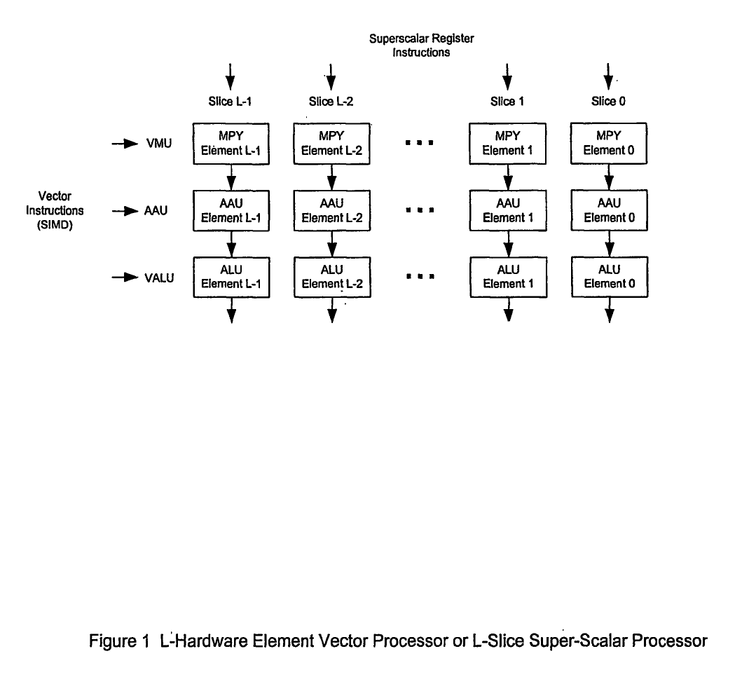

The processor may operate in either Vector or Super-scalar mode (referred to as Register mode). FIG. 1 illustrates the concurrent assignment of functional units for Vector mode and independent use of hardware “slices” in Register mode.

The processing of data in Vector mode is SIMD (single instruction, multiple data) using multiple hardware elements. These processing hardware elements are duplicated to permit the parallel processing of data in Vector mode but also provide independent element “slices” for Register mode. Where processing hardware is not duplicated, pipeline logic is implemented to automatically reuse the available hardware within a pipeline stage to implement the programmer-specified operation transparently using two or more clock cycles rather than a single cycle.

In Vector mode 8, 16 or 32-bit data sizes are supported and a fixed size of 32 bit is used for Register mode. The native hardware elements operate on a 32-bit word size (optional 64 bit in future versions). As a super-scalar processor, up to 8 instructions may be issued in a single clock cycle. Depending on the processor mode, Vector or Register, instructions are assigned to a particular instruction decoder. In Register mode, a traditional model is used whereby the instructions are assigned to the functional unit to which they pertain. As a novel implementation within a vector processor, the instructions in Register mode are directed through a “slice” of the vector-processing pipeline, where each “slice” normally corresponds to an element of the resulting vector. This permits super-scalar processing to exploit all hardware elements of the vector processor. Hence with an 8 hardware element vector processor, the super-scalar processor may dispatch up to 8 instructions per clock cycle.

In Vector mode, the processor groups and assembles vector instructions from the super-scalar instruction stream and creates a very wide, multistage pipeline-instruction which operates in lock-step order on the various components of the vector processor. EPIC and VLIW instruction processors may offer similar vector performance using the technique of loop unrolling but this requires many registers and an unnecessary large code size. Along with the complication of programming all operations in these very long instruction words, VLIW and EPIC processors further impose restricted combinations of instructions which a programmer or compiler must honor. With the TOVEN, assembling the multistage pipeline-instruction from smaller constituent vector instructions (primitive instructions) allows a programmer to specify only those operations required without a need for filler functional-unit specific NOP's. Loop-unrolling is not needed since an instruction is multistage whereas a VLIW processor usually requires N-loop unrolls and N-times more registers to get similar performance to an N-multstage instruction.

The TOVEN processor is well suited for pipelined operations. In a standard configuration, each functional unit occupies its own pipeline stage. This standard implementation uses an 11-stage pipeline. With the use of vector element-guarded operations, the vector-processing pipeline is well suited for super-pipelining whereby the number of pipeline stages may be 3 to 4× while the clock rate may be increased into the GHz range. In order to provide responsiveness for program control purposes, a simple Scalar ALU is provided with a short pipeline. Program control logic, address computations and other simple general calculations and logic may be implemented in the Scalar ALU and results are immediately available early in the pipeline.

Where necessary the pipeline implements a distributed control and hazard detection model to resolve resource contention, operand hazards and simulation of additional parallel hardware. Implementation of hardware-based control allows programs to be developed independently and isolated from avoidance of hazard conditions. Of course the best program would exploit full knowledge of hazard and avoid them where possible, but a programmer-friendly softly degraded performance is far better than a hard error condition.

This manual provides a description of the processor family architecture, complete reference material for programmers and software examples for common signal, image and other applications. Additional application information is available in a companion manual.

1.1.1 Configurations

Table 1-1 shows the architecture configuration options for the Tolon Vector Engine Processor Family.

TABLE 1-1
TOVEN Processor Family Features

| Feature | 160132 | 160432 | 160816 | 160832 | 321632 |
|---|---|---|---|---|---|
| Availability | On | On | On | Now | Future |
| | Request | Request | Request | | |
| Class | Scalar | Superscalar | Vector | Vector | Vector |
| | | | Superscalar | Superscalar | Superscalar |
| Instructions Issued | 1 | Up to 4 | Up to 8 | Up to 8 | Up to 8 or more |
| per Cycle | | | | | |
| Instruction Size | 16 | 16 | 16 | 16 | 32 |
| (bits) | | | | | |
| Data Size (bits) | 32/16/8 | 32/16/8 | 16/8 | 32/16/8 | 32/16/8 |
| | | | | | (64 optional) |
| Max Vector Size | 0 | Upto 64 bit | 64 or 128 bit | 256 bit | 256 or 512 bit |
| Superscaler Slices | 1 | 1 to 4 | 4 or 8 | 8 | 8 or 16 |
| Data Type | | | | | |
| Integer | ° | ° | ° | ° | ° |
| Fractional | ° | ° | ° | ° | ° |
| Exponential | | | | Optional | Optional |
| Multiplier Elements | One | One to Four | Four or Eight | Four or Eight | Eight or Sixteen |
| and Word Size | 32 × 32 bit | 32 × 32 bit | 16 × 16 bit | 32 × 32 bit | 32 × 32 bit |
| Array Adder | None | None | Four or Eight 24 | Four or Eight | Eight or Sixteen |
| Elements and Word | | | bit | 48 bit | 48 bit |
| Size + Guard Bits | | | | | |
| ALU Elements and | One 48 bit | One to Four | Four or Eight | Eight | Eight or Sixteen |
| Word Size + Guard | | 48 bit | 24 bit | 48 bit | 48 bit |
| Bits | | | | | |

The TOVEN operates on vectors (size=#elements*word size) by exploiting the ability to have very wide on-chip memories allowing parallel fetches of data vectors. The number of hardware elements and the width of the data memories are configurable based on the acceleration necessary. These sizes need not be powers of two.

1.1.2 Operands

The TOVEN processor family is designed for the efficient support of DSP algorithms. 8, 16 and 32-bit sizes (Byte, Half-Word and Word) as signed/unsigned integer or fractional types are supported. Optional data formats include long integer or fractional (64 bit), compact floating point (16 bit in 6.10 format), IEEE single precision (32 bit) and IEEE double precision (64 bit) floating point operands. Extended precision accumulation for integer and fractional is supported with the following ranges: 48 bit for accumulating 32-bit numbers, 24 bit for accumulating 16-bit numbers, and 12 bit for accumulating 8-bit numbers. Rounding and shift operations are supported as per the ETSI basic speech primitives and for clipping/limiting of video data. The processor addressing modes (used for loading and storing registers) support post-address modification by positive or negative steps. Circular buffer addressing is also supported in hardware as part of the post-addressing operations. The Table 1-2 summarizes the different data operand types, sizes, and formats.

TABLE 1-2
Operand Types, Sizes, Formats and Placement

| Type | Sign | Size | Format |
|---|---|---|---|
| Integer | Signed | Byte | S.7.0 |
| | | Half-Word | S.15.0 |
| | | Word | S.31.0 |
| | | Long | S.63.0 |
| Integer | Unsigned | Byte | 8.0 |
| | | Half-Word | 16.0 |
| | | Word | 32.0 |
| | | Long | 64.0 |
| Fractional | Signed | Byte | S.7 |
| | | Half-Word | S.15 |
| | | Word | S.31 |
| | | Long | S.63 |
| Fractional | Unsigned | Byte | 1.7 |
| | | Half-Word | 1.15 |
| | | Word | 1.31 |
| | | Long | 1.63 |
| Exponential | | Compact | S.5.10 |
| | | Single | S.8.23 + 1 |
| | | Double | S.11.52 + 1 |

The TOVEN uses strongly typed operands and automatically performs type conversions (type-casting) according to the desired operation result. This is accomplished by “tagging” the data format in the appropriate registers. This tagging can be done manually or automatically allowing the programmer to take advantage of this feature or to treat it as transparent. This data format “tagging” is implicitly performed by most computer languages (such as C/C++) according to built-in rules for operating with mixed operands.

1.1.3 Functional Units

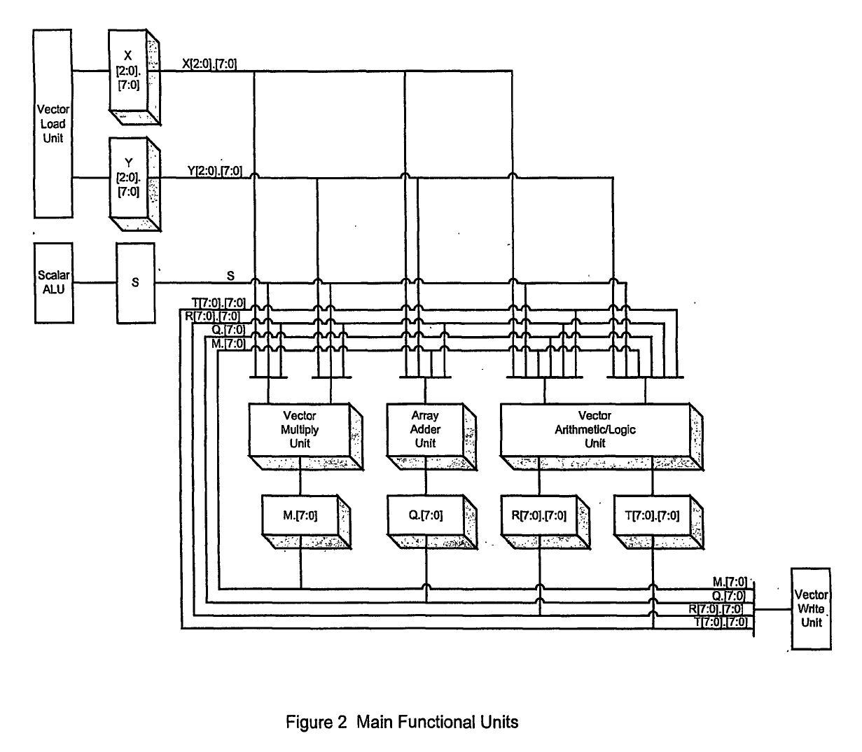

The main functional units in the Tolon Vector Engine Architecture are shown in FIG. 2.

The notation used is:

[register].[element] or X[register high:low].[element high:low]

.[element] or M.[element high:low]

Vector Computational Units—The processor uses three independent computational units: a Vector Multiplier Unit (VMU), an Array Adder Unit (AAU) and Vector Arithmetic/Logic Unit (VALU)

Scalar Computational Unit—The processor uses a scalar Arithmetic/Logic Unit (SALU) for program control flow and assisting with initial address computations.

Vector Operands—X0, X1 and X2 are the X vector operands, Y0, Y2 and Y3 are the Y vector operands.

Vector Results—M is the vector result from the VMU, Q is the vector result from the AAU, R is the primary result from the VALU, T contains secondary results (such as division quotient) from the VALU.

Data Address Generators—Dedicated multiple address generators supply addresses for X and Y vector operand access and result (M, Q, R, T) storage.

Program Sequencer—A program sequencer fetches groups of instructions for the superscalar instruction decoder. The sequencer supports XXX-cycle conditional branches and executes program loops with no overhead.

Memory—Harvard organization with separate instruction and data memory. Data memory is unified with multiple access ports to be compiler and programmer-friendly.

In Vector mode, using a multistage pipeline effectively achieves the following in a single cycle:

Generate the next program address

Fetch the next instruction

Perform one double length vector operand read (effectively reading two operand vectors)

Perform one vector operand write

Update up to three data address pointers (with optional circular buffer logic).

Perform a vector multiply operation of four 32-bit elements, eight 16-bit elements or sixteen 8-bit elements

Perform an array addition operation of eight 32-bit elements (sixteen 16-bit elements requires two cycles but the second cycle is usually pipelined into the next instruction)

Perform a vector arithmetic/logic operation of eight 32-bit elements, sixteen 16 bit elements or thirty two 8-bit elements

Perform a scalar ALU computation

Implement a program loop

In a single cycle, all elements of each unit (such as the VMU, AAU, VALU) execute an element operation. Approximately 30 operations (16-bit multiplications, 32-bit accumulations) may be performed (not including operations associated with updating of pointers). At a 200 MHz clock, this represents 6,000 equivalent scalar MIPS and is sustainable for many DSP applications.

1.1.4 Pipeline Organization

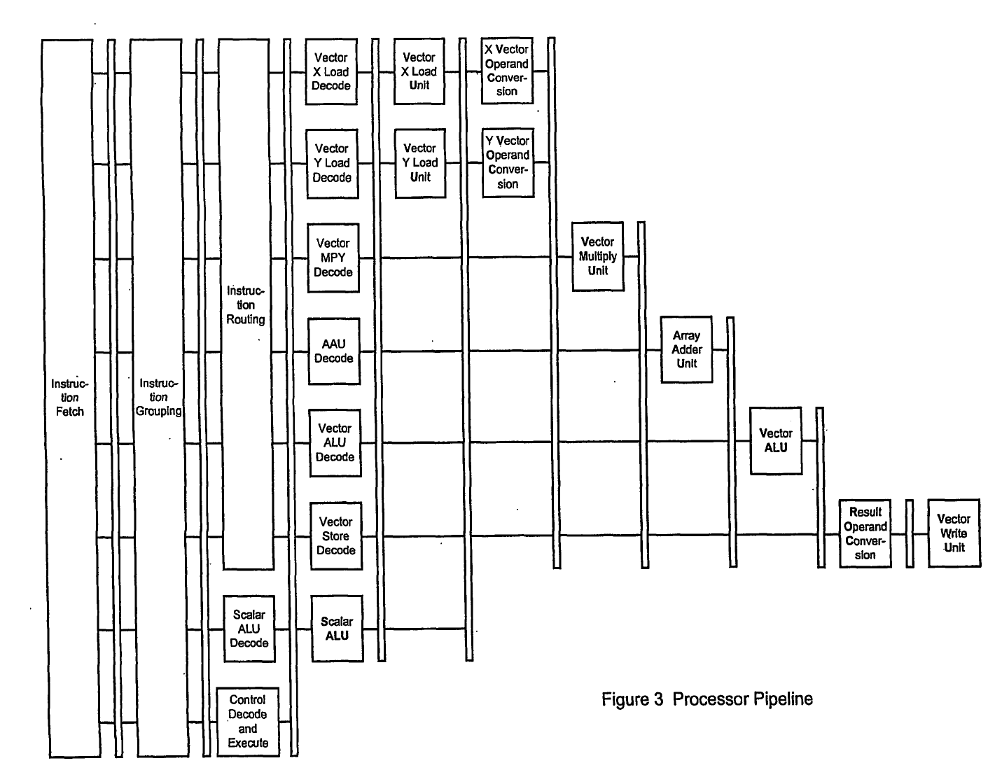

The TOVEN is implemented in a series of interconnected vector units in a pipeline as shown in FIG. 3. The Vector Pre-Fetch Unit (VPFU) (not shown) is responsible for accessing operands from the on-chip memory. The Vector Load Unit (VLU) responds to operand load instructions and delivers X and Y operands in the proper vector order to the execution units. The Vector Operand Conversion (VOC) is responsible for promoting and demoting operands as required for the concurrent operation(s). The Vector Multiplier Unit (VMU) is the first of three execution units and is responsible for operand multiplication. The Array Adder Unit (AAU) is responsible for the addition of vector elements from either the VMU, a prior VALU result or a memory vector operand. The Vector Arithmetic and Logic Unit (VALU) is responsible for classical ALU operations and implementation of the accumulate stage normally used in Multiply and Accumulate DSP operations. The Vector Write Unit (VWU) writes results back to the on-chip memory based on individual conditional controls for each element Included within the result write path is a Vector Result Conversion (VRC) which rounds or saturates, convert formats, and reduces or increases precision.

Memory access of operands is essential for flexibility in algorithm coding. The on-chip memory is organized as a wide memory with the appearance of multiple access ports. The access ports are used for fetching the X and Y operands and writing the R result Integral to the memory system is also a bulk transfer mechanism used for moving data to/from external bulk memory. These features are explained in the later sections of this chapter.

For clarity, a multistage instruction can be defined as a group of primitive instructions (opcodes) that would be grouped together. The multistage, single-cycle instruction to find the expected value of a vector given an accompanying probability vector is as follows:

.macro EXPECTED_VALUE(X0, IX0, Y0, IY0, IWO)

| | | |
|---|---|---|
| V.LD | X0, IX0, +VL; | // load register X0 and post increment |
| | | the load pointer IXO by VL |
| V.LD | Y0, IY0, +VL; | // load register Y0 and post increment |
| | | the load pointer IYO by VL |
| V.MUL | X0, Y0; | // point-wise multiply X0 and Y0 |
| | | creating a vector stored in register M |
| V.AAS | M, sum; | // sum elements of vector M with the |
| | | result being stored in register Q |
| V.SHRA | Q, S; | // register R = Q shift right by |
| | | factor in register S |
| V.ST | R, IWO, +SW; | // store R to memory location |
| | | IWO, post increment IW0 by SW |

.endm

The primitive instructions in the EPECTED VALUE macro will be grouped together to make a single cycle, multistage instruction. Using a loop construct such as “for (i=0; i<N; i++) {EXPECTED_VALUE(X0, IX0,Y0,IY0,IWO)}, would require N clock cycles and (6 primitive instructions)*16-bit=96-bit instruction space for the inner loop.

1.2 Core Architecture

This section describes the core architecture of the Tolon Vector Processor Family, as shown in FIGS. 1, 2 and 3.

1.2.1 Instructions

The computational (execution) units of the TOVEN Processor are designed to support both Vector and Register mode instructions. Vector instructions (Vector mode) make the elements of a functional unit work in SIMD whereas Register mode instructions make the hardware elements or the “slices” of a functional unit work independently. To make things clear, each element of a functional unit can be programmed in Register mode, but in Vector mode, all the elements in a particular functional unit are performing in SIMD and do not have to be individually programmed

Processor instructions are categorized as Vector (Type 7), Register (Types 4, 5 and 6) and General (Types 0, 1, 2 and 3). These instructions types are further described in Table 1-3.

Vector and Register instruction groups are mutually exclusive as they both allocate the vector processor's pipeline functional resources according to different algorithms. In Vector mode, a vector load of each X and Y, a vector multiply, an array addition, a vector ALU, and a vector write are executed together in one group (multistage instruction). In Register mode, one vector or scalar load of each X and Y, any multiplication or ALU operation on an element of R, and a vector or scalar write are permitted to be executed together in one group. In either mode, Vector or Register, most General instructions may be used. These include scalar/pointer load/store operations, immediate value set operations, scalar ALU operations, control transfer and miscellaneous operations.

TABLE 1-3
Instruction Categories

| Type | Category | General Description |
|---|---|---|
| 7 | Vector | Vector load, store, multiply, ALU and array addition |
| 6 | Register | Element multiply operations with 3 operands |
| | | Element ALU operations with 1 operand |
| 5 | Register | Element ALU operations with 2 operands and 16 or |
| | | 32 bit constants |
| 4 | Register | Element ALU operations with 2 operands |
| 3 | General | Scalar/pointer load/store operations |
| 2 | General | Set immediate value operations with 8, 16 and 32 |
| | | bit constants |
| 1 | General | Scaler ALU operations with 1 operand |
| 0 | General | Control transfer, guard operations and |
| | | miscellaneous operations |

1.2.2 Computational Units

The vector computational units of the TOVEN Processor include the Vector Multiply Unit (VMU), Array Adder Unit (AAU), Vector Arithmetic and Logic Unit (VALU). The scalar computations are performed in the Scalar Arithmetic and Logic Unit (SALU). The SALU is provided for performing simple computations for program control and initial addresses. The SALU is positioned early in the pipeline so that the effect of the full pipeline length can usually be avoided. This reduces penalties for branching and other change of control operations (calls and returns).

The Vector Multiply Unit (VMU)

The Vector Multiply Unit (VMU) operates on 8, 16 and 32-bit size data and produces 16, 32 and 32-bit results respectively. Generally, a result of a multiplication requires doubling the range of its operands. Multiplication of 32-bit data types in the VMU is limited to producing either the high or low 32-bit result. A high word result is needed when multiplying fractional numbers, whereas a low word result expresses the result of multiplying integer numbers. A mixed-mode fractional/integer multiplication is supported and the result is considered as fractional.

Each multiplier hardware element (for a 32-bit word size) is responsible for operating with a mixture of signed and unsigned operands with both fractional and integer types:

1) four 8×8 integer/fractional multiplies to produce four 16-bit products

2) two 16×16 integer/fractional multiplies to produce two 32-bit products

3) one 32×32 fractional multiply to produce a 32 bit fractional product (high order result)

4) one 32×32 integer multiply to produce a 32 bit integer product (low order result)

The multiplier element also performs cross-wise multiplication (cross-product) of vectors that is used for in multiplying real and imaginary parts in complex multiplication. For 32-bit operands, this exchange is performed outside of the basic element multiplier. For 16 and 8-bit operands, this exchange is performed within the multiplier element by computing appropriate partial products.

The Array Adder Unit (AAU)

The Array Adder Unit (AAU) operates on 8, 16, and 32-bit size data and produces 12, 24, and 48-bit results respectively. The output data size is increased over the input data size because of guard bits.

The fundamental operation performed by this unit is matrix-vector multiplication where the elements of the matrix are restricted to −1,0,1.

qⱼ=ΣC_{j,k}*pₖ where C_{j,k} is an element of {−1, 0, 1}.

A matrix of this form allows the summation of an input vector (operand register), partial summation, permutation, and many other powerful transformations (such as an FFT, dyadic wavelet transform).

The Vector Arithmetic and Logic Unit (VALU)

The Vector Arithmetic and Logic Unit (VALU) operates on 8, 16, 32-bit and also 12, 24, 48-bit size data producing a 12, 24 and 48-bit result respectively. The VALU input may be a result (stored in the R or Q register) from the AAU unit hence the support of 12, 24, 48-bit operand size is needed. Through register type “tagging”, operand registers for the VALU can be different and the proper type cast will be performed automatically (transparent to the programmer).

The function of the VALU is to perform the traditional arithmetic, logical, shifting and rounding operations. Special considerations for ETSI routines are accommodated in overflow and shifting situations. Shift right uses should allow for optional rounding to resulting LSB. Shift left should allow for saturation.

The Scalar Arithmetic and Logic Unit (SALU)

The Scalar Arithmetic and Logic Unit (SALU) performs simple operations for a fixed 32-bit size primarily for control and addressing operations. Typically ALU instructions are supported with the result stored as a 32-bit register (S register). The S register can be accessed by the VMU for vector-scalar multiplication.

1.2.3 Conversion Units

The conversion units of the TOVEN Processor include the Vector Operand Conversion (VOC), and Vector Result Conversion (VRC). Both of these units do not respond to explicit instructions, but rather perform the conversions as specified for the operations being performed with the operands being used.

1.2.4 Load/Store Units

Vector Pre-Fetch Unit (VPFU)

The Vector Pre-Fetch Unit (VPFU) is responsible for accessing operands from the on-chip memory.

Vector Load Unit (VLU)

The Vector Load Unit (VLU) responds to operand load instructions and delivers X and Y operands in the proper vector order to the execution units.

Vector Write Unit (VWU)

The Vector Write Unit (VWU) writes results back to the on-chip memory based on individual conditional controls for each element

1.2.5 Guarded Operations

In the TOVEN Processor, nearly all instructions are conditionally executed. Vector instructions conditionally operate on an element-by-element basis using the Vector Enable Mask (VEM) and the Vector Condition Mask (VCM). These masks are derived from traditional status conditions of the Vector ALU. Non-vector instructions use a Scalar Guard derived from status conditions of either the Scalar ALU or a selected element of the Vector ALU. Non-vector instructions execute conditionally or use a True condition, where the True condition was the result of a set of status conditions.

Vector instructions execute unconditionally or use an Enabled condition, a True condition or a False condition. The Enabled condition, E, executes if the corresponding bit in the Vector Enable Mask is one. The True condition, T, executes if the corresponding bits in both the Vector Enable Mask and Condition Mask are one. The False condition, F, executes if the corresponding bit in the Vector Enable Mask is a one and the Condition Mask is a zero. If no condition is specified, the instruction executes on all elements. Table 1-4 summaries the vector instruction execution guards.

TABLE 1-4
Vector Instruction Execution Guards

| Conditional Execution | VEM | VCM |
|---|---|---|
| None | — | — |
| Enable (E) | 1 | — |
| True (T) | 1 | 1 |
| False (F) | 1 | 0 |

The Vector Enable Mask is provided to facilitate the implementation of concurrent multi-channel algorithms such as vocoders. The Vector Enable Mask is used by a calling routine to selectively enable the channels (elements) for which the processing must be performed. Within the routine, the Vector Condition Mask register is used to enable/disable selective elements based on conditional codes. These masking registers are stackable to a software stack by pushing/popping at the entry and exit of routines and are copied from one to the other for nesting of conditional operations.

1.2.6 Vector Looping Control

The looping mechanism works in multiples of the hardware vector length such that if the hardware supports a vector length of 8, the loop can be specified as ⅛^{th} of the number of elements. Alternatively, the loop can be specified in the number of elements and decremented by the hardware vector length, VML or VAL. The last instantiation may even be partial as the value of VML and/or VAL may be set to the remainder for the last pass through the loop. These temporarily changed values of VML and/or VAL may be restored upon completion of the loop. This mechanism allows software implementations to be independent of the hardware length of the vector units.

1.2.7 Memory Interface

Memory organization is Harvard with separate instruction and data memory. All data memory is however unified to be friendly to the compiler and programmer. The use of pre-fetch operations (effectively as a cache), allows full speed delivery of operands to the operational units. Data pre-fetch reads at least twice the amount of data consumed in any given clock cycle. This balances the throughput with respect to the consumption of pairs of data from different locations with the reading of sequential operands. Operands only need to be aligned according to their size to allow efficient access as on most RISC processors.

### Section 2. Operand/Operation Typing

2.1 Overview

The TOVEN implements a strongly typed-system for identifying data operands and conversions required for particular operations. Each data operand has characteristics of the following:

1) Operand type may be Integer, Fractional or Exponential (floating point)

2) Signed or Unsigned attributes for Integer and Fractional types

3) Size which may be Byte, Half-Word, Word or Long for Integer and Fractional types and Compact, Single or Double for an Exponential type

4) Placement specifies positions 0 to 7 for Byte, 0 to 3 for Half-Word, 0 to 1 for Word, where 0 denotes the least significant position

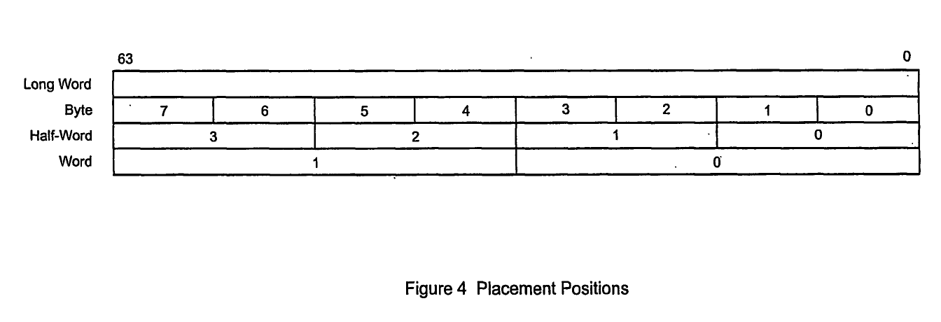

Placement refers to a position relative to a “virtual” 64-bit Long-Word and is used to identify the significance associated with each component data FIG. 4 illustrates the positions of Bytes, Half-Words and Words relative to a 64-bit Long Word. Each position is type-aligned. For example if one was accumulating 8-bit data (summing the elements of a vector, say y) with the result being “r” a 12-bit number, “position 0” would refer to bits 0 to 7 of r (r[7:0]) and “position 1” would refer to bits 8 to 11 of r (r[11:8]). In this case “position 1” would reference the guard bits. In reality, the accumulating register is 16 bits but only 12 bits are used, hence “position 1” just provides 4 bits of information.

Exponential (floating point) support is currently not implemented, but is reserved for a future member of the TOVEN Processor Family. A size of long for Integer and Fractional data types is also currently not implemented and reserved. Fractional data is shown using either one sign or one integer bit with the rest of the bits as fractional. Other Fractional data formats may be used by the programmer maintaining the location of the binary point (like other DSPs).

2.2 Type Specification

The Table 2-1 summarizes the different data operand types, sizes, formats and placement:

TABLE 2-1
Operand Types, Sizes, Formats and Placement

| Type | Sign | Size | Format | Placement |
|---|---|---|---|---|
| Integer | Signed | Byte | S.7.0 | 0-7 |
| | | Half-Word | S.15.0 | 0-3 |
| | | Word | S.31.0 | 0-1 |
| | | Long | S.63.0 | 0 |
| Integer | Unsigned | Byte | 8.0 | 0-7 |
| | | Half-Word | 16.0 | 0-3 |
| | | Word | 32.0 | 0-1 |
| | | Long | 64.0 | 0 |
| Fractional | Signed | Byte | S.7 | 0-7 |
| | | Half-Word | S.15 | 0-3 |
| | | Word | S.31 | 0-1 |
| | | Long | S.63 | 0 |
| Fractional | Unsigned | Byte | 1.7 | 0-7 |
| | | Half-Word | 1.15 | 0-3 |
| | | Word | 1.31 | 0-1 |
| | | Long | 1.63 | 0 |
| Exponential | | Compact | S.5.10 | |
| | | Single | S.8.23 + 1 | |
| | | Double | S.11.52 + 1 | |

A placement f0 refers to the least significant position.

The implementation of the operand-type information utilizes a “type register” associated with each operand and address pointer. The format of a type register is shown below in Table 2-2:

TABLE 2-2
Type Register Format

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | | | | | | |
|---|---|---|---|---|---|---|---|
| Type | Size/Position | S/U | R | R/T | B/U | Sat | Reserved |

0 - Fractional
1 - Integer
2 - Exponential
3 - Automatic

0x0 - Byte, position = 0
0x1 - Byte, position = 1
0x2 - Byte, position = 2
0x3 - Byte, position = 3
0x4 - Byte, position = 4
0x5 - Byte, position = 5
0x6 - Byte, position = 6
0x7 - Byte, position = 7
0x8 - Half-Word, position = 0
0x9 - Half-Word, position = 1
0xa - Half-Word, position = 2
0xb - Half-Word, position = 3
0xc - Word, position = 0
0xd - Word, position = 1
0xe - Long-Word, position = 0
0xf - Unspecified

0 - signed
1 - unsigned

0 - reserved

0 - round
1 - truncate

0 - unbiased-rounding
1 - biased-rounding

0 - no saturation
1 - normal saturation
2 - luma saturation (240)
3 - chroma saturation (235)

0 - reserved

The types are Fractional, Integer and Exponential. The operand type, “Automatic”, is used for automatic operand matching. The interpretation of “Automatic” is dependent on its use as an operand, operation, or result type. When used as an operand type, “Automatic” means the operand type is of the same type as the operation expects and hence no conversion is necessary. When used as an operation type, the operation will be performed according to the type of its operands (operand matching logic is used to determine the common operation type). As a result type, “Automatic” is not used. Operand “size” and “position” are encoded into a common field. The position is enumerated from the least significant position to the most relative to a 64 bit word. A Byte may occupy any one of 8 positions, a Half-Word may occupy any one of 4 positions, a Word may occupy either of 2 positions, and a Long-Word may only be in one position. The size/position field value of “Unspecified” is used for operand matching of size and position properties but not of an operand type.

The “sign” field indicates if the operand or result is to be considered Signed or Unsigned. This specification is used for multiplication and saturation. Multiplication uses the sign attributes of its operands t control its operation to be Signed/Signed, Unsigned/Unsigned or mixed. Saturation uses the sign attribute of its operand to control the saturation range (such as 0x8000 to 0x7fff for signed or 0x0000 to 0xffff for unsigned). Currently, the sign field of an operation type is unused.

2.2.1 Operand Types

The type registers associated with vector data operands are:

TX0—associated with operand-address pointer IX0

TX1—associated with operand-address pointer IX1

TX2—associated with operand-address pointer IX2

TY0—associated with operand-address pointer IY0

TY1—associated with operand-address pointer IY1

TY2—associated with operand-address pointer IY2

In the execution of a vector load operation, the destination registers, X[2:0] and Y[2:0], inherit the “tag” associated with a pointer it was loaded with. Hence if X0 is loaded using pointer IX1, then the type attributes of X0 will be taken from TX1. Further, any changes to the type register, TX1, will immediately apply as the type of data held in X0.

2.2.2 Operation Types

The type registers associated with the vector functional units are:

TMOP—specifies the VMU operand type

TRES—specified the VMU, AAU and VALU result type

The vector operations performed through TOVEN are controlled through the use of this type information. The operands for the VMU are converted according to the type-register, TMOP. This may specify “Automatic” or “Unspecified” to allow the operand matching logic determine the common type for the VMU operation. The results of the VMU, AAU and VALU are all specified according to the type-register, TRES. The operands for the AAU and VALU are also converted according to TRES. Again, specifying “Automatic” or “Unspecified” allows the operand matching logic to determine the common type for the AAU or VALU operation. The actual result of the VMU may be converted to match the type specified in TRES if necessary.

2.2.3 Result Types

The type registers associated with the result registers are:

TM—associated with result register M

TQ—associated with result register Q

TR—associated with result register R

TT—associated with result register T

These types represent the actual operand/result attributes. As such, the types “Automatic” or “Unspecified” are not normally used.

2.23 Storage Types

The type registers associated with writing vector results are:

TW0—associated with result-address pointer IW0

TW1—associated with result-address pointer IW1

TW2—associated with result-address pointer IW2

In the execution of a vector store operation, the destination registers, M, Q, R and T may be converted according to the type register associated with the destination address pointer.

2.2.3 Other Types

Additional type registers are:

TS—associated with scalar register S (result register of the SALU)

TIM—associated with immediate constants (4-bit, 16-bit and 32-bit)

2.3 Operand Promotion

As described in the previous section, an operand type-register is associated with each operand and result (and also with each address pointer). The operand type(s) and operation/result type(s) are used for controlling conversions for each operation. (Instructions are provided to alter the type registers once operands are in registers.) Operand promotion refers to conversions to larger operands with generally no loss of precision. The operand promotions performed according to operand and operation type attributes include:

1) Positioning Bytes, Half-Words or Words into extended precision values

2) Sign extension/zero fill

3) Conversions of Integer/Fractional to Exponential

4) Conversion of lower precision Exponential to higher precision Exponential

Operand promotions are performed in the preparation of the operands in the Vector Operand Conversion Unit (VOC) before the operand is delivered to the specific vector-processing unit (VMU, AAU or VALU). Result promotion is performed by the Vector Result Conversion Unit (VRC) when storing operands to memory through the Vector Write Unit (VWU).

Both operand and operation types (result and storage types for vector write operations) are used for promoting the operand.

Promotion of operands may be implicit by matching one form of operand with another form operand (either to match the other data operand or match the operation type). Depending on either the operation type or the other data operand, a conversion from one format to another would be performed automatically. The conversion is equivalent to what is normally performed in high-level languages, such as C Language, when mixed operands types are used. When one operand is Exponential (floating point) and the other is Integer, an implicit conversion of Integer to Exponential is performed first and then the operation is performed. With the strong typing of operands in the TOVEN, a conversion can be automatically applied to the necessary operands. The rules for implicit type conversion should follow those in C Language. These rules should be extended to convert Fractional operands to their equivalent exponential representation assuming either 1.15 or 1.31 operand formats.

2.3.1 Operand Position

The positioning operation shifts the vector operand into the specified position relative to the operation type for a vector unit instruction. Vector instructions may operate on Integer or Fractional data with bytes, half-words or words sizes.

2.3.2 Operand Sign

The sign extension/zero fill controls the expansion into the higher order bits.

2.3.3 Promotion of Integer/Fractional to Exponential

Promotion of Integer/Fractional data to Exponential may be considered in two steps (the actual implementation need not utilize two distinct steps). The first step, enumerated in Table 2-3, is a type conversion to the nearest exponential equivalent whereby no loss of precision is expected.

TABLE 2-3
Enumerated Conversion of Integer/Fractional to Exponential

| Type | Size | Converted To |
|---|---|---|
| Integer | Byte | Compact or Short |
| | Half-Word | Short |
| | Word | Double |
| | Long | Double or extended (if supported) |
| Fractional | Byte | Compact or Short |
| | Half-Word | Short |
| | Word | Double |
| | Long | Double or extended (if supported) |

The second step is then a promotion of a “smaller” exponential operand to a larger operand as discussed in the section 2.3.4.

2.3.4 Promotion of Lower Precision to Higher Precision Exponential

The promotion of lower precision exponential operands to higher precision is identical to the handling of operands in high-level languages such as C Language.

2.4 Operand Demotion

Operand demotion refers to conversions to smaller operands with an intentional loss of precision. The demotion is performed to match operand types for specific operation type(s) and for operand storage. The operand demotions performed according to operand and operation type attributes include:

1) Positioning Half-Words or Words into lower precision values

2) Conversions of Exponential to Integer/Fractional

3) Saturation

4) Rounding

Operand demotions are performed in the preparation of the operands in the Vector Operand Conversion Unit (VOC) before the operand is delivered to the specific vector-processing unit (VMU, AAU or VALU). The Vector Result Conversion Unit (VRC) performs result demotion when operands are stored to memory through the Vector Write Unit (VWU).

Both operand and operation types (result and storage types for vector write operations) are used for demoting the operand.

2.4.1° Operand Positioning

Use of a portion of a word in a half-word operand or a portion of a word or half-word in a byte operand is implemented through operand positioning. The high or low-half of a word operand may be used as the half-word operand. When a low half-word is used as the operand, the operand is considered as unsigned. The corresponding type register should be set accordingly for the selection of the desired high or low portion and sign attributes of the portion. Table 2-4 shows this Operand Positioning.

TABLE 2-4
Operand Positioning

| | | Converted | |
|---|---|---|---|
| Type | Size | To | Placement |
| Integer | Half-Word | Byte | low_byte(value) |
| | | Byte | high_byte(value) |
| | Word | Byte | low_byte(low_halfword(value)) |
| | | Byte | high_byte(low_halfword(value)) |
| | | Half-Word | low_halfword(value) |
| | | Half-Word | high_halfword(value) |
| Fractional | Half-Word | Byte | low_byte(value) |
| | | Byte | high_byte(value) |
| | Word | Byte | low_byte(low_halfword(value)) |
| | | Byte | high_byte(low_halfword(value)) |
| | | Half-Word | low_halfword(value) |
| | | Half-Word | high_halfword(value) |

Conversion of Integer to/from Fractional data types is performed without any consideration of the location of the binary point.

2.4.2 Conversion of Exponential to Integer/Fractional

A demotion occurs on the storage of operands when a Floating-Point operand is to be stored in a Fractional variable, or used as Fractional instruction operand. The conversion may result in either an Integer or Fractional number. A Fractional number is assumed to be 1.7, 1.15 or 1.31 in either signed or unsigned format Optional rounding and/or saturation may be used in the conversion to Integer or Fractional numbers.

2.4.3 Saturation

When a Fractional operand is demoted, saturation may be performed on the operand. Saturation is dependent on whether the operand/result is signed or unsigned for the selection of the appropriate numeric limits for saturation.

Video saturation may also be specified for saturating data to unsigned bytes using a maximum of 240 (235 for chroma) and a minimum of 16 for 656 video format

2.4.4 Rounding

When a Fractional operand is demoted, rounding may be performed on the operand. Both biased and unbiased rounding should be supported selected by a processor mode bit For some algorithms, biased rounding must explicitly be performed. For other algorithms, unbiased rounding is preferred.

2.5 Type-Independent Operations

In addition to the promotion of data operands, the specific form of the instruction operation (Integer, Fractional, Exponential) may be selected based on the promoted matching data operand types. For example, a type-independent “add” operation f two data operands may be in either Integer/Fractional or Exponential depending on the common promoted data operand type. The result may be further converted (promoted or demoted) for subsequent operations or storage according to desired operand type. The selection of the form of the type-independent instruction is much like operator overloading in C++. Data operands would be automatically promoted to a common type and the matching operation would be performed.

As the operand type would be a characteristic of a data operand, the operand type would be passed into a routine or piece of code along with the data operand. This allows common code to operate on different and mixed types of data. This is a classic example of its utility is for a maximum function. Any type of data operand may be compared with any type of data operand using a type-independent “compare” instruction with automatic promotion.

2.6 Other Conversions

The TOVEN also performs other conversions as results are generated. These conversions are-used to ensure reliable computations. They are discussed in the following sections.

2.6.1 Redundant Sign Elimination

Redundant sign elimination is used automatically when two Fractional numbers are multiplied. This serves to eliminate the redundant sign bit formed by the multiplication of two S.15 numbers to form a S.31 result as an example. The redundant sign elimination is NOT performed for mixed Integer/Fractional or Integer only operations so as to preserve all result bits. The programmer is responsible for shifts in these cases. Multiplication of two Fractional operands or one Fractional and one Integer operand results in a Fractional result type. Only a multiplication of two Integer operands results in an Integer result type.

2.6.2 Corner Cases

Corner cases arise from the asymmetry of two's complement numbers. The Fractional multiplication of −1 by itself is a good example −1 is represented by 0x8000 as a half-word. When multiplied by itself, 0x8000 times 0x8000 gives 0x8000 0000 which is the representation of −1 as a word fractional value. The result most suitable is 0x7fff ffff, which is nearly 1.

Another example is−(−1) which should also result in a value of 1 but needs to be represented by a value of nearly 1 as a fractional number. This form of fractional negation is used frequently in the AAU and VALU. Conditions such as these should be detected and corrected in each processing stage where such corner cases may occur. Alternatively, the expansion by 1 bit could be accommodated in the processing of the AAU and VALU.

2.6.3 Shifting Corrections

Corrections to the result after a shift may also be necessary. A Fractional operand shifted right may need to be rounded. A Fractional operand shifted left may need to be saturated.

### Section 3. Computational Units

3.1 Overview

3.2 Vector Multiplier Unit (VMU)

The Vector Multiplier Unit (VMU) performs the following arithmetic operations in Vector Mode.

| | |
|---|---|
| 1) Point-wise vector multiplication | V.MUL |
| 2) Cross-product/cross-wise vector multiplication | V.XMUL |
| 3) Vector by a scalar (scalar in the SALU result register S) | V.MUL, |
| | V.XMUL |
| 4) Vector point-wise multiplication with itself | V.SQR |

The operands come from vector operand registers, X[2:0] or Y[2:0], a prior vector result, R, or a scalar operand, S. The result from a VMU is stored (return) in register M.

Point-Wise Vector Multiplication

Point-wise vector multiplication is defined as:

m(i)=x(i)*y(i)

Cross-Product/Cross-Wise Vector Multiplication

Cross-product or cross-wise vector multiplication is defined as:

| | |
|---|---|
| m(2i) = x(2i + 1) * y(2i) | - even terms |
| m(2i + 1) = x(2i) * y(2i + 1) | - odd terms |

Vector by a Scalar Multiplication

Vector point-wise multiplication with a scalar is defined as:

| | |
|---|---|
| m(i) = x(i) * s | - when x(i) specified |
| m(i) = s * y(i) | - when y(i) specified |

Vector cross-wise multiplication with a scalar is defined as:

| | |
|---|---|
| m(2i) = x(2i + 1) * s, m(2i + 1) = x(2i) * s | - when x(i) specified |
| m(2i) = s * y(2i), m(2i + 1) = s * y(2i + 1) | - when y(i) specified |
| | (same as a vector by scalar |
| | multiply) |

A Note on Complex Multiplication

Complex multiplication for a vector may be performed in two groups of instructions controlling the VMU, AAU, and VALU functional units together. A complex number is represented by a real number followed by an imaginary number.

A Complex multiplication is as follows:

(a+ib)*(c+id)=(ac−bd)+i(ad+bc)=e+if

On the TOVEN Processor, the first instruction group 1) loads new operands (data may by fetched prior to execution in other functional units launched in the same group of instructions), 2) performs the Real/Real and Imaginary/Imaginary multiplications (point-wise multiplication with results ac and bd), 3) performs a subtraction within the AAU (forming e=ac−bd and f=0), and 4) the VALU stores the partial results (e and f) continuation with the second group of instructions.

The second group of instructions does not load new operands but performs 1) the Real/Imaginary pair multiplications (cross-wise multiplication with results ad and bc), 2) performs an addition within the AAU (forming f=ad+bc and e=0), and 4) the VALU then combines (using an arithmetic add operation) the Real (e) and Imaginary (f) portions together completing the complex multiplication.

3.2.1 VMU Block Diagram

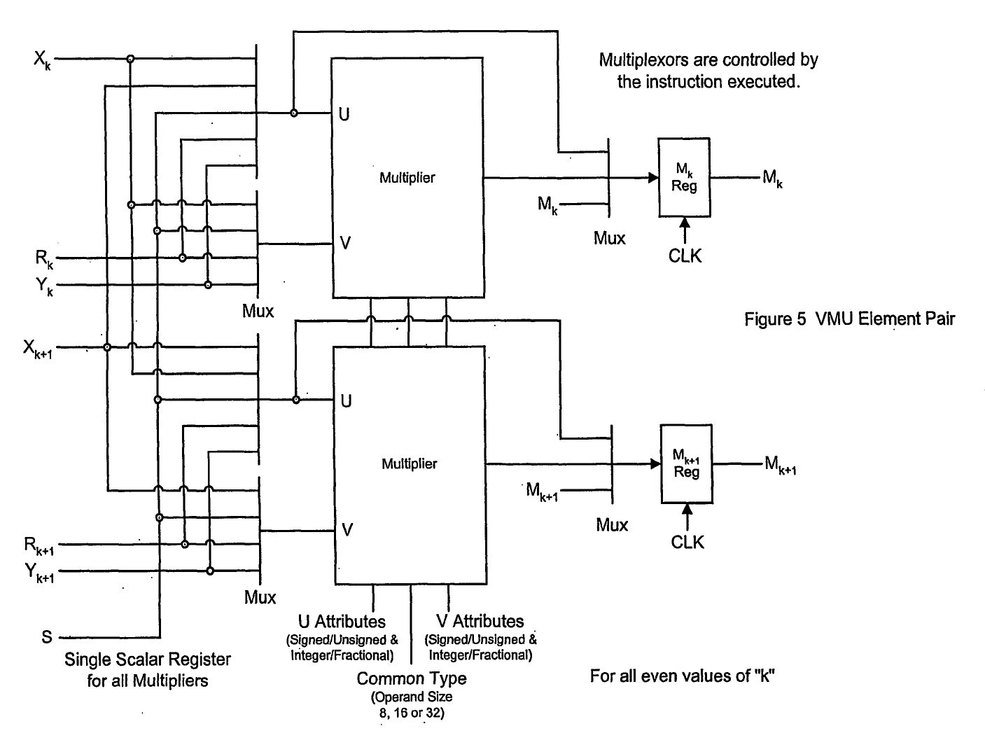

A VMU Element pair is illustrated in FIG. 5. Multiplexors, controlled by the decoded instruction, are used to select the operands. When using 32-bit data size, Xᵢ and Xₖ₋₁ are exchanged between elements for performing cross-product/cross-wise multiplication. The operand-type registers provide sign and type attributes. The multiplier size is produced by the operand-size matching logic according to the multiplier-type register, IMOP.

3.2.2 VMU Standard Functions

The VMU operates on 8, 16 or 32-bit data sizes and produces 16, 32 and 32-bit results respectively. Generally, a result of a multiplication requires doubling the range of its operands. Multiplication of 32-bit data types in the VMU is limited to producing either the high or low 32-bit result A high word result is needed when multiplying Fractional numbers, whereas a low word result expresses the result of multiplying Integer numbers. A mixed-mode Fractional/Integer multiplication is supported and the result is considered as Fractional.

Each multiplier hardware element (32-bit word size) is responsible for operating with a mixture of signed and unsigned operands with both Fractional and Integer types:

1) Four 8×8 Integer/Fractional multiplies to produce four 16-bit products

2) Two 16×16 Integer/Fractional multiplies to produce two 32-bit products

3) One 32×32 Fractional multiply to produce a 32-bit Fractional product (high order result)

4) One 32×32 Integer multiply to produce a 32-bit Integer product (low order result)

The multiplier element is also required to perform cross-wise multiplication by interchanging a neighboring operand. For 32-bit operands, this exchange is performed outside of the basic element multiplier. For 16 and 8-bit operands, this exchange is performed within the multiplier element by computing appropriate partial products. Table 3-1 shows the multiplier result types and sign attributes.

TABLE 3-1
Multiplier Result Types and Sign Attributes

| Operand Types | Result Type | Redundant Sign Elimination |
|---|---|---|
| Integer * Integer | Integer | no |
| Integer * Fractional | Fractional | optional |
| Fractional * Integer | Fractional | optional |
| Fractional * Fractional | Fractional | left shift result one bit |

| Sign Characteristics | Result Sign Characteristics |
|---|---|
| Unsigned * Unsigned | Unsigned |
| Unsigned * Signed | Signed |
| Signed * Unsigned | Signed |
| Signed * Signed | Signed |

The multiplier corrects “corner” cases such as the multiplication of 0x8000 by 0x8000 as signed 16 bit numbers (equivalent to −1). The result of −1 times −1 should be 1 and hence the proper arithmetic result should be 0x7fff ffff rather than 0x8000 0000.

3.2.2.1 VMU Vector Mode Operations

There are five instructions for the VMU. The first instruction is point-wise vector multiplication or point-wise vector-scalar multiplication, the second instruction is cross-wise vector multiplication or cross-wise vector-scalar multiplication, and the third is vector-vector multiplication (squaring) or scalar-scalar multiplication. The last two instructions are used for moving a value into the M register. Please note that when the 32-bit S register is use as an operand, a vector is created with each element of the vector equaling the value in the S register. For example, the “V.SQR S” instruction would result in a vector (not scalar) stored in the M register with each element equaling the value in S squared.

| | |
|---|---|
| [T, F, E, none].V.MUL | [Xi, S], [Yj, S, R] |
| [T, F, E, none].V.XMUL | [Xi, S], [Yj, S, R] |
| [T, F, E, none].V.SQR | [Xi, Yj, S, R] |
| [T, F, E, none].V.MOV | M, [Xi, Yj, S, R] |
| [T, F, E, none].V.XMOV | M, [Xi] |

3.2.2.2 VMLU Register Mode Operations

The VMU instructions for Register mode require an additional operand, “Rd”, which selects the register (R0 to R7) to store the result. Rd, where “d” is also the hardware element slice, will implicitly select the operands Xi.d and Yi.d. For convenience, the user need not specify the “.d” suffixes in the X and Y operands.

| | | |
|---|---|---|
| [T, none].R.MUL | Rd, [Xi.d, S], [Yj.d, S] | // Rd = x * y; |
| [T, none].R.MAC | Rd, [Xi.d, S], [Yj.d, S] | // Rd += x * y; |
| [T, none].R.MSU | Rd, [Xi.d, S], [Yj.d, S] | // Rd −= x * y; |

The following instructions work on a pair of elements (i.e. 2 hardware slices) with the result stored in an Rd register. Each operand is a pair of 32-bit registers (such as Xi.d and Xi.d+1) and one could view these instructions as a 2-point dot-product (z=x(0)*y(0)+x(1)*y(1)) with variations.

| | | |
|---|---|---|
| [T, none].R.DMUL | Rd, [Xi.d, S], [Yj.d, S] | // Rd = x(0) * y(0) |
| | | // R(d + 1) = x(1) * y(1) |
| [T, none].R.DMAC | Rd, [Xi.d, S], [Yj.d, S] | // Rd += |
| | | x(0) * y(0) + x(1) * y(1) |
| [T, none].R.DMSU | Rd, [Xi.d, S], [Yj.d, S] | // Rd −= |
| | | x(0) * y(0) + x(1) * y(1) |
| [T, none].R.CMULR | Rd, [Xi.d, S], [Yj.d, S] | // Rd = |
| | | x(0) * y(0) − x(1) * y(1) |
| [T, none].R.CMULI | Rd, [Xi.d, S], [Yj.d, S] | // Rd = |
| | | x(1) * y(0) + x(0) * y(1) |
| [T, none].R.CMACR | Rd, [Xi.d, S], [Yj.d, S] | // Rd += |
| | | x(0) * y(0) − x(1) * y(1) |
| [T, none].R.CMACI | Rd, [Xi.d, S], [Yj.d, S] | // Rd += |
| | | x(1) * y(0) + x(0) * y(1) |

The dual operand VMU Register instructions are:

| | | |
|---|---|---|
| [T, none].R.MUL | Rd, [Rs, Xi.d, Yj.d, S, C4, C16, | // Rd = Rd * z |
| | C32] | |

| | | |
|---|---|---|
| [T, none].R.SQR | Rd, [Rs, Xi.d, Yj.d, S] | // Rd = x \hat{ } 2 |
| [T, none].R.SQRA | Rd, [Rs, Xi.d, Yj.d, S] | // Rd += x \hat{ } 2; |

Please note, these Register Mode operations also require the cooperation of the AAU and VALU elements associated with Rd (and in some cases, R(d + 1)).

3.2.3 VMU Type Conversions

The operands for the VMU are converted according to the type register, TMOP. This may specify “Automatic” or “Unspecified” to allow the operand matching logic determine the common type for the VMU operation. This permits the programmer to allow the hardware to match the operands. Table 3-2 shows the VMU operand matching used when TMOP is set to “automatic” or “unspecified”.

TABLE 3-2
VMU Automatic Operand Matching

| TMOP | Operand U | Operand V | Operation Format |
|---|---|---|---|
| Auto | Byte | Byte | Byte * Byte |
| | Byte | Half-Word | Half-Word * Half-Word |
| | Byte | Word | Word * Word |
| | Half-Word | Byte | Half-Word * Half-Word |
| | Half-Word | Half-Word | Half-Word * Half-Word |
| | Half-Word | Word | Word * Word |
| | Word | Byte | Word * Word |
| | Word | Half-Word | Word * Word |
| | Word | Word | Word * Word |

In each case, the operand with the largest size is used to specify the operation format. The other operand would then be “promoted” to match this common operand format. Table 3-3 shows the VMU operand conversions used when TMOP is set to a specific operand type.

TABLE 3-3
VMU Operand Conversions

| TMOP | Operand U or V | Operation Format |
|---|---|---|
| Byte | Byte | Byte * Byte |
| | Half-Word | Byte * Byte |
| | Word | Byte * Byte |
| Half-Word | Byte | Half-Word * Half-Word |
| | Half-Word | Half-Word * Half-Word |
| | Word | Half-Word * Half-Word |
| Word | Byte | Word * Word |
| | Half-Word | Word * Word |
| | Word | Word * Word |

When TMOP is explicitly set for a particular operation type, then that is exactly the operand format used for the operation. In this case, both operands may be converted if necessary (using either promotion or demotion) into the common operand format.

The result, M, of the VMU is specified according to the type register, TRES. The result of the VMU may be converted to match the type specified in TRES if necessary using a demotion operation. Since only a demotion is provided, it may be necessary to restrict the type specified in TMOP according to the type specified in TRES. Table 3-4 shows the VMU result conversion used to match the result format specified in TRES.

TABLE 3-4
VMU Result Conversion as Specified by TRES

| TRES | TMOP | Actual TRES | Actual MOP |
|---|---|---|---|
| Auto | Auto | Result Format | Common Operand Format |
| | Byte | Half-Word | Byte |
| | Half-Word | Word | Half-Word |
| | Word | Word | Word |
| Byte | Auto | Byte | Common Operand Format |
| | Byte | Byte | Byte |
| | Half-Word | Byte | Half-Word |
| | Word | Byte | Word |
| Half-Word | Auto | Half-Word | Common Operand Format |
| | Byte | Half-Word | Byte |
| | Half-Word | Half-Word | Half-Word |
| | Word | Half-Word | Word |
| Word | Auto | Half-Word | Half-Word or Common |
| | | | Operand Format |
| | Byte | Half-Word | Half-Word |
| | Half-Word | Half-Word | Half-Word |
| | Word | Half-Word | Word |

This restriction is necessary when TRES specified a Word result and either TMOP or the common operand format would be Byte size. This restriction also aides the computation of vector length allowing all result elements in M to be forwarded onto the AAU or the VALU.

3.2.4 VMU Hardware Implementation

3.2.4.1 Multiplier Partial Product Algorithm

The following vectors of 4 bytes are considered as four byte operands, two half-word operands or one word operand, are used for description of the multiplication process:

| | | | | |
|---|---|---|---|---|
| Vector X element: | A | B | C | D |
| Vector Y element: | E | F | G | H |

The four 8×8 multiplication pairs are (using four 8×8 multipliers):

AE, BF, CG and DH

The four 8×8 crosswise multiplication pairs are (using four 8×8 multipliers):

AF, BE, CH and DG

The two 16×16 multiplications generate the following pairs, which are added and shifted to form the proper result (using eight 8×8 multipliers):

AE<<16+(AF+BE)<<8+BF and CG<16+(CH+DG)<<8+DH

The two 16×16 crosswise multiplications generate the following pairs, which are added and shifted to form the proper result (using eight 8×8 multipliers):

AG<<16+(AH+BG)<<8+BH and CE<<16.+(CF+DE)<<8+DF

The 32×32 fractional multiplication generates the following pairs, which are added and shifted to form a 32-bit fractional result (using ten 8×8 multipliers):

AE<<48+(AF+BE)<<40+(AG+BF+CE)<<32+(AH+BG+CF+DE)<<24

The 32×32 integer multiplication generates the following pairs, which are added and shifted to form a 32-bit integer result (using ten 8×8 multipliers):

(AH+BG+CF+DE)<<24+(BH+CG+DF)<<16+(CH+DG)<8+DH

Note: a check will be needed to determine that the other products associated with a full 64-bit product result would need to be performed. This check verifies that the product terms shown are zero:

AE, AF, BE, AG, BF and CF (should this be CE instead?)

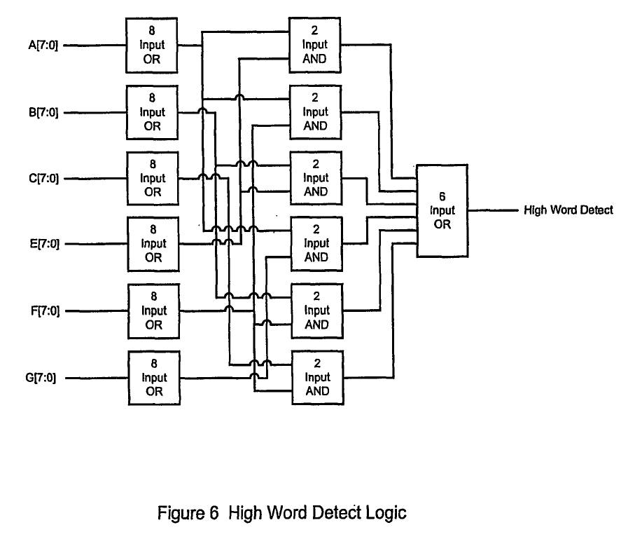

The check may be implemented by detecting if either (or both) of the two operands are zero. First, each of the 6 operands, A, B, C and B, F, G is checked for a value of zero (using an 8 input OR). Then 6 AND gates check for a zero operand for each of these product terms. Finally, a 6 input OR combines the results of the 6 product tests. This logic to implement High-Word detection is shown in FIG. 6.

A full 64-bit product may be produced from two successive integer multiplications. The first multiplication produces the low order 32 bits and the second produces the upper 32 bits. A partial product from the first multiplication needs to be saved for the proper carry into the upper 32 bits. This may be specified using a word position of 1 for the result selecting the upper 32 bits.

3.2.4.2 Multiplier Partial Products

The following partial products are required for the implementation of the multiplication algorithm described in the previous section and are shown in Table 3-5:

TABLE 3-5
Multiplier Partial Products

| 8 × 8 | 8 × 8 | 16 × 16 | 16 × 16 | 32 × 32 | 32 × 32 |
|---|---|---|---|---|---|
| | R * I | | R * I | Fract. | Integer |
| | | | | 30 | |
| AE | | AE | | AE | |
| | AF | AF | | AF | |
| | BE | BE | | BE | |
| BF | | BF | | BF | |
| | | | AG | AG | |
| | | | CE | CE | |
| | | | AH | AH | AH |
| | | | BG | BG | BG |
| | | | CF | CF | CF |
| | | | DE | DE | DE |
| | | | BH | | BH |
| | | | DF | | DF |
| CG | | CG | | | CG |
| | CH | CH | | | CH |
| | DG | DG | | | DG |
| DH | | DH | | | DH |

Ten 8×8 multipliers are needed for this implementation. A two-input multiplexor is used to select the input operands for about half of the multipliers. Under Set A, the 32×32 fractional multiplier inputs must all be accommodated. The six remaining terms may be overlapped with terms not used for their respective multiplications. Logic would be needed to select which set is used for each of the 6-multiplier products that have multiple selections.

The assignment of products to Set B may be optimized with respect to several criteria First, the cross multiplier unit terms, AH and DE should not be multiplexed as these may have longer signal delays. Next, the assignment of operand pairs may consider the commonality of an input operand and hence eliminate the need for one operand multiplexor. Finally, the resulting routing of the product terms into the adders may be considered. Following at least the first two suggested optimizations, the following sets given in Table 3-6 are recommended:

TABLE 3-6
Multiplier Partial Products Organized in Sets

| 8 × 8 | 8 × 8 | 16 × 16 | 16 × 16 | 32 × 32 | 32 × 32 | Set A | Set B |
|---|---|---|---|---|---|---|---|
| | R * I | | R * I | Fract. | Integer | | |
| AE | | AE | | AE | | AE | DG |
| | AF | AF | | AF | | AF | DH |
| | BE | BE | | BE | | BE | BH |
| BF | | BF | | BF | | BF | DF |
| | | | AG | AG | | AG | CG |
| | | | CE | CE | | CE | CH |
| | | | AH | AH | AH | AH | Not Used |
| | | | BG | BG | BG | BG | |
| | | | CF | CF | CF | CF | |
| | | | DE | DE | DE | DE | Not Used |
| | | | BH | | BH | | |
| | | | DF | | DF | | |
| CG | | CG | | | CG | | |
| | CH | CH | | | CH | | |
| | DG | DG | | | DG | | |
| DH | | DH | | | DH | | |

3.2.4.3 Multiplier Cell

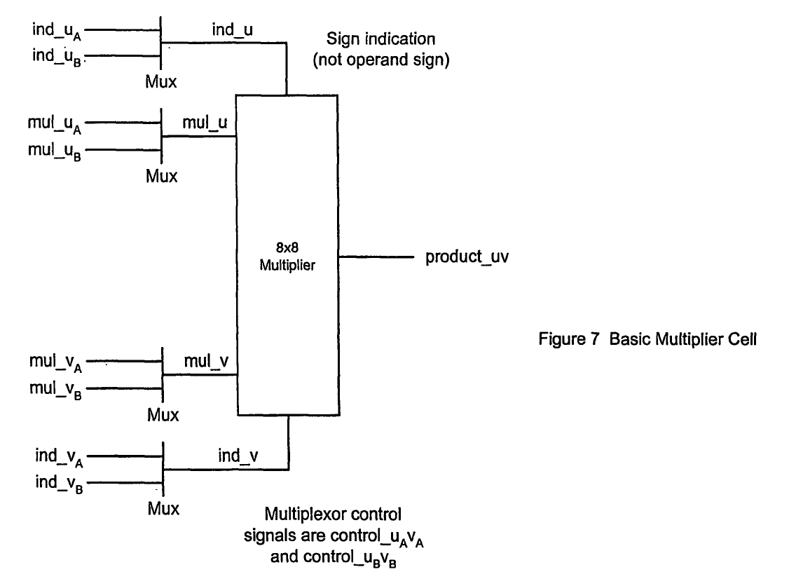

The basic multiplier cell, illustrated in FIG. 7, uses two 8-bit operands, referred to as operands mul_u and mul_v, two single-bit operand-sign indications (conveying either signed or unsigned), referred to as ind_u and ind_v, and produces a 16-bit partial product, referred to as product_uv. The overall operand sign and size types determine the operand-sign indications for the basic multiplier cell. Only the most significant byte of a signed operand is indicated as signed while the rest of the bytes are indicated as unsigned.

Some of the multiplier cells also include one or two 2-input multiplexors for selection of Set A or Set B operands. The suggested Set A/B pairings allows for commonality in some multiplier inputs and often only one 2-input multiplexor is required.

The production of the operand-sign indication and the selection of the Set A or B operands for each 8×8 multiplier product must be individual for each hardware element in the VMU for the support of Register mode operations where each operand may have its own unique attributes.

The specification of integer/fractional affects primarily normalization after the 8×8 product term additions. It does not affect the generation of the 8×8 partial product terms (except it selects the terms for producing an integer or fractional result from a 32×32-bit multiply.) The normalization process is implemented after the summation of the partial products as a simple one-bit shift to the left for a fractional result type.

3.2.4.4 Partial Product Summation Network

The 16-bit partial products are added together according to the operation. Table 3-7 below shows the partial products to be added together. The structure of the summation network will be a set of multiplexors to select the desired operand(s) (or to select 0) and a set of adders. The number of full adders required is at least 13. An expected number is probably 15. L and H subscripts refer to the low and high 8 bits of the partial product terms respectively.

TABLE 3-7
Partial Product Summation

| | Pᵢ₇ | Pᵢ₆ | Pᵢ₅ | Pᵢ₄ | Pᵢ₃ | Pᵢ₂ | Pᵢ₁ | Pᵢ₀ |
|---|---|---|---|---|---|---|---|---|
| 8 × 8 | AE_{H} | AE_{L} | BF_{H} | BF_{L} | CG_{H} | CG_{L} | DH_{H} | DH_{L} |
| 8 × 8 R*I | AF_{H} | AF_{L} | BE_{H} | BE_{L} | CH_{H} | CH_{L} | DG_{H} | DG_{L} |
| 16 × 16 | | | BF_{H} | BF_{L} | | | DH_{H} | DH_{L} |
| (5 adders | | BE_{H} | BE_{L} | | | DG_{H} | DG_{L} | |
| each) | | | AF_{H} | AF_{L} | | | CH_{H} | CH_{L} |
| | AE_{H} | AE_{L} | | | CG_{H} | CG_{L} | | |
| 16 × 16 R*I | | | BH_{H} | BH_{L} | | | DF_{H} | DF_{L} |
| (5 adders | | BG_{H} | BG_{L} | | | DE_{H} | DE_{L} | |
| each) | | AH_{H} | AH_{L} | | | CF_{H} | CF_{L} | |
| | AG_{H} | AG_{L} | | | CE_{H} | CE_{L} | | |
| 32 * 32 Frac. | | | | DE_{H} | | | | |
| (13 adders) | | | | CF_{H} | | | | |
| | | | | BG_{H} | | | | |
| | | | | AH_{H} | | | | |
| | | | CE_{H} | CE_{L} | | | | |
| | | | BF_{H} | BF_{L} | | | | |
| | | | AG_{H} | AG_{L} | | | | |
| | | BE_{H} | BE_{L} | | | | | |
| | | AF_{H} | AF_{L} | | | | | |
| | AE_{H} | AE_{L} | | | | | | |
| 32 * 32 Integer | | | | | | | DH_{H} | DH_{L} |
| (12 adders) | | | | | | DG_{H} | DG_{L} | |
| | | | | | | CH_{H} | CH_{L} | |
| | | | | | DF_{H} | DF_{L} | | |
| | | | | | CG_{H} | CG_{L} | | |
| | | | | | BH_{H} | BH_{L} | | |
| | | | | | DE_{L} | | | |
| | | | | | CF_{L} | | | |
| | | | | | BG_{L} | | | |
| | | | | | AH_{L} | | | |

3.2.4.5 Implementation

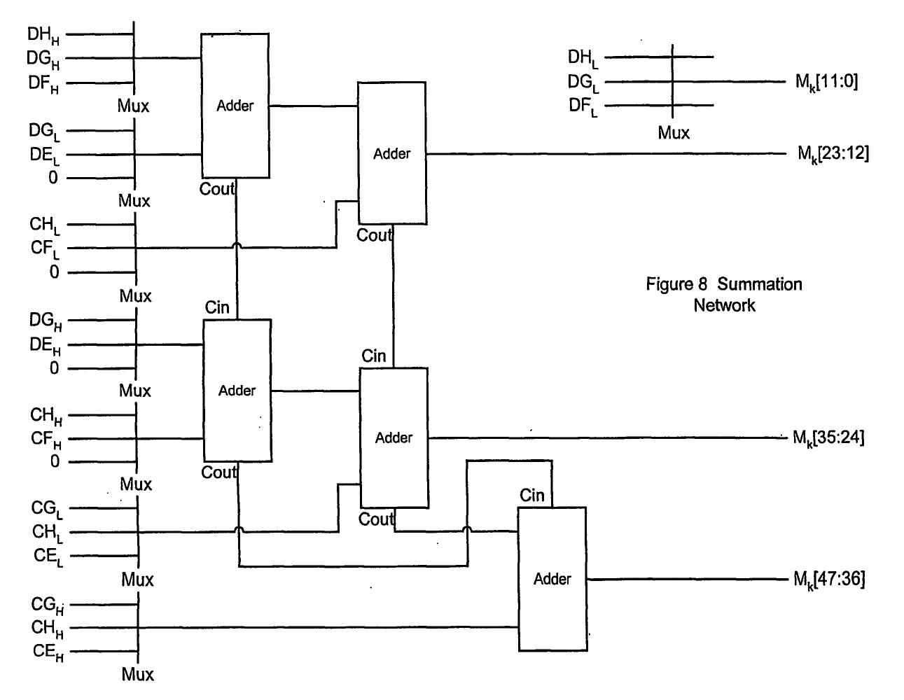

The implementation of the multiplier cell is suggested in FIG. 7. FIG. 8 shows an illustrative implementation of the summation network using a full adder. The exact implementation of both components needs to be researched. A Wallace tree or an Additive Multiply technique (Section 12.2 of Computer Arithmetic by Parhami) may be suitable for the multiplier implementation. Some form of a CSA (Carry Save Adder) style adder (3 inputs, 2 outputs per level) may be appropriate for the implementation of the adder networks.

When a multiplier cell is not needed, power should be conserved by setting (and holding) its inputs at a zero value. This could be done with the multiplexor or with a set of simple AND gates. The summation network should also perform similar power management. In addition, the clock used for internal pipeline stages (and anything else) should be gated off for the multiplier cells and adders in the summation network that are not needed.

The multiplier should also be correct with “corner” cases such as the multiplication of 0x8000 by 0x8000 as signed 16 bit numbers (equivalent to −1). The result of −1 times −1 should be 1 and hence the proper arithmetic result should be 0x7fff ffff rather than 0x8000 0000.

3.3 ARRAY ADDER UNIT (AAU)

The Array Adder Unit (AAU) performs the summation of an input vector (operand register), partial summation, permutation, and many other powerful transformations (such as an FFT, dyadic wavelet transform, and compare-operations for Virterbi decoding).

The Array Adder Unit is used to arithmetically combine elements of a VMU result, M, a prior VALU result, R, or from a memory operand X or Y. Essentially the AAU provides matrix-vector multiplication (y=Cx) where the elements of the C-matrix are −1,0,1. The C matrix may be fetched or altered for each subsequent instruction.

The fundamental operation performed by this unit is

| | |
|---|---|
| qⱼ = Σ C_{j,k} * pₖ | where C_{j,k} is an element of {−1, 0, 1} |

Special modes may be defined to provide for common C matrices such as “Identity” for setting Q=P, “Unity” for setting Q to be the sum of all P, and “Real” or “Imaginary” for computing the complex multiplication of real or imaginary terms. Several pre-defined patterns may also be used for FFT and DCT operations. The output of this unit, Q, is applied as an input to the VALU or it can be directly stored to memory.

3.3.1 AAU Block Diagram

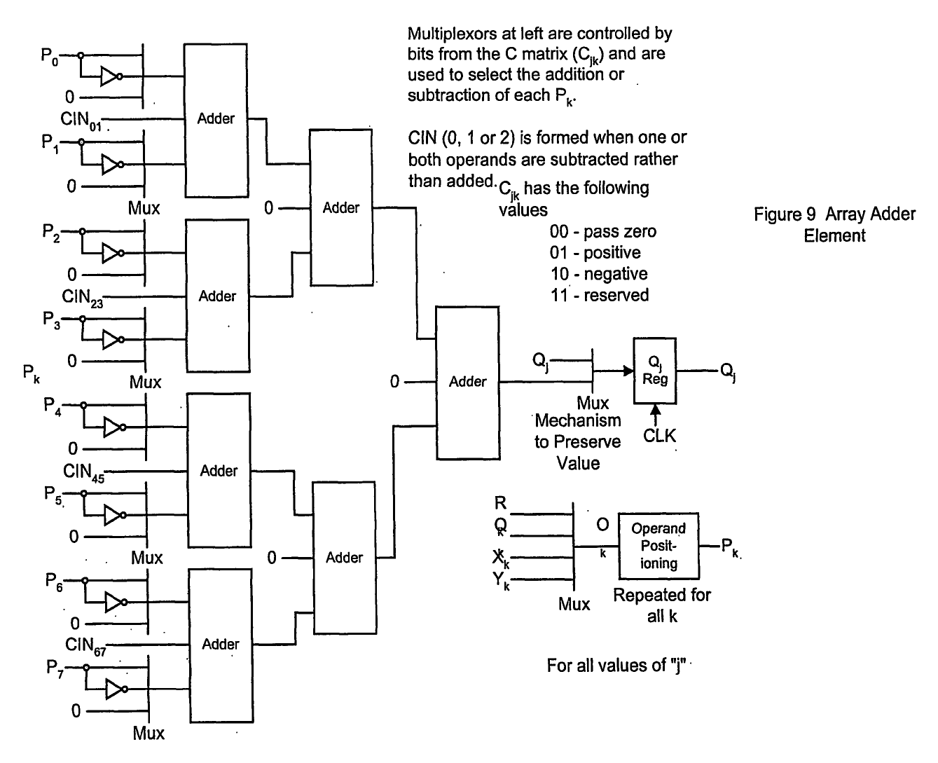

An AAU Element is illustrated in FIG. 9. The multiplexor at the bottom right, controlled by the decoded instruction, is used to select the operands. Multiplexors along the left, controlled by a row of the C matrix, now referred to as a C vector (a matrix can be broken into row vectors), selects the addition or subtraction of each term. The sign (signed or unsigned) and type (Fractional or Integer) attributes are provided by the operand-type register.

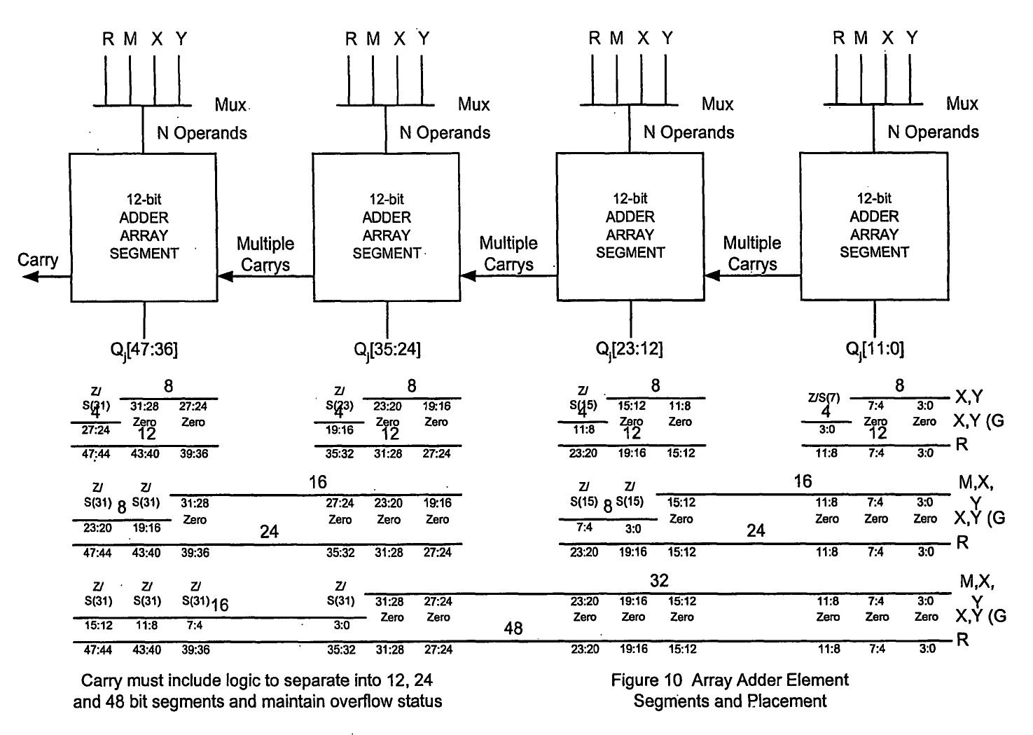

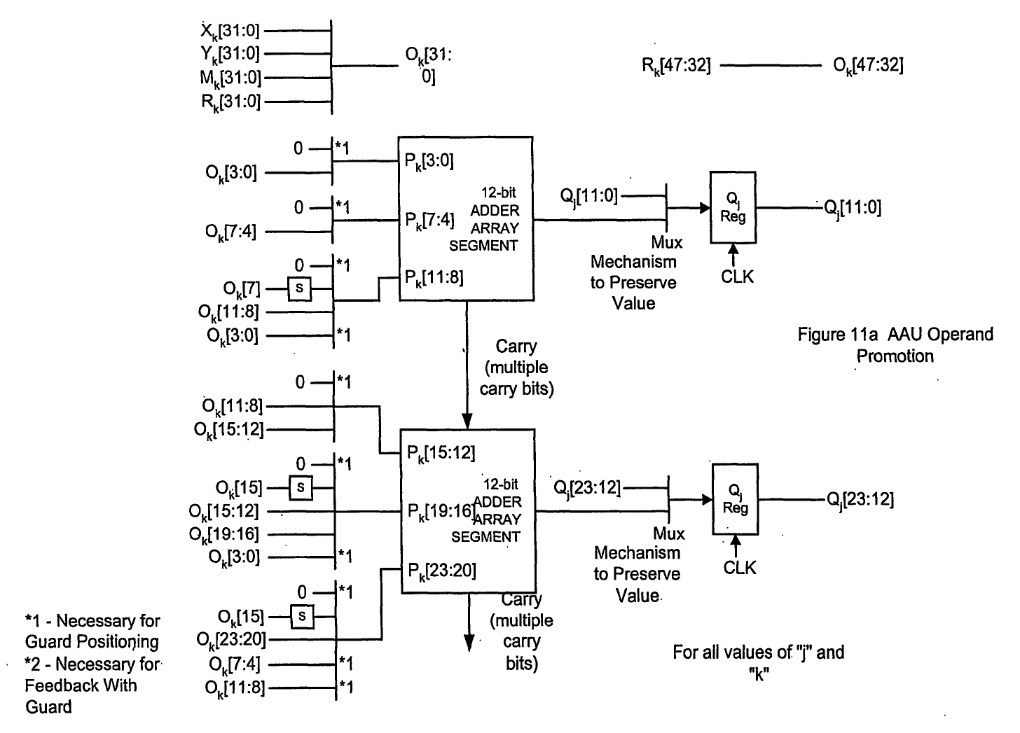

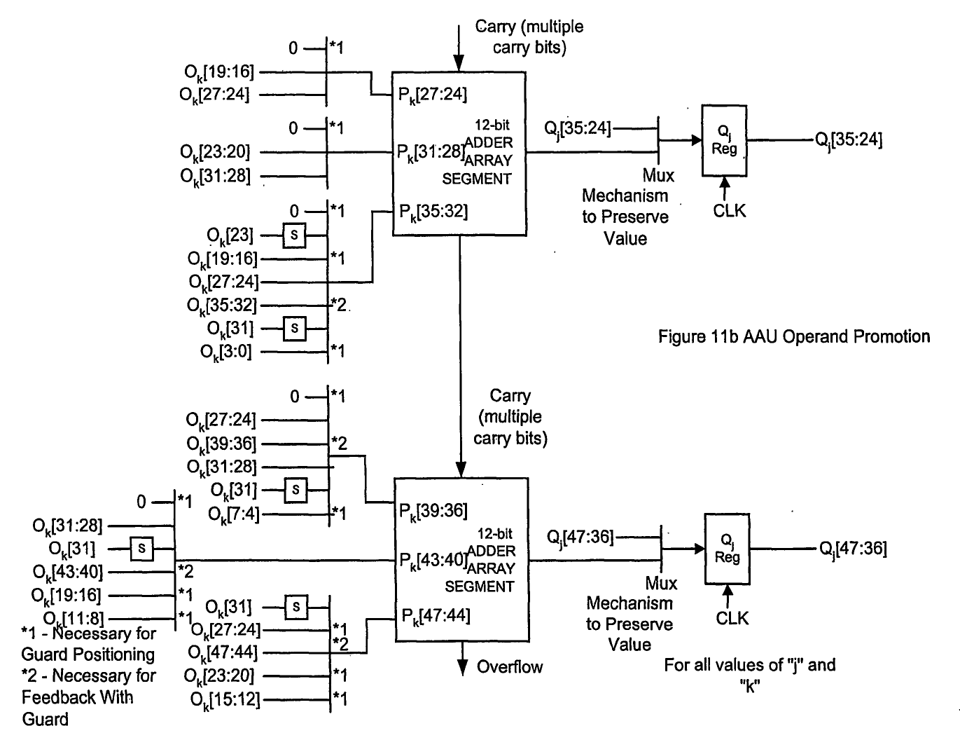

FIG. 10 shows the implementation of the AAU as a set of 12-bit wide segments. Multiplexors control the delivery of operands for each segment as illustrated below the diagram of the segments. Sign extension is necessary when a smaller operand is used in a segment (such as an X or Y operand). FIGS. 11a and 11b show the multiplexors, operand positioning and sign extension processes.

3.3.2 AAU Standard Functions

The Array Adder Unit controls each adder term with a pair of bits from the control matrix, C, to allow each Pₖ to be excluded, added or subtracted. The encoding of the control bits are 00 for excluding, 01 for adding and 10 for subtracting. The combination 11 is not used and reserved.

The following operations are encoded in a pair of bits for each C[j][k]:

C[j][k]

00—zero

01—+1 (add)

10—−1 (subtract)

11—not used

These bits are packed into halfwords as follows:

15 14 13 12 11 10 9 8 7 6 5 4 3 2 1 0
C[j][7] C[j][6] C[j][5] C[j][4] C[j][3] C[j][2] C[j][1] C[j][0]

The C matrix, representing the pattern to be used for add/subtract, is a set of 8 half-words with the first half-word for Q[0] (i.e. C[0][7 to 0]) and the last half-word for Q[7] (i.e. C[7][7 to 0]).

The pre-determined patterns are:

PASS sets Qⱼ to Pⱼ for all possible terms.

SUM produces all Qⱼ as the same sum of all Pₖ.

REAL is used to set Qⱼ to Pⱼ−Pₚ, and Qⱼ₊₁ to 0 for all even j.

IMAGINARY is used to set Qⱼ to 0 and Qⱼ₊₁ to Pⱼ+Pⱼ₊₁ and for all even j.

FFT2, FFT4 and FFT8 represent addition/subtraction patterns used for FFT Radix 2, 4 and 8 kernels respectively. The patterns and use needs to be evaluated. More patterns may be needed for computing FFTs efficiently.

VIRTERBI may be used to perform several compares in parallel to accelerate the algorithm. It is likely that several different patterns may be necessary for the support of Virterbi.

DCT represents a group of addition/subtraction patters used for the implementation of DCT and IDCT operations. Several patterns may be necessary.

SCATTER represents a group of scatter/gather/merging patterns, which may be deemed useful to support.

For general access, the control matrix, C, may be loaded using the address specified in ICn. With VML equal to 8, one 16-bit word is needed for each VAL unit. Hence, C must be accessed as a vector competing with pre-fetches of other operands. With respect to sustained throughput, the multiplier vectors are normally half the width of the ALU vectors and the pre-fetch unit is designed to sustain full throughput t the ALU.

The VMU result, M, the VALU result, R, or a direct operand, X or Y, may be used for the AAU operation. The result of the AAU is available as Q in the VALU.

The AAU should be correct when forming −(−1) as a fractional number. The result may need to be approximated as 0x7fff or expanded by one bit to properly represent this operation.

3.3.2.1 AAU Vector Mode Operations

The single operand AAU Vector instructions is:

[T, F, B, none].V.AAS [Xi, Yj, M, R], [pattern, [Icn, [0 or none, +VL, −VL, SC]]]

The defined C matrix patterns are the following:

PASS or IDENTITY

TRANSPOSE

SUM_TO_{—}0

SUM_ALL

SUM_PAIRS or SUM_PAIRS_EVEN

SUM_PAIRS_ODD

COMPLEX_REAL or COMPLEX_REAL_EVEN

COMPLEX_IMAG or COMPLEX_IMAG_EVEN or SUM_PAIRS_ODD

COMPLEX_REAL_ODD

COMPLEX_IMAG_ODD or SUM_PAIRS_EVEN

FFT2

FFT4

FFT8

(others)

3.3.2.2 AAU Register Mode Operations

The three operand AAU Register instructions are:

[T, none].R.CMACR Rd, [Xi.d, S], [Yj.d, S]

[T, none].R.CMACI Rd, [Xi.d, S], [Yj.d, S]

[T, none].R.CMULR Rd, [Xi.d, S], [Yi.d, S]

[T, none].R.CMULI Rd, [Yi.d, S], [Yj.d, S]

[T, none].R.DMAC Rd, [Xi.d, S], [Yj.d, S]

[T, none].R.DMSU Rd, [Yi.d, S], [Yj.d, S]

Please note, these Register Mode operations also require the cooperation of the VMU and VALU elements associated with Rd (and in some cases, Rd+1).

33.3 AAU Type Conversions

The AAU performs a limited operand promotion whereby it places an operand X, Y or M, into either the low or high halves of an extended precision format compatible with the operand type. Hence, for a Byte operand, it may be positioned in bit 7 to 0, i.e., a placement of 0, or it may be positioned in the extended bits, bits 11 to 8, i.e., a placement of 1. Table 3-8 shows the placement and bit position of the different operands. (Note, all even placements are regarded the same as placement of 0 and all odd placements are regarded the same a placement of 1. This allows a more consistent identification of operand significance.)

TABLE 3-8
Placement and Bit Position of Different Operands

| Operand | Placement | Bit Positions |
|---|---|---|
| Byte | 0, 2, 4 or 6 | 7 to 0 |
| | 1, 3, 5 or 7 | 11 to 8 |
| Half-Word | 0 or 2 | 15 to 0 |
| | 1 or 3 | 23 to 16 |
| Word | 0 | 31 to 0 |
| | 1 | 47 to 32 |

No placement is performed for the extended precision operand R as this operand already occupies all the available bit positions. In FIG. 10, the horizontal lines under the AAU segments illustrate where the operands are positioned for the standard position and for the guard position, labeled G.

3.3.4 AAU Hardware Implementation

FIG. 10 shows the implementation of the AAU as a set of 12-bit wide segments. Multiplexors control the delivery of operands for each segment as illustrated below the diagram of the segments. Sign extension is necessary when a smaller operand is used in a segment (such as an X or Y operand). FIG. 11 shows the multiplexors, operand positioning and sign extension processes. The implementation of the array addition for each result element, Qⱼ, is shown in FIG. 9.

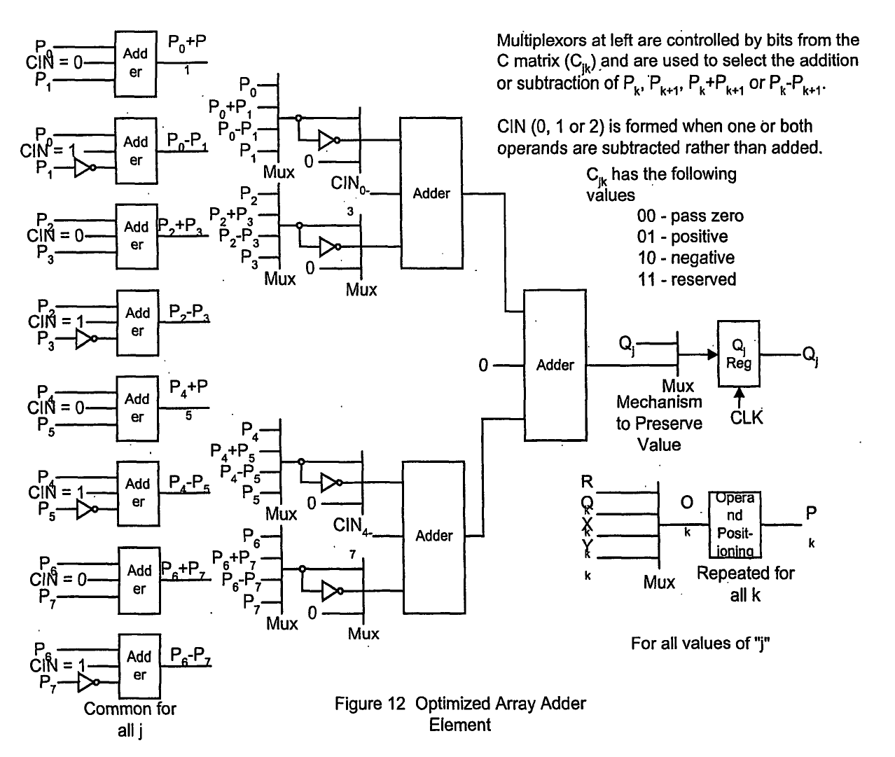

An alternate implementation of the array addition, shown in FIG. 12, uses a common first stage to form shared terms resulting from the combination of two inputs of either positive or negative polarity. These terms may then be selected for use in the second level of additions in the AAU. The implementation in this manner saves a number of adders, as only one addition and one subtraction herein after refereed to as “adders”) is necessary. Table 3-9 shows the possible combinations of two inputs.

TABLE 3-9
Combinations of Two Input Terms

| C_{j,B} | C_{j,A} | Result |
|---|---|---|
| 00 | 00 | zero |
| 00 | 01 | A |
| 00 | 10 | −A |
| 01 | 00 | B |
| 01 | 01 | A + B |
| 01 | 10 | B − A |
| 10 | 00 | −B |
| 10 | 01 | A − B |
| 10 | 10 | −A − B |

The implementation shown in FIG. 9 uses four adders in the first level for each of 8 independent Qⱼ elements for a total of 32 adders. Using the alternative implementation in FIG. 12, two adders are needed for every two input terms, Pₖ (shown as A and B in the above table) for a total of 8 adders. The reduced the number of adders comes at the expense f requiring 4-input multiplexors and the associated routing between all of the vector elements.

Accordingly, a vector processor as described herein may comprise a vector of multipliers computing multiplier results; and an array adder computational unit computing an arbitrary linear combination of the multiplier results. The array adder computational unit may have a plurality of numeric inputs that are added, subtracted or ignored according to a control vector comprising the numeric values 1, −1 and 0, respectively. The array adder computational unit may comprise at least 4 or at least 8 inputs, and may comprise at least 4 outputs.

3.4 Vector Arithmetic, Logic and Shift Unit (VALU)

The Vector ALU (VALU) performs the traditional arithmetic, logical, shifting and rounding operations. The operands are the results of the VMU, AAU or VALU as M, Q, R or T respectively, direct inputs, X and Y and scalar, S. The VALU result, T, is not available for all Register mode instructions. The operands for the VALU instructions are symbolized by the following:

A∈{X, S, T, M, Q, R}

B∈{Y, S, T, M, Q, R}

The basic operations performed by the VALU instructions are the following:

| | | |
|---|---|---|
| R = A + B | | |
| R = A − B | | |
| R = B − A | | |
| R = \|A\| | | (absolute value) |
| R = \|A − B\| | | (absolute difference) |
| R = A | | |
| R = −A | | |
| R = ˜A | | (not) |
| R = A & B | | (and) |
| R = A \| B | (or) | |
| R = A \hat{ } B | | (xor) |
| R = A << exp | | (exp can be +, 0 or −, shift is arithmetic or |
| | | logical) |
| R = A >> exp | | (exp can be +, 0 or −, shift is arithmetic or |
| | | logical) |
| R = R \hat{ } A << exp | | |
| R = R \hat{ } A >> exp | | |

Special considerations for ETSI routines accommodate overflow and shifting situations. Arithmetic shift right allows for optional rounding to the resulting LSB. Similarly, arithmetic shift left allows for saturation.

This unit is also responsible for conditional operations to perform merging, scatter and gather. In addition, there is a need for some logical operations and comparisons for specialized algorithms such as Virterbi decoding.

3.4.1 VALU Block Diagram

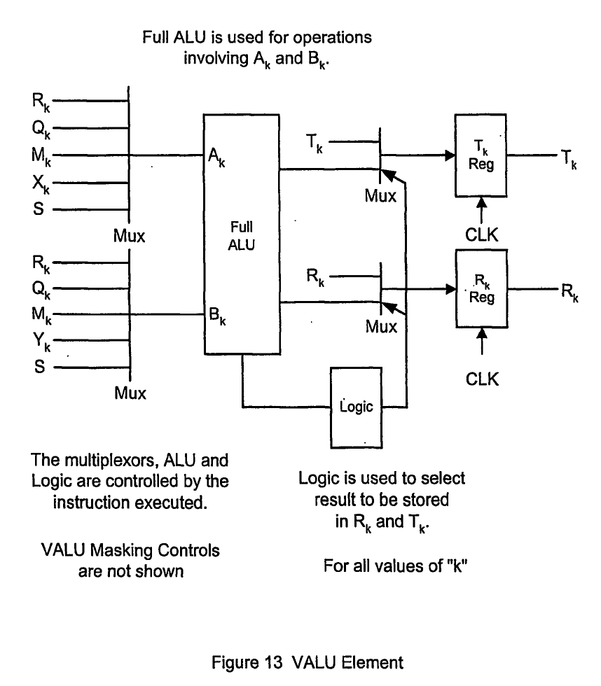

A VALU Element is illustrated in FIG. 13. The multiplexors at the left, controlled by the decoded instruction, are used to select the operands. The operand-type registers provide the sign and type attributes.

3.4.2 VALU Standard Functions

The VALU performs a variety of traditional arithmetic, logical, shifting and rounding operations. The operands are the results of the VMU, AAU or VALU as M, Q, R or T respectively, direct inputs, X and Y and scalar, S. The VALU result, T, is not available for all Register mode instructions.

The shift count for shift operations would need to be specified by a register or immediate value. The shift count may be either positive or negative where a negative shift count reverses the shift direction (as in C Language). The result of the shift may be optionally rounded and saturated.

3.4.2.1 VALU Vector Mode Operations

The dual operand VALU Vector instructions are:

| | |
|---|---|
| [T, F, E, none].V.ABD | [Xi, S, T, Q, M, R], [Yj, S, T, Q, M, R] |
| [T, F, E, none].V.ADD | [Xi, S, T, Q, M, R], [Yj, S, T, Q, M, R] |
| [T, F, E, none].V.ADDC | [Xi, S, T, Q, M, R], [Yj, S, T, Q, M, R] |
| [T, F, E, none].V.CMP | [Xi, S, T, Q, M, R], [Yj, S, T, Q, M, R] |
| [T, F, E, none].V.SUB | [Xi, S, T, Q, M, R], [Yj, S, T, Q, M, R] |
| [T, F, E, none].V.SUBC | [Xi, S, T, Q, M, R], [Yj, S, T, Q, M, R] |
| [T, F, E, none].V.SUBR | [Xi, S, T, Q, M, R], [Yj, S, T, Q, M, R] |
| [T, F, E, none].V.DIV | [Xi, S, T, Q, M, R], [Yj, S, T, Q, M, R] |
| [T, F, E, none].V.AND | [Xi, S, T, Q, M, R], [Yj, S, T, Q, M, R] |
| [T, F, E, none].V.OR | [Xi, S, T, Q, M, R], [Yj, S, T, Q, M, R] |
| [T, F, E, none].V.XOR | [Xi, S, T, Q, M, R], [Yj, S, T, Q, M, R] |
| [T, F, E, none].V.SHLA | [Xi, S, T, Q, M, R], [Yj, S, T, Q, M, R] |
| [T, F, E, none].V.SHLL | [Xi, S, T, Q, M, R], [Yj, S, T, Q, M, R] |
| [T, F, E, none].V.SHRA | [Xi, S, T, Q, M, R], [Yj, S, T, Q, M, R] |
| [T, F, E, none].V.SHRL | [Xi, S, T, Q, M, R], [Yj, S, T, Q, M, R] |

The single operand VALU Vector instructions are:

| | |
|---|---|
| [T, F, E, none].V.ABS | [Xi, Yj, S, T, Q, M, R] |
| [T, F, E, none].V.NEG | [Xi, Yj, S, T, Q, M, R] |
| [T, F, E, none].V.ROUND | [Xi, Yj, S, T, Q, M, R] |
| [T, F, E, none].V.SAT | [Xi, Yj, S, T, Q, M, R] |
| [T, F, E, none].V.NOT | [Xi, Yj, S, T, Q, M, R] |
| [T, F, E, none].V.EXP | [Xi, Yj, S, T, Q, M, R] |
| [T, F, E, none].V.NORM | [Xi, Yj, S, T, Q, M, R] |
| [T, F, E, none].V.MOV | R, [Xi, Yj, S, T, Q, M, R] |
| [T, F, E, none].V.MOV | T, R |
| [T, F, E, none].V.XCH | R, T |

3.4.2.2 VALU Register Mode Operations

The three operand VALU Register instructions are:

| | |
|---|---|
| [T, none].R.CMACR | Rd, [Xi.d, S], [Yj.d, S] |
| [T, none].R.CMACI | Rd, [Xi.d, S], [Yj.d, S] |
| [T, none].R.CMULR | Rd, [Xi.d, S], [Yj.d, S] |
| [T, none].R.CMULI | Rd, [Xi.d, S], [Yj.d, S] |
| [T, none].R.DMAC | Rd, [Xi.d, S], [Yj.d, S] |
| [T, none].R.DMSU | Rd, [Xi.d, S], [Yj.d, S] |
| [T, none].R.DMUL | Rd, [Xi.d, S], [Yj.d, S] |
| [T, none].R.MAC | Rd, [Xi.d, S], [Yj.d, S] |
| [T, none].R.MSU | Rd, [Xi.d, S], [Yj.d, S] |
| [T, none].R.MUL | Rd, [Xi.d, S], [Yj.d, S] |

The dual operand VALU Register instructions are:

| | |
|---|---|
| [T, none].R.MUL | Rd, [Rs, Xi.d, Yj.d, S, C4, C16, C32] |
| [T, none].R.SQR | Rd, [Rs, Xi.d, Yj.d, S] |
| [T, none].R.SQRA | Rd, [Rs, Xi.d, Yj.d, S] |

Please note, these Register Mode operations also require the cooperation of the VMU and AAU elements associated with Rd (and in some cases, Rd+1).

The dual operand VALU Register instructions are:

| [T, none].R.ABD | Rd, [Rs, Ts, Xi.d, Yj.d, S, C4, C16, C32] |
|---|---|
| [T, none].R.ABS | Rd, [Rs, Xi.d, Yj.d, S] |
| [T, none].R.ADD | Rd, [Rs, Ts, Xi.d, Yj.d, S, C4, C16, C32] |
| [T, none].R.ADDC | Rd, [Rs, Ts, Xi.d, Yj.d, S, C4, C16, C32] |
| [T, none].R.CMP | Rd, [Rs, Ts, Xi.d, Yj.d, S, C4, C16, C32] |
| [T, none].R.SUB | Rd, [Rs, Ts, Xi.d, Yj.d, S, C4, C16, C32] |
| [T, none].R.SUBC | Rd, [Rs, Xi.d, Yj.d, S, C4, C16, C32] |
| [T, none].R.SUBR | Rd, [Rs, Xi.d, Yj.d, S, C4, C16, C32] |
| [T, none].R.DIV | Rd, [Rs, Xi.d, Yj.d, S, C4, C16, C32] |
| [T, none].R.AND | Rd, [Rs, Ts, Xi.d, Yj.d, S, C4, C16, C32] |
| [T, none].R.OR | Rd, [Rs, Ts, Xi.d, Yj.d, S, C4, C16, C32] |
| [T, none].R.XOR | Rd, [Rs, Ts, Xi.d, Yj.d, S, C4, C16, C32] |
| [T, none].R.MAX | Rd, [Rs, Xi.d, Yj.d, S] |
| [T, none].R.MIN | Rd, [Rs, Xi.d, Yj.d, S] |
| [T, none].R.NEG | Rd, [Rs, Xi.d, Yj.d, S] |
| [T, none].R.NOT | Rd, [Rs, Xi.d, Yj.d, S] |
| [T, none].R.BITC | Rd, [Rs, Xi.d, Yj.d, S, C4] |
| [T, none].R.BITI | Rd, [Rs, Xi.d, Yj.d, S, C4] |
| [T, none].R.BITS | Rd, [Rs, Xi.d, Yj.d, S, C4] |
| [T, none].R.BITT | Rd, [Rs, Xi.d, Yj.d, S, C4] |
| [T, none].R.EXP | Td, Rd |
| [T, none].R.NORM | Rd, Td |
| [T, none].R.SHLA | Rd, [Rs, Xi.d, Yj.d, S, C4, C16, C32] |
| [T, none].R.SHLL | Rd, [Rs, Xi.d, Yj.d, S, C4, C16, C32] |
| [T, none].R.SHRA | Rd, [Rs, Xi.d, Yj.d, S, C4, C16, C32] |
| [T, none].R.SHRL | Rd, [Rs, Xi.d, Yj.d, S, C4, C16, C32] |
| [T, none].R.REVB | Rd, [Rs, Xi.d, Yj.d, S, C4] |
| [T, none].R.VIT | Rd, [Rs, Xi.d, Yj.d, S] |
| [T, none].R.MOV | Rd, [Rs, Ts, Xi.d, Yj.d, S, C4] |
| The single operand VALU Register instructions are: | |
| [T, none].R.ROUND | Rd |
| [T, none].R.SAT | Rd |

3.4.3 VALU Type Conversions

The VALU performs a limited operand promotion whereby it places an operand X, Y, M or S, into either the low or high positions of an extended precision format compatible with the operand type. Hence, for a Byte operand, it may be positioned in bits 7 to 0, (placement of 0), or it may be positioned in the extended bits, bits 11 to 8, (placement of 1). Note, all even placements are regarded the same as placement of 0 and all odd placements are regarded the same a placement of 1. This allows a more consistent identification of operand significance. Table 3-10 shows the placement and bit position of the different operands.

TABLE 3-10
Placement and Bit Position of Operands

| Operand | Placement | Bit Positions |
|---|---|---|
| Byte | 0, 2, 4 or 6 | 7 to 0 |
| | 1, 3, 5 or 7 | 11 to 8 |
| Half-Word | 0 or 2 | 15 to 0 |
| | 1 or 3 | 23 to 16 |
| Word | 0 | 31 to 0 |
| | 1 | 47 to 32 |

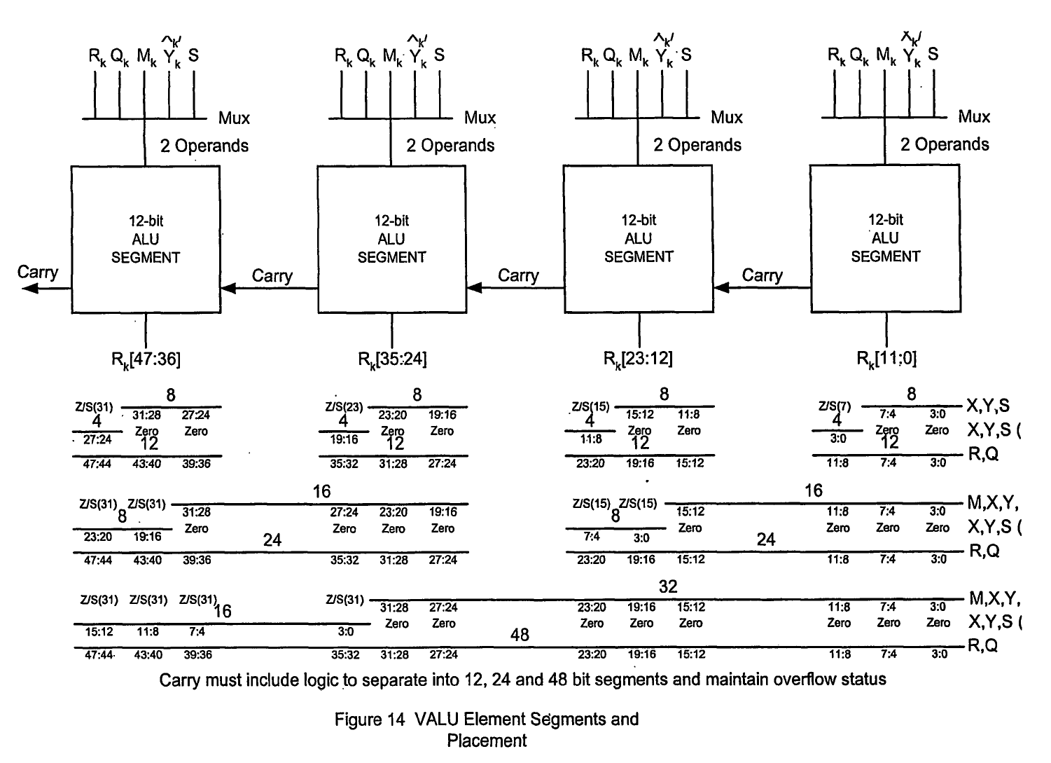

No placement is performed for the extended precision operands R, T and Q as these operands already occupies all the available bit positions. In FIG. 14, the horizontal lines under the ALU segments illustrate where the operands are positioned for the standard position and for the guard position, labeled G.

3.4.4 VALU Hardware Implementation

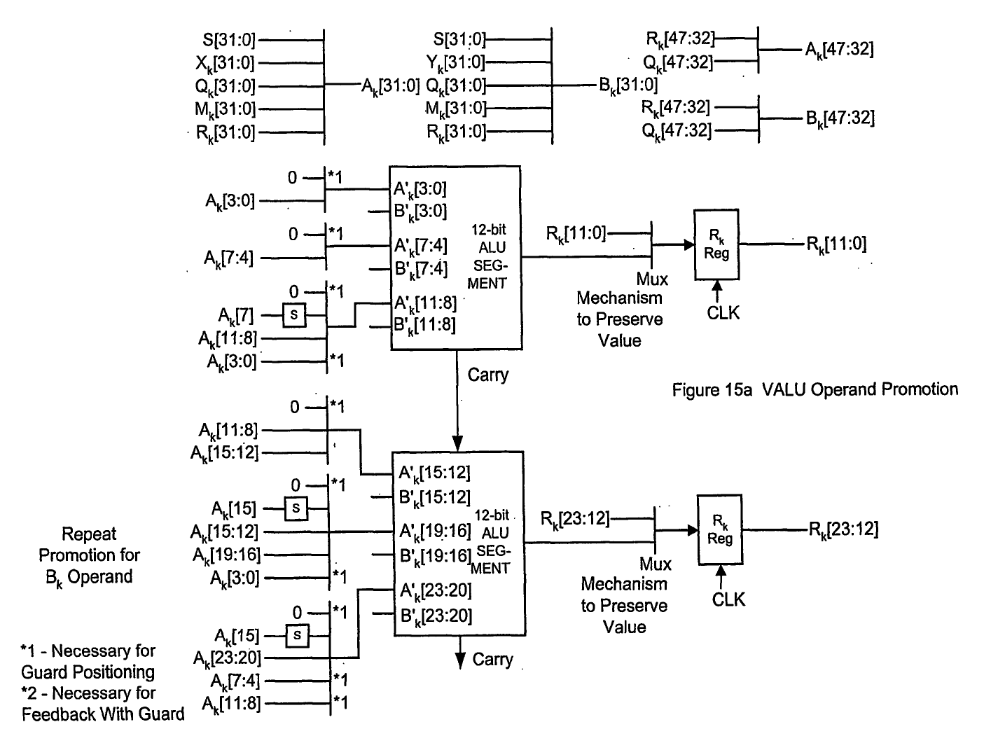

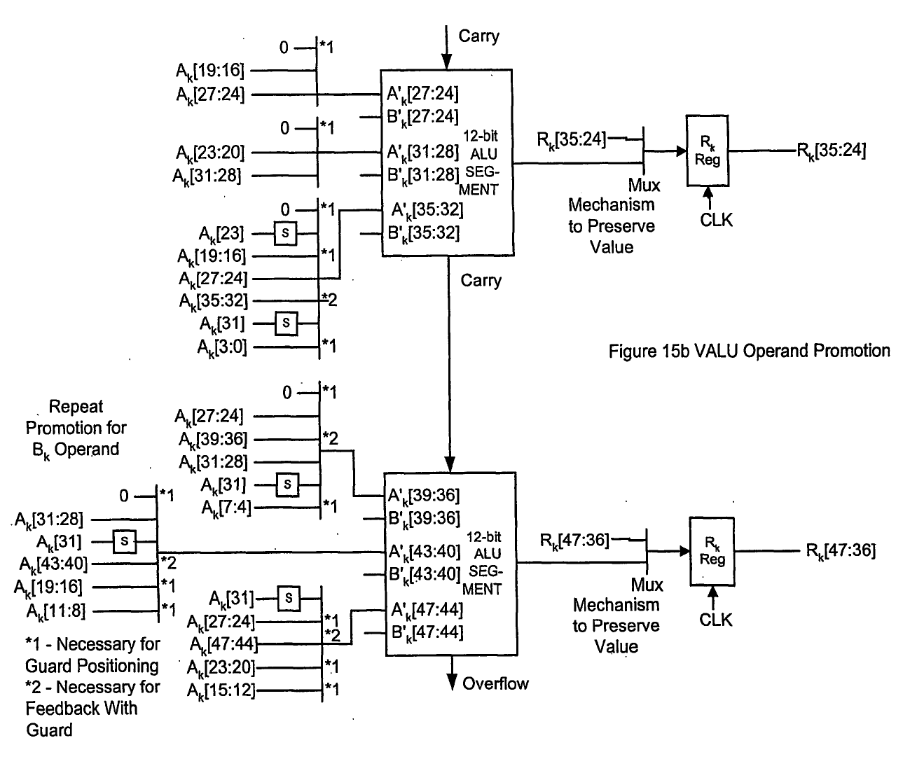

FIG. 14 shows the implementation of the VALU as a set of 12-bit wide segments. Multiplexors control the delivery of operands for each segment as illustrated below the diagram of the segments. Sign extension is necessary when a smaller operand is used in a segment (such as an X or Y operand). FIGS. 15a and 15b shows the multiplexors, operand positioning and sign extension processes.

3.5 Scalar ALU (SALU)

The Scalar ALU (SALU) performs the simple arithmetic, logical and shifting operations for the support of program control flow operations and special address calculations not supported by the dedicated address pointer operations. The SALU is positioned early in the processor pipeline to permit both control flow operations (such as for program loops and other logic tests) and address calculations (such as for indexing into arrays) to be done without waiting for the full length of the standard processing pipeline. The SALU functional unit is positioned as shown in FIGS. 1-3 immediately after the SALU instruction decoder.

The operands are the SALU result register, S, and an immediate constant, general purpose registers, G[7:0], the VAR registers consisting of (Izn, Tzn, Bzn and Lzn) as well as other special processor registers such as VEM and VCM. Depending on the interconnection complexities, processor may also support operands from individual elements of M, Q, R, T, X and Y.

3.5.1 SALU Standard Functions

The SALU performs a variety of traditional arithmetic, logical and shifting operations. The operands are the SALU result register, S, and an immediate constant, general purpose registers, G[7:0], the VAR registers consisting of (Izn, Tzn, Bzn and Lzn) as well as other special processor registers such as VEM and VCM. Depending on the interconnection complexities, processor may also support operands from individual elements of M, Q, R, T, X and Y.

The shift count for shift operations would need to be specified by a register or immediate value. The shift count may be either positive or negative where a negative shift count reverses the shift direction (as in C Language).

The dual operand SALU Register instructions are:

| | |
|---|---|
| [T, none].S.ABS | S, [register, C4, C16, C32] |
| [T, none].S.ADD | S, [register, C4, C16, C32] |
| [T, none].S.CMP | S, [register, C4, C16, C32] |
| [T, none].S.SUB | S, [register, C4, C16, C32] |
| [T, none].S.AND | S, [register, C4, C16, C32] |
| [T, none].S.OR | S, [register, C4, C16, C32] |
| [T, none].S.XOR | S, [register, C4, C16, C32] |
| [T, none].S.NEG | S, [register, C4, C16, C32] |
| [T, none].S.NOT | S, [register, C4, C16, C32] |
| [T, none].S.SHLA | S, [register, C4, C16, C32] |
| [T, none].S.SHLL | S, [register, C4, C16, C32] |
| [T, none].S.SHRA | S, [register, C4, C16, C32] |
| [T, none].S.SHRL | S, [register, C4, C16, C32] |
| [T, none].S.REVB | S, [register, C4, C16, C32] |
| [T, none].S.MOV | S, [register, C4, C16, C32] |
| [T, none].S.XCH | S, [register] |

These instructions are designed for use in program control flow operations using loop counter (for, while or do loops), supporting conditional run time tests (if/else conditionals) and logical combinations of complex conditional tests (using and/or/not operations). Array address calculations are supported by the arithmetic and shift operations used to perform multiplications of an array index by its element size (in bytes). Once a calculation is completed, the result may be transferred to a processor specific register using the exchange command, XCH.

3.5.2 SALU Type Conversions

The SALU performs no operand conversions as all of its operands are used as 32-bit operands.

Accordingly, a device as described herein may implement a method to improve responsiveness to program control operations. The method may comprise providing a separate computational unit designed for program control operations, positioning the separate computational unit early in the pipeline thereby reducing delays, and using the separate computation unit to produce a program control result early in the pipeline to control the execution address of a processor.

A related method may improve the responsiveness to an operand address computation. The method may comprise providing a separate computational unit designed for operand address computations, positioning said separate computational unit early in the pipeline thereby reducing delays, and using said separate computation unit to produce a result early in the pipeline t be used as an operand address.

### Section 4. Conversion Units

4.1 Overview

Operand conversion units are used for the conversion of operands read from memory (X and Y), after the multiplier produces a result for storage into M, operand inputs to the AAU and VALU, and for result storage back to memory. The conversion of operands to/from memory is regarded as the most general. The other conversions are specialized for each of its associated units (VMU, AAU and VALU).

As of this writing, the conversions associated with the VMU, AAU and VALU have been presented in Section 3.

The VMU conversion is limited to operand demotion as growth in operand size is natural with multiplication. In order to match operand sizes and reduce complexity in vector length computation logic, VMU results may only be demoted. (Promotion is essentially handled by forcing VMU operand size to be at least 16 bits when a 32-bit result is required in M.)

The AAU and VALU promote operands to permit them to represent a normal or a guard position. Support of the guard position is provided to allow a program to specify the full-extended precision maintained by the functional unit

4.2 Conversion Hardware Implementation

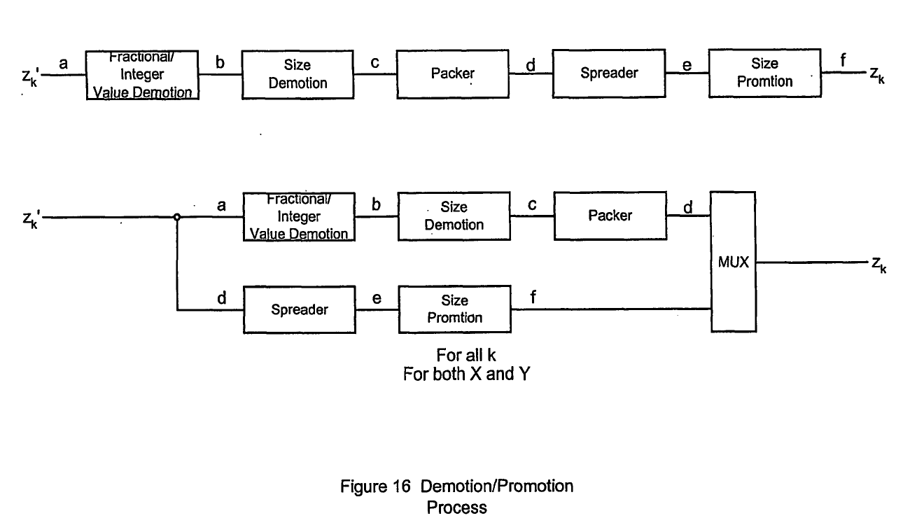

Based on the operand data type, size, and the operation type, a conversion from one from operand form to another may be necessary. The steps involved in this conversion are 1) Fractional/Integer Value Demotion, 2) Size Demotion, 3) Packer, 4) Spreader and 5) Size Promotion. FIG. 16 illustrates the conversion process to convert a data operand for use in a vector processor unit.

There are two equivalent implementations. The first implementation is a linear sequence of the five processing functions. The second form exploits the knowledge that either a demotion or a promotion is being used (and not both). The processing delay may be reduced through use of this structure. It requires an additional multiplexor to select the properly formatted operand. Either process may be used to pass through an operand unaltered for the cases where no promotion/demotion is necessary.

4.2.1 Factional/Integer Value Demotion

Fractional numbers are commonly saturated if the extended precision value (held in the guard bits) is different than the sign bits. Signed 32/48-bit Fractional numbers greater than 0x0000 7fff ffff are limited to this value as Fractional numbers less than 0xffff 8000 0000 are limited to this value. Unsigned 32/48-bit Fractional numbers greater than 0x0000 ffff ffff are limited to this value.

Fractional numbers may also be rounding to improve the accuracy of the least significant bit retained. When converting 32/48-bit Fractional numbers to a 16-bit number, the value 0x0000 0000 8000 is effectively added (for positive numbers) or subtracted (for negative numbers) to round the fractional number prior to reducing its precision.

Integer numbers may also be saturated identically as Fractional numbers. They are not however rounded. Integer saturation may also require limiting the values to smaller numeric ranges when reducing the precision from 32/48-bits to 6-bits as an example. In addition, Integer numbers may be saturated to special ranges when they are used to convey image information. For some color image formats, the intensity (luminance) is to be bounded within the range [16, 240] and the color (chrominance) is to be bounded within the range [16, 235].

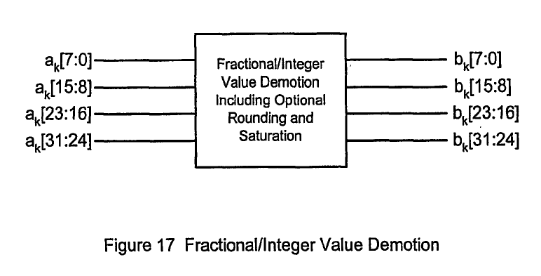

Hence, Fractional demotion is used to round and/or saturate an operand before it is converted through demotion to a smaller sized operand. Integer demotion is used to saturate an operand before it is converted through demotion to a smaller sized operand. The data operand may be either 16 to 32-bits (or 48 bits for the result write conversion) in size. The Fractional demotion process is illustrated in FIG. 17 and is described in the following subsections. Fractional demotion (saturation and rounding) should not be used in any conversions of Fractional operands if multi-precision operations are being performed in software.

4.2.1.1 Saturation

If the conversion is to a byte, then all bytes above the selected byte must be the same as the sign bit (or zero if unsigned). If not, the number is saturated to a value according to its sign (if it is signed, otherwise limited to the maximum value the converted value may represent). A similar conversion is performed if the conversion is to a half-word.

Special Integer video saturation mode is provided for limited luminance values to the range [16, 240] and chrominance values to the range [16, 235]. The use of special limits is conveyed through the operand-type registers associated with the target operand. Note, the conversion need not be to a byte size for the special Integer video saturation modes. Table 4-1 shows the saturation limits for signed and unsigned operands.

TABLE 4-1
Saturation Limits

| Target | Maximum | Minimum | Maximum | Minimum |
|---|---|---|---|---|
| Operand | Signed | Signed | Unsigned | Unsigned |
| Byte | 0x7f | 0x80 | 0xff | 0x00 |
| Half-Word | 0x7fff | 0x8000 | 0xffff | 0x0000 |
| Word | 0x7fff ffff | 0x8000 0000 | 0xffff ffff | 0x0000 0000 |
| Luma | 240 = 0xf0 | 16 = 0x10 | 240 = 0xf0 | 16 = 0x10 |
| Chroma | 235 = 0xEB | 16 = 0x10 | 235 = 0xEB | 16 = 0x10 |

4.2.1.2 Rounding

Rounding is used to more accurately represent a Fractional value when only a higher order partial word is being used as a target operand. Rounding may be either unbiased or biased. Most DSP algorithms prefer the use of unbiased rounding to prevent inadvertent digression. Speech coder algorithms explicitly require the use of biased rounding operations as they were specified by functional implementation commonly performed by ordinary Integer processors by the unconditional addition of the rounding value.

4.2.2 Size Demotion

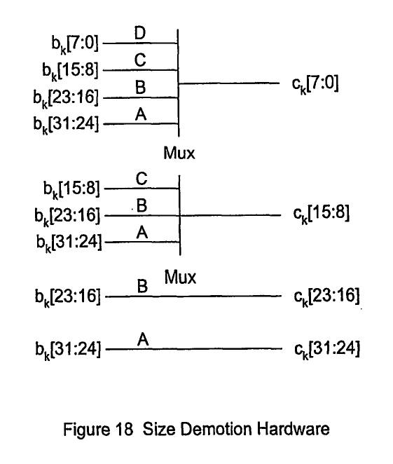

Size demotion is used to select the 8 or 16-bit sub-field of the 16 or 32-bit Integer or Fractional operand. (Fractional numbers are also subject to this demotion when converting operand sizes.) FIG. 18 illustrates the hardware implementation of this processing. The symbol, bₖ[i:j], represents bits i to j of element k of vector b.

For a 32-bit operand consisting of the bytes ABCD, and a pair of 16-bit operands consisting of the byte pairs AB and CD. Table 4-2 defines the size demotion process.

TABLE 4-2
Size Demotion

| Data Operand | Target Operand | Position | 31:24 | 23:16 | 15:8 | 7:0 |
|---|---|---|---|---|---|---|
| Word | Byte | 3 or 7 | | | | A |
| | | 2 or 6 | | | | B |
| | | 1 or 5 | | | | C |
| | | 0 or 4 | | | | D |
| Word | Half-Word | 1 or 3 | | | A | B |
| | | 0 or 2 | | | C | D |
| Half-Word | Byte | 1, 3, 5 or 7 | | * | A* | C |
| | | 0, 2, 4 or 6 | | * | B* | D |
| Word | Word | Any | A | B | C | D |
| Half-Word | Half-Word | Any | A | B | C | D |

A single byte result is placed on the lowest 8 bits. A half-word result is placed on the lowest 16 bits. A pair of bytes related to a single byte from each of two half-words is placed on the lowest 16 bits of the word (* indicates the usual position and A* rB* represents this alternative position). These conventions are considered as the “normalized” orientation for further processing by the Vector Packer. All positions not explicitly filled are do-not-care values. They may be held at zero (as a constant) value to conserve power by reducing switching of circuits.

4.23 Vector Packer

The packer reorganizes the data operands into a set of adjacent elements. This completes the process of demotion. The packing operation uses 1, 2 or 4 bytes from each 32-bit element The normalized forms used are:

| Data Operand | Target Operand | 31:24 | 23:16 | 15:8 | 7:0 |
|---|---|---|---|---|---|
| Word | Byte | | | | D |
| Word | Half-Word | | | C | D |
| Half-Word | Byte | | * | C* | D |
| Byte | Byte | A | B | C | D |
| Half-Word | Half-Word | A | B | C | D |
| Word | Word | A | B | C | D |

Consider the vector to be composed of Aₖ, Bₖ, Cₖ, and Dₖ representing the ABCD bytes as given in the table above for the k^{th} element. The packer is responsible for compressing the unused space out of the vector so that each vector processor (up to the length of the vector) is delivered data for processing.

This conversion step uses C* (instead of the position indicated by *) when converting from Half-Words to Bytes assuming the “normalized” orientation with the two Bytes packed into the lower Half-Word. This internal convention is used to simplify and regularize the packer logic.

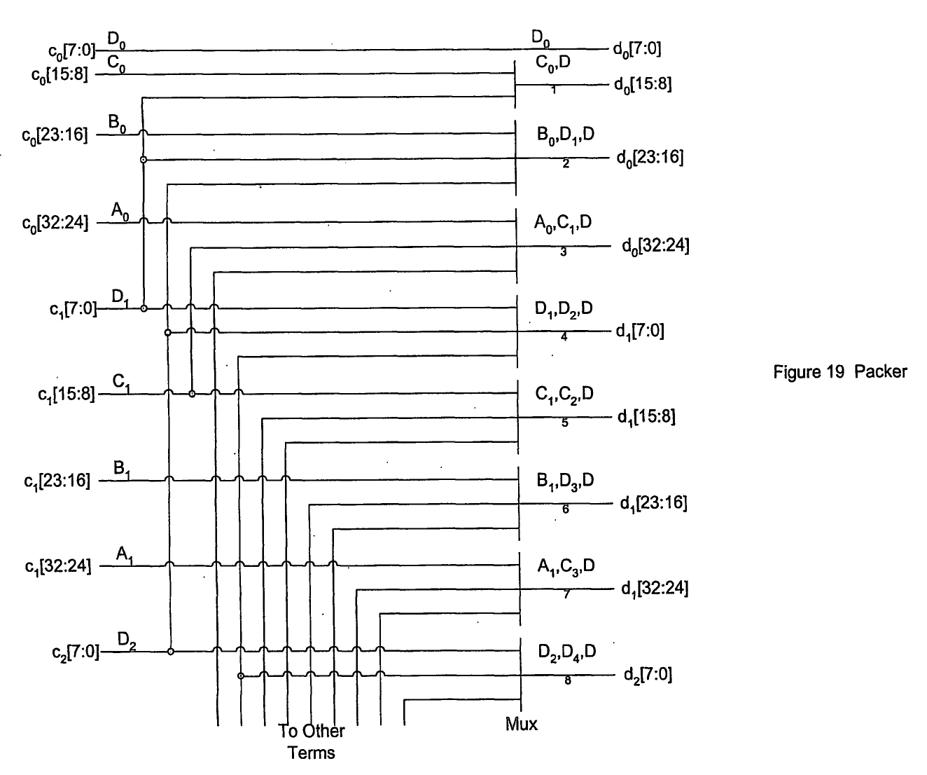

FIG. 19 illustrates the hardware implementation of the Vector Packer. Table 4-3 identifies the packing operation for representative 32-bit vector processors.

TABLE 4-3
Packing Operation

| | | | | | |
|---|---|---|---|---|---|
| Data Operand | Target Operand | 31:24 | 23:16 | 15:8 | 7:0 |

Element 0

| | | | | | |
|---|---|---|---|---|---|
| Word | Byte | D₃ | D₂ | D₁ | D₀ |
| Word | Half-Word | C₁ | D₁ | C₀ | D₀ |
| Half-Word | Byte | C₁* | D₁ | C₀* | D₀ |
| Byte | Byte | A₀ | B₀ | C₀ | D₀ |
| Half-Word | Half-Word | A₀ | B₀ | C₀ | D₀ |
| Word | Word | A₀ | B₀ | C₀ | D₀ |

Element 1

| | | | | | |
|---|---|---|---|---|---|
| Word | Byte | D₇ | D₆ | D₅ | D₄ |
| Word | Half-Word | C₃ | D₃ | C₂ | D₂ |
| Half-Word | Byte | C₃* | D₃ | C₂* | D₂ |
| Byte | Byte | A₁ | B₁ | C₁ | D₁ |
| Half-Word | Half-Word | A₁ | B₁ | C₁ | D₁ |
| Word | Word | A₁ | B₁ | C₁ | D₁ |

Element 2

| | | | | | |
|---|---|---|---|---|---|
| Word | Byte | D₁₁ | D₁₀ | D₉ | D₈ |
| Word | Half-Word | C₅ | D₅ | C₄ | D₄ |
| Half-Word | Byte | C₅* | D₅ | C₄* | D₄ |
| Byte | Byte | A₂ | B₂ | C₂ | D₂ |
| Half-Word | Half-Word | A₂ | B₂ | C₂ | D₂ |
| Word | Word | A₂ | B₂ | C₂ | D₂ |

Element 3

| | | | | | |
|---|---|---|---|---|---|
| Word | Byte | D₁₅ | D₁₄ | D₁₃ | D₁₂ |
| Word | Half-Word | C₇ | D₇ | C₆ | D₆ |
| Half-Word | Byte | C₇* | D₇ | C₆* | D₆ |
| Byte | Byte | A₃ | B₃ | C₃ | D₃ |
| Half-Word | Half-Word | A₃ | B₃ | C₃ | D₃ |
| Word | Word | A₃ | B₃ | C₃ | D₃ |

The tables continue for all the vector processor elements. This conversion step uses C* (instead of a B) when converting from Half-Words to Bytes assuming the “normalized” orientation with the two Bytes packed into the lower Half-Word. This internal convention is used to simplify and regularize the packer logic.

It is anticipated that due to finite vector length, demotion and packing will be limited by the number of words available from the pre-fetch buffer. If more vector processors are enabled than the amount of data extracted from half-words or words, then corrective action may be necessary. The corrective action may include trapping the processor to inform the developer or performing additional vector data operand pre-fetches to obtain all the required data. The partial vector would need to be saved in a register while the rest of the data is obtained. The packer network would need to allow for a distributor function to deliver the entire byte or half-word vector in pieces.

4.2.4 Vector Spreader

The spreader re-organizes the data operands from a packed form into a more precision data type (such as U.8.0 to S. 15.0 in video). The spreading operation provides 1, 2 or 4 bytes for each 32-bit element in normalized form (position 0). If a “position” other than normalized is desired, then a second step is required.

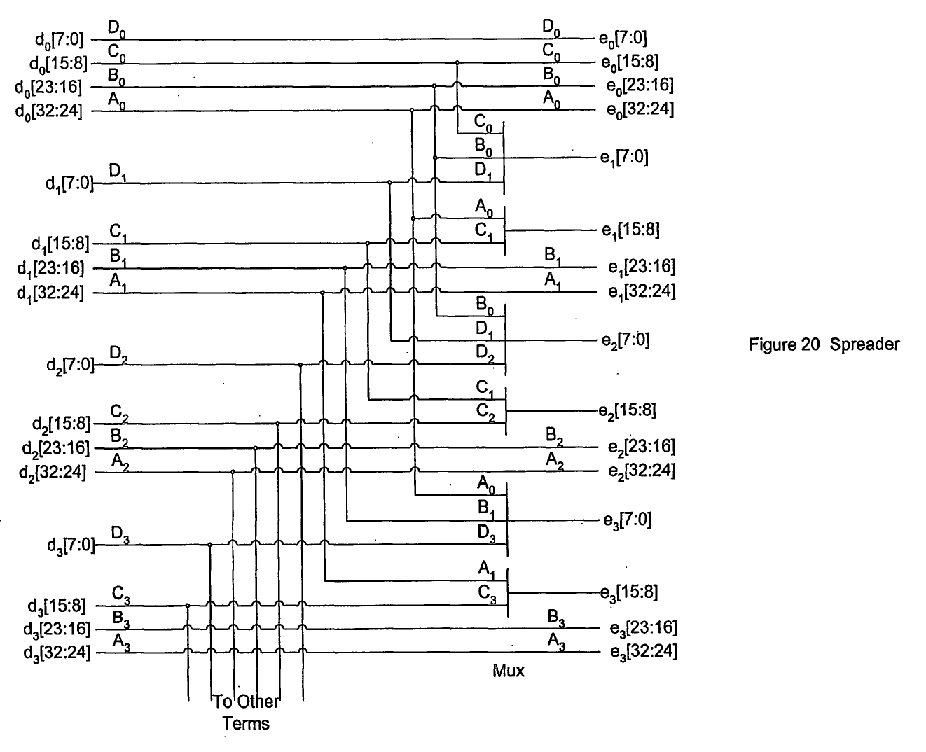

Consider the vector composed of Aₖ, Bₖ, Cₖ, and Dₖ representing the ABCD bytes for the k^{th} element FIG. 20 illustrates the hardware implementation of the Vector Spreader. Table 44 identifies the spreading operation for representative 32-bit vector processors

TABLE 4-4
Spreading Operation

| | | | | | |
|---|---|---|---|---|---|
| Data Operand | Target Operand | 31:24 | 23:16 | 15:8 | 7:0 |

Element 0

| | | | | | |
|---|---|---|---|---|---|
| Byte | Word | | | | D₀ |
| Byte | Half-Word | | * | C₀* | D₀ |
| Half-Word | Word | | | C₀ | D₀ |
| Byte | Byte | A₀ | B₀ | C₀ | D₀ |
| Half-Word | Half-Word | A₀ | B₀ | C₀ | D₀ |
| Word | Word | A₀ | B₀ | C₀ | D₀ |

Element 1

| | | | | | |
|---|---|---|---|---|---|
| Byte | Word | | | | C₀ |
| Byte | Half-Word | | * | A₀* | B₀ |
| Half-Word | Word | | | A₀ | A₀ |
| Byte | Byte | A₁ | B₁ | C₁ | D₁ |
| Half-Word | Half-Word | A₁ | B₁ | C₁ | D₁ |
| Word | Word | A₁ | B₁ | C₁ | D₁ |

Element 2

| | | | | | |
|---|---|---|---|---|---|
| Byte | Word | | | | B₀ |
| Byte | Half-Word | | * | C₁* | D₁ |
| Half-Word | Word | | | C₁ | D₁ |
| Byte | Byte | A₂ | B₂ | C₂ | D₂ |
| Half-Word | Half-Word | A₂ | B₂ | C₂ | D₂ |
| Word | Word | A₂ | B₂ | C₂ | D₂ |

Element 3

| | | | | | |
|---|---|---|---|---|---|
| Byte | Word | | | | A₀ |
| Byte | Half-Word | | * | A₁* | B₁ |
| Half-Word | Word | | | A₁ | B₁ |
| Byte | Byte | A₃ | B₃ | C₃ | D₃ |
| Half-Word | Half-Word | A₃ | B₃ | C₃ | D₃ |
| Word | Word | A₃ | B₃ | C₃ | D₃ |

A pair of bytes related to a single byte from each of two half-words is placed on the lowest 16 bits of the word (* indicates the usual position and A* or B* represents this alternative position). These conventions are considered as the “normalized” orientation for further processing by the Vector Spreader. All positions not explicitly filled are do-not-care values. They may be held at zero (as a constant) value to conserve power by reducing switching of circuits.

4.2.5 Size Promotion

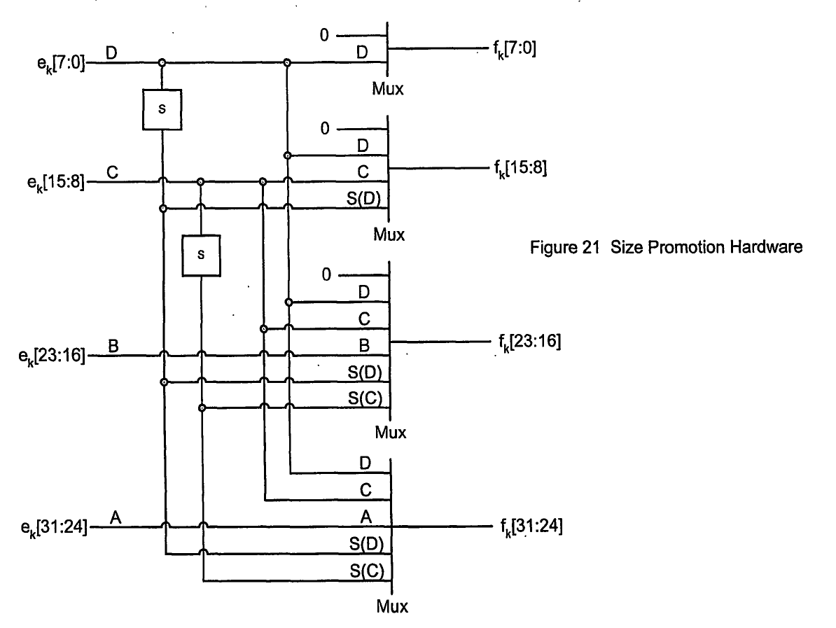

Size promotion is used to position the smaller Integer or Fractional operand into the desired field of the target operand. The operand is presented as a set of bytes, ABCD. FIG. 21 illustrates the hardware implementation. Table 4-5 specified the size promotion.

TABLE 4-5
Size Promotion

| Data | | | | | | |
|---|---|---|---|---|---|---|
| Operand | Target Operand | Position | 31:24 | 23:16 | 15:8 | 7:0 |
| Byte | Word | 0 or 4 | S(D) | S(D) | S(D) | D |
| | | 1 or 5 | S(D) | S(D) | D | zero |
| | | 2 or 6 | S(D) | D | zero | zero |
| | | 3 or 7 | D | zero | zero | zero |
| Byte | Half-Word | 0, 2, 4 or 6 | S(C*) | C* | S(D) | D |
| | | 1, 3, 5 or 7 | C | zero | D | zero |
| Half-Word | Word | 0 or 2 | S(C) | S(C) | C | D |
| | | 1 or 3 | C | D | zero | zero |
| Byte | Byte | Any | A | B | C | D |
| Half-Word | Half-Word | Any | A | B | C | D |
| Word | Word | Any | A | B | C | D |

A byte operand may be placed into any byte of the half-word or word target operand. Sign extension may be used if the operand is signed; zero fill is otherwise used. Similar conversions are used for positioning half-word into word operands.

This conversion step uses C* (instead of a B) when converting from Bytes to Half-Words assuming the “normalized” orientation with the two Bytes packed into the lower Half-Word. This internal convention is used to simplify and regularize the spreader logic.

4.3 Operand Matching Logic

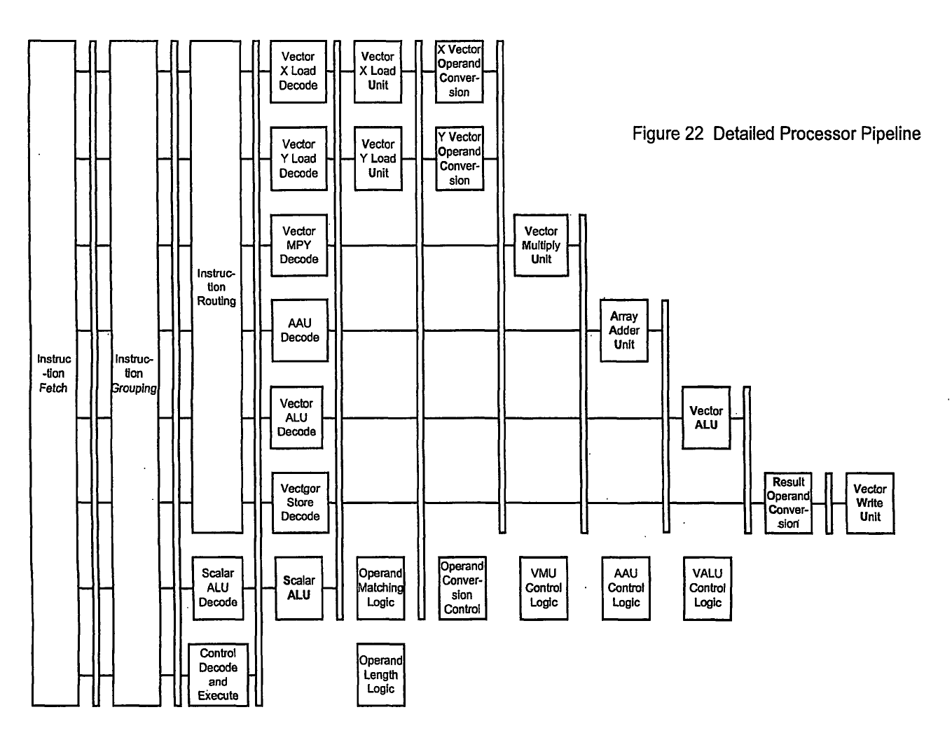

Concurrent to the loading of operands, the Operand Matching Logic (shown in FIG. 22) evaluates the types of operands and the scheduled operations. This logic determines common operand types for the VMU, AAU and VALU. This section described the algorithm coded in a C-like style. If “Auto” or “Unspecified” attributes are used in an operation-type register, TMOP or TRIES, operand-type matching logic is used to adjust the operation type to the largest of the operands to be used for an operation. Otherwise, the operands are converted to the size requested for an operation according to TMOP or TRES as appropriate.

4.3.1 VMU Type Determination

VMU Operand and Operation Types are determined according to the following algorithm:

Symbols

AUTO represents an unspecified operand size

OS8 represent an 8-bit operand/result size

OS16 represent a 16 bit operand/result size

OS32 represent a 32-bit operand/result size

Inputs

TMOP is the operand type register for the VMU

TRES is the result type register for the VMU, AAU and ALU

TU is the operand type register for U operand vector (an X, S operand)

TV Is the operand type register for V operand vector (an Y, S or R operand)

Outputs

TUV is the common operand type register for the VMU

TM is the result type register for the VMU M result vector

Algorithm

```
    if (TMOP == AUTO) {
    if(single operand used) {
        TUV = TU; /* or TV depending on which operand
        vector is selected */
    } else /* dual operands are used */ {
        if ((TU == OS32) ∥ (TV == OS32)) {
            TUV = OS32;
        }else if ((TU == OS16) ∥ (TV == OS16))
            TUV = OS16;
        } else /* both must be OS8 */ {
            TUV = OS8;
        }
    }
    } else {
    TUV = TMOP;
    }
if (TRES == AUTO) {
    if (TUV == OS8) {
        TM = OS16;
        } else /* either OS32 or OS16 */
            TM = OS32;
        }
    } else {
        TM = TRES;
        if (TRES == OS32) && (TUV == OS8)) {
            TUV = OS16; /* Needs adjustment for
                            required result format */
        }
    }
```

The VMU result is optionally demoted after a computation to match the result format (according to TRES) used in the rest of the functional units. In cases where an 8-bit operand would be used, a 16-bit operand may be forced if a 32-bit result format is required.

Please note that the following code is used to reduce the number of comparisons and to exploit a particular bit encoding used for representing the operand sizes:

| if ((TU == OS32) ∥ (TV == OS32)) { /* statement 1 */ | |
|---|---|
| TUV = OS32; | |
| }else if ((TU == OS16) ∥ (TV == OS16)) | /* statement 2 */ |
| TUV = OS16; | |
| } else /* both must be OS8 */ { | /* statement 3 */ |
| TUV = OS8; | |
| } | |

For determining a common operand type from a pair of operands, the following logic is implemented by the above code fragment:

| TU | TV | TUV | Statement |
|---|---|---|---|
| OS8 | OS8 | OS8 | 3 |
| OS8 | OS16 | OS16 | 2 |
| OS8 | OS32 | OS32 | 1 |
| OS16 | OS8 | OS16 | 2 |
| OS16 | OS16 | OS16 | 2 |
| OS32 | OS8 | OS32 | 1 |
| OS32 | OS16 | OS32 | 1 |
| OS32 | OS32 | OS32 | 1 |

4.3.2 AAU Type Determination

AAU Operand and Operation Types are determined according to the following algorithm:

Symbols

AUTO represents an unspecified operand size

OS8 represent an 8-bit operand/result size

OS16 represent a 16-bit operand/result size

OS32 represent a 32-bit operand/result size

Inputs

TRES is the result type register for the VMU, AAU and ALU

TO is the operand type register for O operand vector (an X, Y, M or R operand)

Outputs

TQ is the result type register for the AAU Q result vector and the operand type for the AAU

```
Algorithm
if (TRES == AUTO) {
    TQ = TO;
} else {
    TQ = TRES;
}
```

43.3 VALU Type Determination

VALU Operand and Operation Types are determined according to the following algorithm:

Symbols

AUTO represents an unspecified operand size

OS8 represent an 8-bit operand/result size

OS16 represent a 16-bit operand/result size

OS32 represent a 32-bit operand/result size

Inputs

TRES Is the result type register for the VMU, AAU and ALU

TA is the operand type register for A operand vector (an X, S, T, Q, M, or R operand)

TB is the operand type register for B operand vector (an Y, S, T, Q, M, or R operand)

Outputs

TR is the result type register for the VALU R result vector and the common operand type for the VALU

Algorithm

```
if (TRES == AUTO) {
if(single operand used) {
    TR = TA; /* or TB depending on which operand vector is selected */
} else /* dual operands are used */ {
    if ((TA== OS32) ∥ (TB== OS32)) {
        TR = OS32;
    }else if ((TA == OS16) ∥ (TB == OS16))
        TR = OS16;
    } else /* both must be OS8 */ {
        TR = OS8;
    }
}
} else {
TR = TRES;
}
```

43.4 Additional Type Determination Considerations

The type determination as exemplified above would need additional decisions when feeding back and forward operands such as R, M, Q and T. For feedback operands, the operand type, TU, TV, TO, TA or Th, would be taken from TR, TM, T or TT from the previous cycle (i.e. the type would correspond to the previously computed operand type). For a feed forward operand, the operand type TO, TA or TB would be taken from the current cycle's TM or TQ (i.e. the type would correspond to the newly computed operand type). The adaptation of the algorithms to fully support the feedback and feed forward operands is relatively simple for one skilled in the art.

Accordingly, a processor as described herein may perform an operation on first and second operand data having respective operand formats. The device may comprise a first hardware register specifying a type attribute representing an operand format of the first data, a second hardware register specifying a type attribute representing an operand format of the second data, an operand matching logic circuit determining a common operand format to be used for both of the first and second data in performing the operation based on the first type attribute of the first data and the second type attribute of the second data, and a functional unit that performs the operation in accordance with the common operand type.

A related method as described herein may include specifying an operation type attribute representing an operation format of the operation, specifying in a hardware register an operand type attribute representing an operand format of data to be used by the operation, determining an operand conversion to be performed on the data to enable performance of the operation in accordance with the operation format based on the operation format and the operand format of the data, and performing the determined operand conversion. The operation type attribute may be specified in a hardware register or in a processor instruction. The operation format may be an operation operand format or an operation result format.

A related method as described herein may include specifying in a hardware register an operation type attribute representing an operation format, specifying in a hardware register an operand type attribute representing a data operand format, and performing the operation in a functional unit of the computer in accordance with the specified operation type attribute and the specified operand type attribute. The operation format may be an operation operand format or an operation result format.

A related method as described herein may provide an operation that is independent of data operand type. The method may comprise specifying in a hardware register an operand type attribute representing a data operand format of said data operand, and performing the operation in a functional unit of the computer in accordance with the specified operand type attribute. Alternatively, the method may comprise specifying in a first hardware register an operand type attribute representing an operand format of a first data operand, specifying in a second hardware register an operand type attribute representing an operand format of a second data operand, determining in an operand matching logic circuit a common operand format to be used for both of the first and second data in performing the operation based on the first type attribute of the first data and the second type attribute of the second data, and performing the operation in a functional unit of the computer in accordance with the determined common operand.

A related method for performing operand conversion in a computer device as described herein may comprise specifying in a hardware register an original operand type attribute representing an original operand format of operand data, specifying in a hardware register a converted operand type attribute representing a converted operand format to which the operand data is to be converted, and converting the data from the original operand format to the converted operand format in an operand format conversion logic circuit in accordance with the original operand type attribute and the converted operand type attribute. The operand conversion may occur automatically when a standard computational operation is requested. The operand conversion may implement sign extension for an operand having an original operand type attribute indicating a signed operand, zero fill for an operand having an original operand type attribute indicating an unsigned operand, positioning for an operand having an original operand type attribute indicating operand position, positioning for an operand in accordance with a converted operand type attribute indicating a converted operand position, or one of fractional, integer and exponential conversion for an operand according to the original operand type attribute or the converted operand type attribute.

4.4 Operand Length Logic

After the common operand and operation types are determined, the vector operand lengths corresponding to the data elements consumed by an operation may be determined. This process matches the number of elements processed by each unit. The vector length, once determined, is used for loop control and for advancing the address pointer(s) related to the operand(s) accessed and consumed for an operation. Within a loop, it is assumed that all the operations will be of the same number of elements. For operand addressing, each pointer used may be incremented by a different value representing the number of elements consumed times the size of the operand in memory. The following algorithm is used for determining the number of elements processed:

Symbols

OS8 represent an 8-bit operand/result size

OS16 represent a 16-bit operand/result size

OS32 represent a 32-bit operand/result size

Inputs

L is the number of 32-bit hardware elements

TUV is the common operand type register for the VMU

TM is the result type register for the VMU M result vector

TQ Is the result type register for the AAU Q result vector and the operand type for the AAU

TR is the result type register for the VALU R result vector and the common operand type for the VALU

Input and Output—Used as Input and Produced as an Output

LM is the result length (in elements) register for the VMU M result vector

LQ is the result length (in elements) register for the AAU Q result vector

LR is the result length (in elements) register for the VALU R result vector

Outputs

VML is the length of vector (In elements) consumed by the VMU

AAL is the length of vector (in elements) consumed by the AAU

VAL is the length of vector (in elements) consumed by the VALU

```
Algorithm
/* Determine VMU Operand Length Requirements */
    if (TUV == OS8) {
    if ((TU == OS32) ∥ (TV == OS32)) {
        VML = 8;
    } else {
        VML = 16;
    }
} else if (TUV == OS16) {
    VML = 8;
} else /* TUV == OS32 */ {
    if (VMY_MODE_8_32×32_ENABLE) {
        VML = 8;
    } else {
        VML = 4;
    }
}
if ((mpy_operand_u == OPERAND_R) ∥
(mpy_operand_v == OPERAND_R)) {
    if (VML > LR) {
        VML = LR;
    }
    if (VML < LR) {
        /* Allow this mismatch for now using fewer elements of R */
    }
}
/* Determine AAU Operand Length Requirements */
    if (aau_operand_o == OPERAND_M) {
    AAL = VML;
    } else {
    if (TQ == OS8) {
        if (TO == OS32) {
            AAL = 8;
        } else if (TO == OS16) {
            AAL = 16;
        } else {
            AAL = 32;
        }
    } else if (TQ == OS16) {
        if (TO == OS32) {
            AAL = 8;
        } else {
            AAL = 16;
        }
    } else /* TQ == OS32 */ {
        AAL = 8;
    }
}
/* Determine VALU Operand Length Requirements */
if ((alu_operand_a == OPERAND_M) ∥
(alu_operand_b == OPERAND_M)) {
    VAL = VML;
    } else if ((alu_operand_a == OPERAND_Q) ∥
    (alu_operand_b == OPERAND_Q)) {
    VAL = AAL;
    } else if ((alu_operand_a == OPERAND_R) ∥
    (alu_operand_b == OPERAND_R)) {
    VAL = LR;
    } else if (TR == OS8) {
    if ((TA == OS32) ∥ (TA == OS32)) {
        VAL = 8;
    } else if ((TA == OS16) ∥ (TA == OS16)) {
        VAL = 16;
    } else {
        VAL = 32;
    }
} else if (TR == OS16) {
    if ((TA == OS32) ∥ (TA == OS32)) {
            VAL = 8;
        } else {
            VAL = 16;
        }
} else /* TR == OS32 */ {
    VML = 8;
}
```

LM=VML;

LQ=AAL;

LR=VAL;

An alternative implementation uses length information (in bytes, not counting extension/guard bits) associated with each of the operand and result registers.

Symbols

OS8 represent an B-bit operand/result size

OS16 represent a 16-bit operand/result size

OS32 represent a 32-bit operand/result size

Inputs

L is the number of 8-bit elements enabled (maximum value is number of 8-bit hardware elements)

TU is the operand type register for U operand vector (an X, S operand)

TV Is the operand type register for V operand vector (an Y, S or R operand)

TUV is the common operand type register for the VMU

TM is the result type register for the VMU M result vector

TO is the operand type register for 0 operand vector (an X, Y, M or R operand)

TQ is the result type register for the AAU Q result vector and the operand type for the AAU

TA is the operand type register for A operand vector (an X, S, T, Q, M, or R operand)

TB Is the operand type register for B operand vector (an Y, S, T, Q, M, or R operand)

TR is the result type register for the VALU R result vector and the common operand type for th VALU

LU is the operand length register for U operand vector (an X, S operand)

LV is the operand length register for V operand vector (an Y, S or R operand)

LUV is the common operand length register for the VMU

LM is the result length register for the VMU M result vector

LO is the operand length register for O operand vector (an X, Y, M or R operand)

LQ is the result length register for the AAU Q result vector and the operand type for the AAU

LA is the operand length register for A operand vector (an X, S, T, Q, M, or R operand)

LB is the operand length register for B operand vector (an Y, S, T, Q, M, or R operand)

LR is the result length register for the VALU R result vector and the common operand type for the VALU

Input and Output—Used as Input and Produced as an Output

LM is the result length register for the VMU M result vector

LQ is the result length register for the AAU Q result vector

LR is the result length register for the VALU R result vector

Outputs

VML Is the length of vector (In elements) consumed by the VMU

AAL Is the length of vector (in elements) consumed by the AAU

VAL is the length of vector (in elements) consumed by the VALU

Algorithm
/* Determine VMU U Operand Length Requirements */
if (mpy_operand_u == OPERAND_R) {
LU = min (LR, L);
} else if ((TU == OS32) && (TUV == OS16)) {

| | |
|---|---|
| LU = L/2; | /* Implemented as a shift right by one bit - L >> 1 */ |

} else if ((TU == OS32) && (TUV == OS8)) {

| | |
|---|---|
| LU = L/4; | /* Implemented as a shift right by two bits - L >> 2 */ |

} else if ((TU == OS16) && (TUV == OS8)) {

| | |
|---|---|
| LU = L/2; | /* Implemented as a shift right by one bit - L >> 1 */ |

```
} else {
    LU = L;
}
/* Determine VMU V Operand Length Requirements */
if (mpy_operand_v == OPERAND_R) {
    LV = min (LR, L);
    } else if ((TV == OS32) && (TUV == OS16)) {
```

| | |
|---|---|
| LV = L/2; | /* Implemented as a shift right by one bit - L >> 1 */ |

} else if ((TV == OS32) && (TUV == OS8)) {

| | |
|---|---|
| LV = L/4; | /* Implemented as a shift right by two bits - L >> 2 */ |

} else if ((TV == OS16) && (TUV == OS8)) {

| | |
|---|---|
| LV = L/2; | /* Implemented as a shift right by one bit - L >> 1 */ |

```
} else {
    LV = L;
}
LUV = min (LU, LV);
LU = LUV;
LV = LUV;
if (TUV == OS32) {
    LM = LUV;
} else {
```

| | |
|---|---|
| LM = LUV * 2; | /* Implemented as a shift left by one bit - L << 1 */ |

```
}
/* Determine AAU O Operand Length Requirements */
if (aau_operand_o == OPERAND_R) {
    LO = min (LR, L);
} else if (aau_operand_o == OPERAND_M) {
    LO = min (LM, L);
} else if ((TO == OS32) && (TQ == OS16)) {
```

| | |
|---|---|
| LO = L/2; | /* Implemented as a shift left by one bit - L >> 1 */ |

} else if ((TO == OS32) && (TQ == OS8)) {

| | |
|---|---|
| LO = L/4; | /* Implemented as a shift left by two bits - L >> 2 */ |

} else if ((TO == OS16) && (TQ == OS8)) {

| | |
|---|---|
| LO = L/2; | /* Implemented as a shift left by one bit - L >> 1 */ |

```
} else {
    LO = L;
}
LQ = LO;
/* Determine VALU A Operand Length Requirements */
if (alu_operand_a == OPERAND_R) {
    LA = min (LR, L):
} else if ((TA == OS32) && (TR == OS16)) {
```

| | |
|---|---|
| LA = L/2; | /* Implemented as a shift right by one bit - L >> 1 */ |

} else if ((TA == OS32) && (TR == OS8)) {

| | |
|---|---|
| LA = L/4; | /* lmplemented as a shift right by two bits - L >> 2 */ |

} else if ((TA == OS16) && (TR == OS8)) {

| | |
|---|---|
| LA = L/2; | /* Implemented as a shift right by one bit - L >> 1 */ |

```
} else {
    LA = L;
}
/* Determine VALU B Operand Length Requirements */
if (alu_operand_b == OPERAND_R) {
    LB = min (LR, L);
} else if ((TB == OS32) && (TR == OS16)) {
```

| | |
|---|---|
| LB = L/2; | /* Implemented as a shift right by one bit - L >> 1 */ |

} else if ((TB == OS32) && (TR == OS8)) {

| | |
|---|---|
| LB = L/4; | /* Implemented as a shift right by two bits - L >> 2 */ |

} else if ((TB == OS16) && (TR == OS8)) {

| | |
|---|---|
| LB = L/2; | /* Implemented as a shift right by one bit - L >> 1 */ |

} else {
LB = L;
}
LR = min (LA, LB);
LA = LR;
LB = LR;
/* Compute vector length equivalents in elements */
if (TM == OS32) {

| | |
|---|---|
| VML = LM/4; | /* Implemented as a shift right by two bits - LM >> 2 */ |

} else if (TM == OS16) {

| | |
|---|---|
| VML = LM/2; | /* Implemented as a shift right by one bit - LM >> 1 */ |

} else /* TM == OS8 */ {
VML = LM;
}
if (TQ == OS32) {

| | |
|---|---|
| AAL = LQ/4; | /* Implemented as a shift right by two bits - LQ >> 2 */ |

} else if (TQ == OS16) {

| | |
|---|---|
| AAL = LQ/2; | /* Implemented as a shift right by one bit - LQ >> 1 */ |

} else /* TQ == OS8 */ {
AAL = LQ;
}
if (TR == OS32) {

| | |
|---|---|
| VAL = LR/4; | /* Implemented as a shift right by two bits - LR >> 2 */ |

} else if (TR == OS16) {

| | |
|---|---|
| VAL = LR/2; | /* Implemented as a shift right by one bit - LR >> 1 */ |

} else /* TR == OS8 */ {
VAL = LR;
}

Accordingly, a device as described herein may implement a method of controlling processing, comprising receiving an instruction to perform a vector operation using one or more vector data operands, and determining a number of vector data elements of the one or more vector data operands to be processed by the vector operation based on a number of vector data elements that constitute each vector data operand and a number of hardware elements available to perform the vector operation. Where multiple operations are involved, the method may comprise receiving instructions to perform a plurality of vector operations, each vector operation using one or more vector data operands, for each of the plurality of vector operations, determining a number of vector data elements of each of the one or more vector data operands to be processed by the vector operation based on a number of vector data elements that constitute each vector data operand of the operation and a number of hardware elements available to perform the vector operation, and determining a number of vector data elements to be processed by all of the plurality of operations by comparing the number of vector data elements to be processed for each respective vector operation.

A device as described herein may also implement a method for controlling processing in a vector processor that comprises performing one or more vector operations on data elements of a vector, determining a number of data elements processed by the vector operations, and updating an operand address register by an amount corresponding to the number of data elements processed.

4.5. Operand Conversion

The Vector Operand Conversion stage must evaluate all necessary concurrent conversions to schedule the use of the available hardware. The current implementation of the TOVEN Processor, as shown in FIG. 22, pr vides for two independent promotion units and demotion units allocated one each for X and Y vector operands. The operand conversions are prioritized with respect to functional unit, VMU, AAU and VALU. Since the superscalar grouping rules assume that a VALU instruction may use a concurrently executing AAU or VMU instruction result, and an AAU instruction may use a concurrently executing VMU instruction result, the VMU operands must be converted first, the AAU operands second and VALU operands last In the worst case, three clock cycles may be necessary if all three instructions require the same conversion unit In general, this may not need three clock cycles, because some of the operands may not need conversion and other operand conversions may be performed concurrently.

Symbols.

OS8 represent an 8-bit operand/result size

OS16 represent a 16-bit operand/result size

OS32 represent a 32-bit operand/result size

Inputs

TU is the operand type register for U operand vector (an X, S operand)

TV is the operand type register for V operand vector (an Y, S or R operand)

TUV is the common operand type register for the VMU

TM is the result type register for the VMU M result vector

TO is the operand type register for O operand vector (an X. Y, M or R operand)

TQ is the result type register for the MAU Q result vector and the operand type for the AAU

TA is the operand type register for A operand vector (an X, S, T, Q, M, or R operand)

TB is the operand type register for B operand vector (an Y, S, T, Q, M, or R operand)

TR is the result type register for the VALU R result vector and the common operand type

Outputs

```
Algorithm
/* Determine VMU X Operand Promotion/Demotion Requirements */
    if (TUV != TU) {
    if (TUV == OS32) {
        mpy_promote_x = TRUE;
    } else if (TU == OS8) {
        mpy_promote_x = TRUE;
    } else {
        mpy_promote_x = FALSE;
    }
    if (TU == OS32) {
        mpy_demote_x = TRUE;
    } else if (TUV == OS8) {
        mpy_demote_x = TRUE;
    } else {
        mpy_demote_x = FALSE;
    }
} else {
    mpy_promote_x = FALSE;
    mpy_demote_x = FALSE;
}
/* Determine VMU Y Operand Promotion/Demotion Requirements */
    if (TUV != TV) {
    if (TUV == OS32) {
        mpy_promote_y = TRUE;
    } else if (TV == OS8) {
        mpy_promote_y = TRUE;
    } else {
        mpy_promote_y = FALSE;
    }
    if (TV == OS32) {
        mpy_demote_y = TRUE;
    } else if (TUV == OS8) {
        mpy_demote_y = TRUE;
    } else {
        mpy_demote_y = FALSE;
    }
} else {
    mpy_promote_y = FALSE;
    mpy_demote_y = FALSE;
}
/* Determine AAU X/Y Operand Promotion/Demotion Requirements */
    if (TQ != TO) {
    if (TQ == OS32) {
        aau_promote = TRUE;
    } else if (TO == OS8) {
        aau_promote = TRUE;
    } else {
        aau_promote = FALSE;
    }
    if (TO == OS32) {
        aau_demote = TRUE;
    } else if (TQ == OS8) {
        aau_demote = TRUE;
    } else {
        aau_demote = FALSE;
    }
} else {
    aau_promote = FALSE;
    aau_demote = FALSE;
}
if (aau operand is X) {
    aau_promote_x = aau_promote;
    aau_demote_x = aau_demote;
}
if (aau operand is Y) {
    aau_promote_y = aau_promote;
    aau_demote_y = aau_demote;
}
/* Determine VALU X Operand Promotion/Demotion Requirements */
    if (TR != TA) {
    if (TR == OS32) {
        alu_promote_x = TRUE;
    } else if (TA == OS8) {
        alu_promote_x = TRUE;
    } else {
        alu_promote_x = FALSE;
    }
    if (TA == OS32) {
        alu_demote_x = TRUE;
    } else if (TR == OS8) {
        alu_demote_x = TRUE;
    } else {
        alu_demote_x = FALSE;
    }
} else {
    alu_promote_x = FALSE;
    alu_demote_x = FALSE;
}
/* Determine VALU Y Operand Promotion/Demotion Requirements */
    if (TR != TB) {
    if (TR == OS32) {
        alu_promote_y = TRUE;
    } else if (TB == OS8) {
        alu_promote_y = TRUE;
    } else {
        alu_promote_y = FALSE;
    }
    if (TB == OS32) {
        alu_demote_y = TRUE;
    } else if (TR == OS8) {
        alu_demote_y = TRUE;
    } else {
        alu_demote_y = FALSE;
    }
} else {
    alu_promote_y = FALSE;
    alu_demote_y = FALSE;
}
/* Match possible concurrent operations */
(This needs to be completed)
```

Please note that the following code is used to reduce the number of comparisons and to exploit a particular bit encoding used for representing the operand sizes:

| | |
|---|---|
| if (TUV != TU) { | /* statement 1 */ |

| | |
|---|---|
| if (TUV == OS32) { | /* statement 2 */ |

mpy_promote_x = TRUE;

| | |
|---|---|
| } else if (TU == OS8) { | /* statement 3 */ |

mpy_promote_x = TRUE;

| | |
|---|---|
| } else { | /* statement 4 */ |

mpy_promote_x = FALSE;

| } | |
|---|---|
| if (TU == OS32) { | /* statement 5 */ |

mpy_demote_x = TRUE;

| | |
|---|---|
| } else if (TUV == OS8) { | /* statement 6 */ |

mpy_demote_x = TRUE;

| | |
|---|---|
| } else { | /* statement 7 */ |

mpy_demote_x = FALSE;

}

} else {

| | |
|---|---|
| mpy_promote_x = FALSE; | /* statement 8 */ |
| mpy_demote_x = FALSE; | |

}

For determining the need for promotion or demotion, the following logic is implemented by the above code fragment

| TUV | TU | Promote | Demote | Statement(s) |
|---|---|---|---|---|
| OS8 | OS8 | no | no | 1 and 8 |
| OS8 | OS16 | no | yes | 6 |
| OS8 | OS32 | no | yes | 5 and 6 |
| OS16 | OS8 | yes | no | 3 |
| OS16 | OS16 | no | no | 1 and 8 |
| OS16 | OS32 | no | yes | 5 |
| OS32 | OS8 | yes | no | 2 and 3 |
| OS32 | OS16 | yes | no | 2 |
| OS32 | OS32 | no | no | 1 and 8 |

### Section 5. Load/Store Units

5.1 Overview

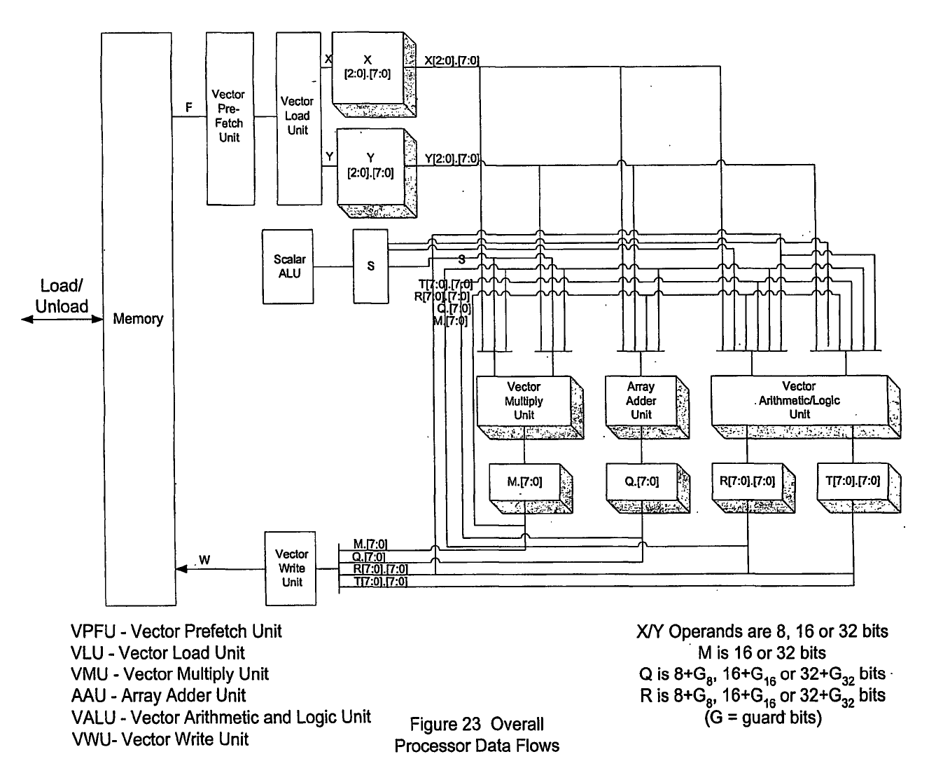

The load operations are performed though the cooperation of the Vector Prefetch Unit and the Vector Load Unit The Vector Write Unit performs the store operations. These units handle scalar and pointer load/store operations as well. FIG. 23 shows the overall data flow between the processing blocks (VMU, AAU, VALU) and the memory.

A single unified memory for local storage of as operands is used. Use of a single operand memory greatly simplifies algorithm design and compiler implementation. Memory addresses are specified in bytes to allow for Byte vectors. Byte-aligned memory allows for Half-word (2 byte), Word (4 byte), and Long (8 byte) vectors to be properly aligned. The Vector Pre-Fetch Unit (VPFU) is responsible for fetching vector operands and updating the address pointers for subsequent memory accesses. Compensation for a single memory is provided by caching or pre-fetching data at twice the rate it is consumed by executing instructions. Bach memory operand is accessed at twice (or slightly more than twice) the hardware vector length so that two-operand access throughput may be sustained.

5.2 Vector Load Unit

The Vector Load Unit (VLU) is visible to the programmer through the various forms of load instructions. These load instructions utilize the addressing registers for the access of memory operands.

5.2.1 Vector Address Registers

The vector addressing operation is specified by the following set of registers referred to as Vector Addressing Registers (VAR's):

index-Address Register (Izn)

Type Register (Tzn)

Base-Address Register (Bzn)

Length Register (or Upper Limit Register) (Lzn)

The Index-Address Register (Izn) specifies the current address. The Type Register (Tzn) identifies attributes of the type of data pointed to by the VAR. The Base-Address Register (Bzn) specifies the base address of the vector for a circular buffer. The Length Register (Lzn) specifies the length of the vector in bytes for a circular buffer. Setting the Length Register (Lzn) to value zero, will disable the circular buffer operation.

The above set of Vector Addressing Registers (VAR's) is used for reading each of the X and Y operand vectors. ‘z’, in the register names is replaced by ‘X’ and ‘Y’ respectively and ‘n’ is the register number (values of 0, 1 or 2).

Circular buffer operations in both the forward and reverse directions are implemented. When a buffer wrap occurs, the vector access may be split into two cycles where a portion of the vector is delivered for each cycle. This data is stored in the VPFU output registers until the entire vector is available.

5.2.2 Vector Address Increment and Step Register

The byte addresses in the Index Address Register (Izn) are post modified by one of the following:

Zero

+VL times operand size

−VL times operand size

Step Register (Sz) times operand size

Vector operands are typically accessed sequentially in either the forward or the backward direction. The use of +VL advances the vector forward and use of −VL moves the vector backward. The Step Registers, SX or SY, may contain either a positive or a negative value thus allowing either an arbitrary increment or decrement (an arbitrary memory stride). SX may only be used with accessing an X operand, while SY may only be used with accessing an Y operand.

Use of +VL or −VL enables the processor to determine the number of elements processed and advances the pointer to match. Hence algorithms may be written to be independent of the number of hardware elements. The number of elements processed depends on a number of factors including the number of available functional units, the operation size, any operand demotion, and matching result elements already processed. The determination of a Vector Length, VL, has been explained in Section 4 along with a proposed algorithm for determining VL.

The load instruction specifies the use of +VL or −VL in conjunction with an operand load. The actual increment/decrement of a pointer by VL is delayed until the operands are actually used. If the operands are not used and two new loads using the same pointers are performed, the pointers will be updated by the number of operands previously used, which in this case will be zero.

5.2.3 VLU Vector Mode Operations

The VLU Vector instructions are:

| | |
|---|---|
| [T, F, E, none].V.LD | Xi, IXn, [0 or none, +VL, −VL, SX] |
| [T, F, E, none].V.LD | Yj, IYn, [0 or none, +VL, −VL, SY] |

“Xi” is the register/operand to store the vector, “Lxn” is the index/pointer into cache-memory, and “[0 or none, +VL, −VL, SX]” is the post incremental value for the pointer “Ixn”.

5.2.4 VLU Scalar Mode Operations

The VLU Scalar instructions are:

| | |
|---|---|
| [T, none].LD | [Reg], Izn, [0 or none, +VL, −VL, Sz] |
| [T, none].LDPTR | [IXn, IYn, ICn, IWn, IPn], IPn, [0 or none, +VL, |
| | −VL, SIP] |
| [T, none].LDCPTR | [IXn, IYn, ICn, IWn, IPn], IPn, [0 or none, +VL, |
| | −VL, SIP] |

The first instruction is used for loading a single register as specified by the operation. If the register is an X operand element, then an IXn pointer (and its related VARs) is used (Y is analogous). For all other registers, the IPn pointer (and its related VARs) is used.

VARs are loaded with the second and third instructions. LDPTR is used for loading a linear address pointer into Izn and Tza and sets Bzn and Lzn to zero (disabling circular buffer operations). LDCPTR is used for loading a circular buffer pointer, thereby loading all four of these registers from memory. These instructions loads multiple registers for a VAR in one (or occasionally two) cycle exploiting the availability of a wide memory read path. For example, to load register DCO with value 0x10 the instructions are: SET IP0, 0x10; LDPTR IX0, IP0, +VL. The last argumnent “+VL” indicates the post-increment value for “IP0”.

When pointers are used to access structures, Tzn would indicate an unspecified operand type. This would be used for situations where arbitrary data is packed in a structure and each element would need to have its type specified by the programmer/compiler prior to its use. [Note, a default type may be indicated in Tzn instead of considering the perand as unspecified.]

When the X or Y Index Registers (DIn or IYn) are loaded, a pre-fetch operation begins. This data may be available for an immediately following vector operation.

5.3 Vector Write Unit

The Vector Write Unit (VWU) is visible to the programmer through the various forms of store instructions. These store instructions utilize the addressing registers for the writing of operands to memory.

The Result Operand Conversion Unit (ROCU) provides for several post operations including 1) conversion of Integer to/from Fractional, 2) biased and unbiased rounding, 3) saturation and 4) selection of result words from the extended precision accumulators. These operations are used when a result is to be stored to memory as well as when the R operand is fed back to the VMU or AAU.

Depending on the depth of the pipeline and algorithms, it may be necessary to invalidate data in the pre-fetch (cache) buffers and/or to stall the operand access from the pre-fetch buffer if the data being read has a pending write operation. A scoreboard technique may be used to track such pending writes and automatically delay the operand fetch. Traps could be used to indicate to the developer such occurrences so they may be eliminated or reduced in frequency.

5.3.1 Vector Address Registers

The vector addressing operation is specified by the following set of registers referred to as Vector Addressing Registers (VAR's):

Index-Address Register (IWn)

Type Register (TWn)

Base-Address Register (BWn)

Length Register (or Upper Limit Register) (LWn)

The Index-Address Register (IWn) specifies the current address. The Type Register (TWn) identifies attributes of the type of data pointed to by the VAR. The Base-Address Register (BWn), specifies the base address of the vector for a circular buffer. The Length Register (LWn) specifies the length of the vector in bytes for a circular buffer. Setting the Length register (Lzn) to value zero disables the circular buffer operation.

The above set of Vector Addressing Registers (VAR's) is used for writing (storing to memory) the T, Q, M and R result vectors. Letter ‘n’ (value of 0, 1 or 2) represents the register number.

5.3.2 Vector Address Increment and Step Register

The addresses in the Index-Address Register (Izn) are post modified by one of the following:

Zero

+VL times operand size

−VL times operand size

Step Register (SW) times operand size

Vector operands are typically accessed sequentially in either the forward or the backward direction. The use of +VL advances the vector forward and use of −VL moves the vector backward. The Step Register, SW may contain either a positive or a negative value thus allowing either an arbitrary increment or decrement (an arbitrary memory stride).

Use of +VL or −VL enables the processor to determine the number of result elements and advances the pointer to match. Hence algorithms may be written to be independent of the number of hardware elements. The number of elements processed depends on a number of factors including the number of available functional units, the operation size, any perand demotion and matching result elements already processed. The determination of a Vector Length, VL, has been explained in Section 4 along with a proposed algorithm for determining VL.

5.3.3 VWU Vector Mode Operations

The VWU Vector instructions are:

| | |
|---|---|
| [T, F, E, none].V.ST | [T, Q, M, R], IWn, [0 or none, +VL, −VL, SW] |

5.3.4 VWU Scalar Mode Operations

The VWU Scalar instructions are:

| | |
|---|---|
| [T, none].ST | [Reg], Izn, [0 or none, +VL, −VL, Sz] |
| [T, none].STPTR | [IXn, IYn, ICn, IWn, IPn], IPn, [0 or none, +VL, |
| | −VL, SIP] |
| [T, none].STCPTR | [IXn, IYn, ICn, IWn, IPn], IPn, [0 or none, +VL, |
| | −VL, SIP] |

The first instruction is used for storing a single register as specified by the operation. If the register is a T, Q, M or R operand element, then an IWn pointer (and its related VARs) is used. For all other registers, the IPn pointer (and its related VARs) is used.

The second and third instructions the store pointer VARs. The STPTR stores only the Izn and Tzn. The STCPTR loads all four of these registers to memory. These instructions permits single cycle (dual cycle in some instances) stores of multiple registers for a VAR exploiting the availability of a wide memory write path.

VARs are loaded with the second and third instructions. STPTR is used for storing a linear address pointer into Izn and Tzn. STCPTR is used for storing a circular buffer pointer, thereby writing all four of these registers to memory. These instructions store multiple registers for a VAR in one (or occasionally two) cycle exploiting the availability of a wide memory write path.

When pointers are used to access structures, Tzn would indicate an unspecified operand type. This would be used for situations where arbitrary data is packed in a structure and each element would need to have its type specified by the programmer/compiler prior to its use. [Note, a default type may be indicated in Tzn instead of considering the operand as unspecified.]

5.4 Vector Prefetch Unit

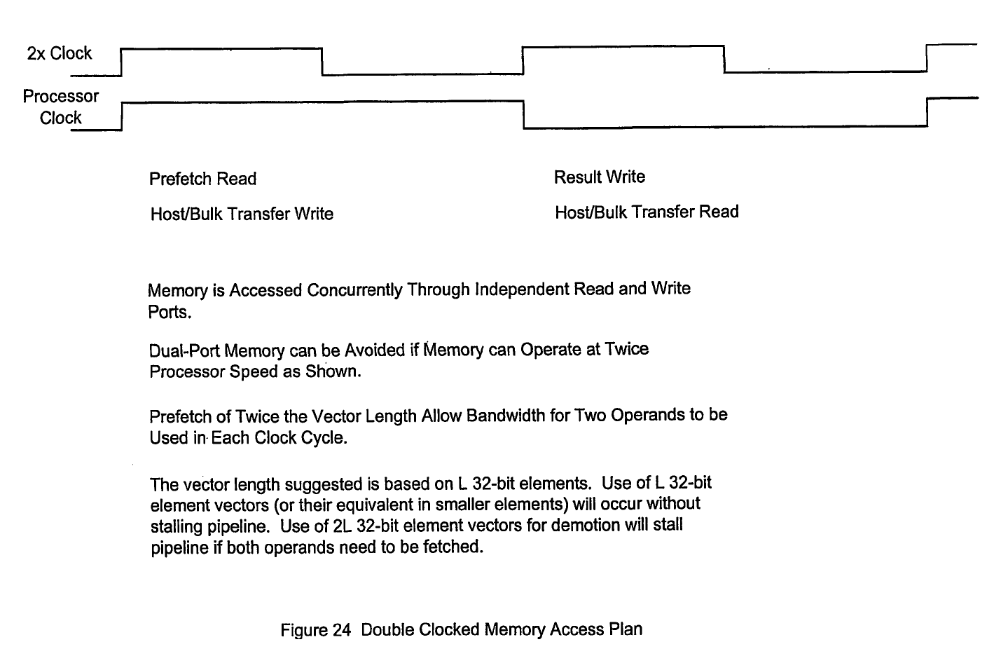

The Vector Prefetch Unit (VPFU) functions transparently to the programmer by prefetching operands into local line buffers for use by the VLU. FIG. 23 shows the overall data flow between the processing blocks (VMU, AAU, VALU) and the memory. The memory allows for multiple ports of access within one processor instruction cycle. These are 1) operand X read, 2) operand Y read, 3) result (T, Q, M, R) write, 4) Host or Bulk memory transfer read and 5) Host or Bulk memory transfer write. If memory is accessed at twice the processor instruction clock frequency, then the memory may be a single-port memory with separate read and write busses as illustrated in FIG. 24. Otherwise, dual-port memory, with separate read and write busses, would be needed in the implementation. The first half processor clock cycle would perform the X or Y operand prefetch (read) and the Host or Bulk memory transfer write cycle. The second half processor clock cycle would perform the R result write and the Host or Bulk memory transfer read cycle.

Note that in this organization, only one operand, X or Y, needs to be read at a time in any given clock cycle. With the use of prefetch and doubling the length of the operand vector reads, effective fetching of both X and Y operands can be sustained. If the processor has a vector length of 8, the prefetch preferably reads at least 16 elements. When the first vector f 8 is consumed from the first prefetch of 16 elements, the next vector can be prefetched. While the prefetch is in progress, the second vector of 8 from the first prefetch of 16 elements is available for access.

The Host and Bulk memory transfer operations would be arbitrated separately from the operand access. Prefetching can be initiated each time the corresponding address register is reloaded. As the vector operand is used, the prefetched data is immediately available and the next address is checked for being with the remaining prefetch buffer. The prefetch buffer can thus usually remain ahead of the data usage.

5.4.1 Vector Prefetch Registers

The following registers exist for the Vector Prefetch Unit:

Pre-Fetch Address Register (Pzn)

Pre-Fetch Data Registers (Dzn)

The Pre-Fetch Address Register, Pzn, is an internal register addressing the next pre-fetch. The Prefetch Data Register (Dzn) holds the lines read from memory.

5.4.2 Memory Access Trade-Offs

The throughput of two vectors of data per instruction (or clock cycle) is accommodated in a single-port memory system through prefetching twice the length of the vectors for each potential vector operand. As the pointer is initialized (or when the pointer is first used), the prefetch operation loads memory into a line buffer of twice the size of the vector. As instructions execute, assuming two vectors consumed in each clock, a prefetch of one or the other operand will occur.

The vectors may be fetched from memory in two manners. The first method is to fetch the line containing the start address of the vector. The second method fetches a line worth of data beginning with the start address of the vector. The differences, advantages and disadvantages of these two methods will be described in the following sections.

5.4.2.1 Fetch Line Containing Start Address of Vector

This fetches all data in the line such that the line is aligned with an address whose least significant bits are zero (referred to as the base address). The vector start address is contained somewhere within the line of data All memories are accessed with the same address.

Advantages

The memory access is uniform across all memory blocks. The base address of the line is used as the address into memory. The line is filled with the fetched block

Disadvantages

The line only contains the start address of the vector and may require an additional prefetch to complete an entire vector. Even if the first vector is complete, the second vector is partial and depending on the condition of the other vector operand, a processor stall may be necessary to complete both vectors. However, once two stalls occur, no further stalling is expected.

5.4.2.2 Fetch Line Beginning with Start Address of Vector

This fetches all the data in the vector. The data is placed into a line (or split across two lines) to hold the data The memory address for each block of memory (corresponding to each vector position) has to be generated uniquely. This leads to a replication of the memory decoding circuits for addressing.

Advantages

The prefetch has exactly two vectors in a line. Access to the first and second vectors is immediate. The only stall may occur if the prefetch of both vectors is not complete on the access to the first pair of vectors.

Disadvantages

The disadvantage of this approach is the duplication of the memory decoding circuits used for addressing. Bach memory block has its own address generated depending on the specific start address of the vector. The line is either partially filled, with the rest of the data placed into the adjacent line, or the line contains data in a wrapped fashion depending on the start address of the vector.

5.4.2.3 Analysis

Either method is acceptable. It is certainly desirable to prefetch two full vectors of data. This also has one less pipeline stall occur while the vectors are being prefetched initially. The additional logic to compute unique memory address and the partitioning of the memory into individual blocks is a relatively significant duplication of hardware. For this reason, the current implementation fetches full lines containing the vector start address and incurs two pipeline stalls that may occur. Once the two lines are filled, further stalls should never be needed.

5.4.3 Vector Length vs. Line Length

The vector length is dependent on the number of vector processors (VML and VAL) and the operand size. The line length represents the length of the data fetched from memory. For uninterrupted processing (i.e. no stalling), the line length needs to be twice the vector length. This balances the consumption rate with the production rate for the memory system providing exactly two vectors every clock cycle.

In the examples, the vector length is shown as 8 (L, VML and VAL). The system may use a different number of multiplier units than addition units (i.e., VML need not equal VAL). However, our first implementation will likely have an equal number of each type of unit.

The element size used in the examples for the multiplier unit is 16 bits, while the element size used in the addition unit is 16, 32 bits or possibly greater in length (guard bits). In order to balance the throughputs for any vector operands, the line lengths (in bits) needs to be:

2*max (VML, VAL)*max (operand size)

As an accommodation for this bandwidth mismatch, when 32-bit operands are used, the arithmetic unit may be used as two halves, where each half operates on the same length vector as the multiplier unit (assuming the arithmetic element size is 32 and the multiplier element size is 16). In this manner, each unit consumes the same number of bits. When 16-bit operands are used, the arithmetic unit may be used in its entirety rather than as halves.

Use of the multiplier unit with 32-bit elements could also be accommodated. In this case, however, the multiplier units could not be split into halves, but would need to be used together. Pairs of multipliers would be used to function as a 32×32-bit multiplier, where Individually they function as two independent 16×16-bit multipliers. The vector operand would be the same length in bits for 32-bit operation. (NOTE: the configuration of the adders needs to be studied for this application. It needs to be determined if the adders should also be paired up to handle accumulation of 64-bit products (or more with guard bits).

An additional consideration with the multiplier unit in particular is the need for use of the most significant 16-bit word for some operations. This is shown in the examples where a stride of 2 is provided for (normal vector operands use adjacent elements for a stride of 1). If this is necessary, then the effective vector length for the multiplier becomes the same as with the use of 32-bit elements.

The use of 32-bit operands as the design target as this would accommodate full speed use of the arithmetic unit with 32-bit operands and the multiplier unit with stride of 2. As a reasonable trade-off, the line length may be equal to the length of the 32-bit vector rather than double the length of the 32-bit vector. This is the line length used in the example implementation diagrams. The processor will transparently stall when operands are required to be prefetched (or fetched). In case of half vector operations, two instructions would be needed; hence, the stalling is not really a compromise to performance when considering half vector operations. It may also be possible that with an appropriate mix of processing instructions, the prefetch will be able to (nearly) sustain simultaneous vector fetching. Vector alignment to the start of a line may be desirable/required to sustain this operation. Possibly an additional line of prefetch buffer may also be desired and/or necessary. (NOTE: this method of operation needs to be evaluated.)

The decision to optimize for 16 or 32-bit elements needs to be based on the frequency of 32-bit element operations. For the occasional pipeline stall, the wider memory paths and double line length (and its associated read/alignment hardware) may not be justified. For a vector multiplier or addition unit length of 8 elements (16 or 32-bit), the line length would need to be 32 16-bit words in length. For a vector length of 16 elements, the line length would need to be 64 16-bit words in length; The line length begins to scale very expensively.

For these reasons, it is recommended to use a line length based on prefetching of two 16-bit element vectors with a stride of 1. Use 32-bit element vectors will be supported, albeit with possible hidden pipeline stalls.

5.5 Vector Prefetch and Load Hardware

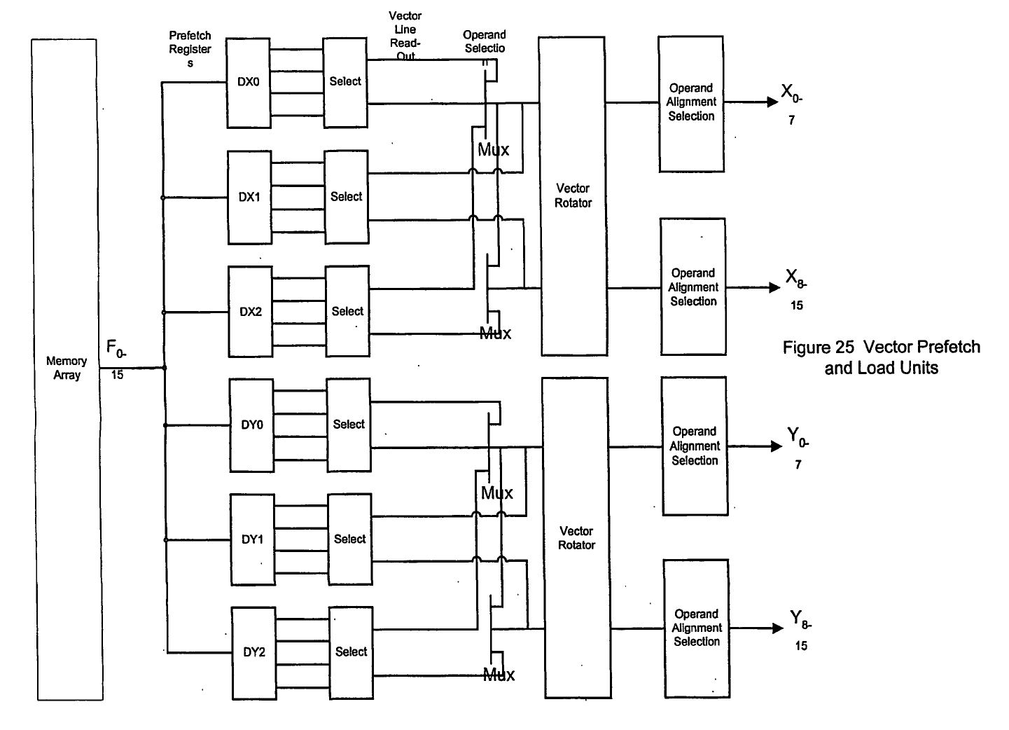

In terms of implementation, the VPFU and VLU are very closely coupled. FIG. 25 illustrates the processing from prefetching to delivery of the vector to the vector operand register. The VPFU reads from memory the largest vector at least at twice the data rate at which it may be consumed in order to balance the throughput in the system. The vector rotator network within the VLU aligns the vector data to the vector operand registers. The vector alignment extracts the data operand at any address alignment. The rotator and operand alignment allows for vectors to being at any memory addressed aligned only to the size of the operand type.

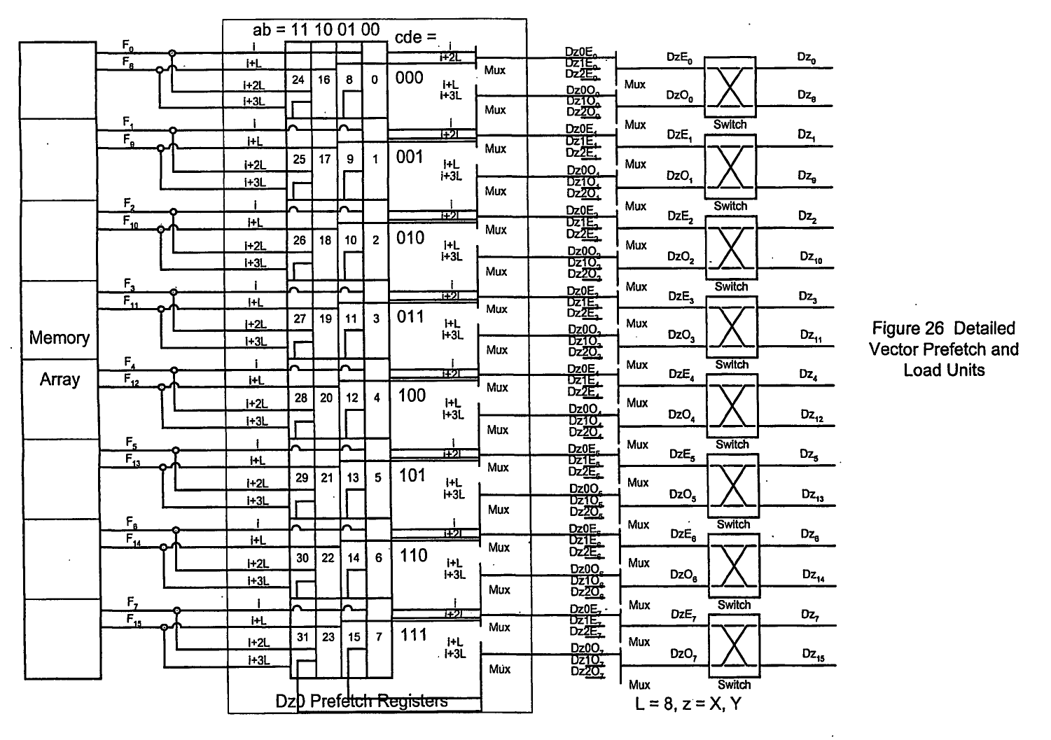

The Memory and Prefetch Data Registers are shown in FIG. 26. Use of 2 lines (4 half lines or sub-blocks) is shown in the middle of the figure. Immediately to the right is a set of multiplexors used to select a double length vector of data. The double length vector is in this example equal to the line length. The data provided at the outputs of the multiplexors consists of consecutive words beginning with the start address of the vector. (Please note, the effect of stalls required to fill the prefetch is not shown in this diagram.) The double length vector read needs to be split into two vectors and aligned so that the word corresponding to the vector start address is delivered to the first vector processor.

The next series of multiplexors selects from different groups of prefetch registers. It is suggested that both the X and Y operands have 3 sets of addressing and prefetch registers. The set used depends solely upon the instruction. This selection occurs at this point to reuse the circuits that follow.

The rightmost processing block is a series of switches (implemented as a pair of two input multiplexors). These switches are used to separate the low and high halves of the double length vector.

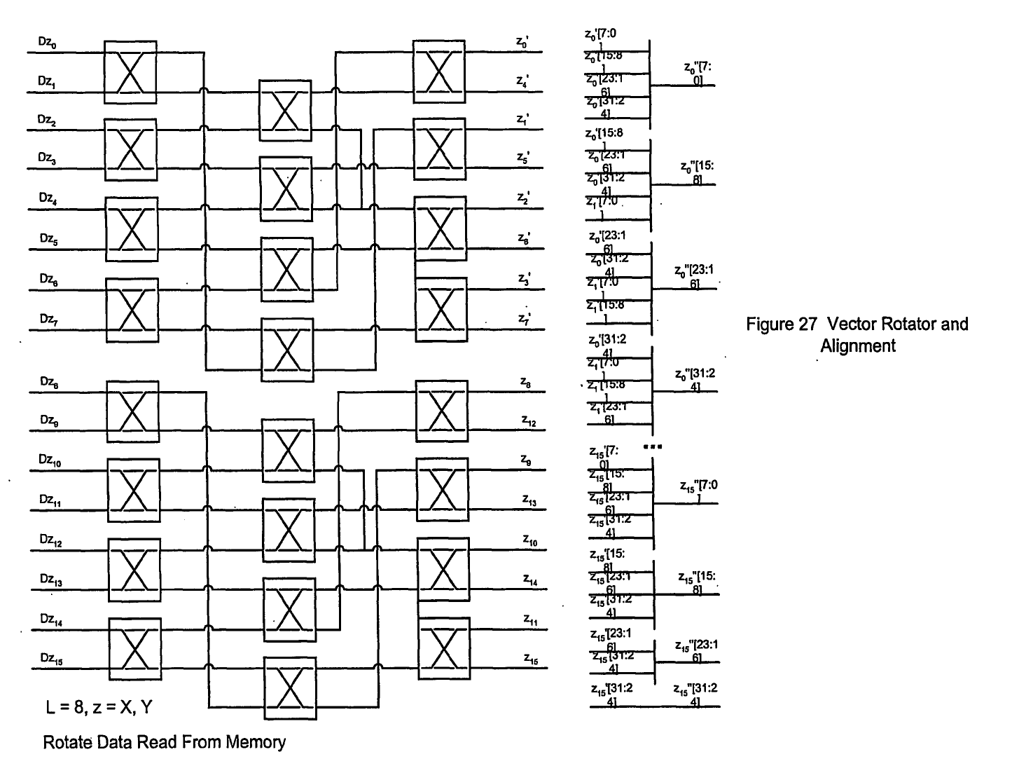

FIG. 27 shows the vector rotation hardware used to align the vector read from memory with the vector processor. The logic in the upper left operates on the low half f the double length vector. The logic in the lower left operates on the high half of the double length vector. The logic to the right delivers the vector to the vector processor as a low vector, a double length vector or a vector with every other element (such as for double precision operands). The stride is normally 1 for most vector operation, but may be specified as two for some conditions.

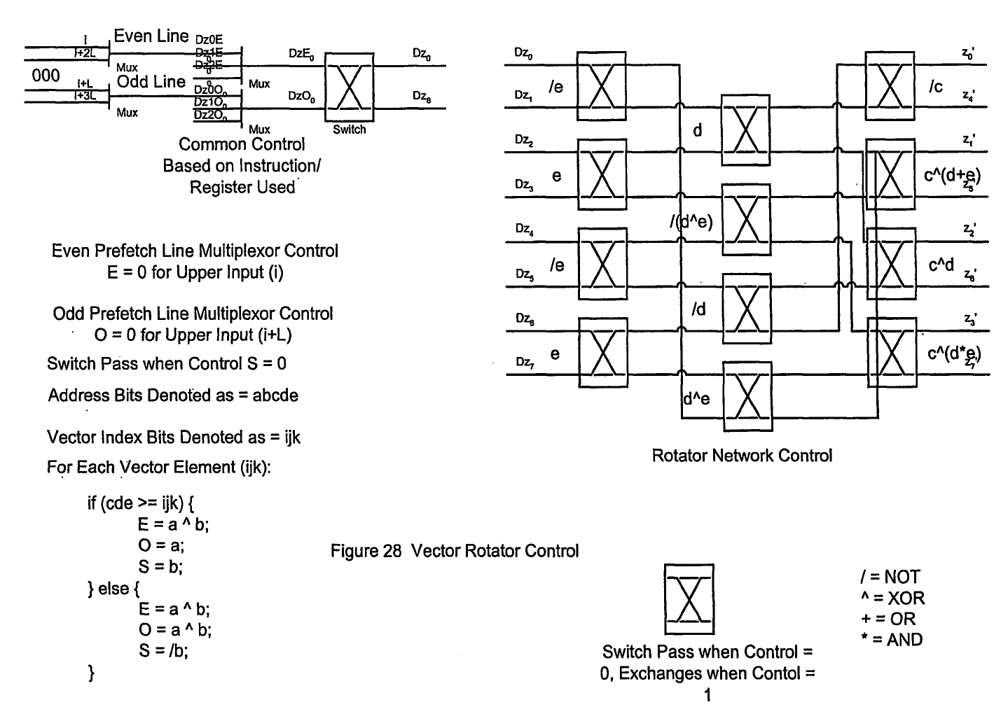

FIG. 28 illustrates the control logic for the hardware shown in FIGS. 26 and 27.

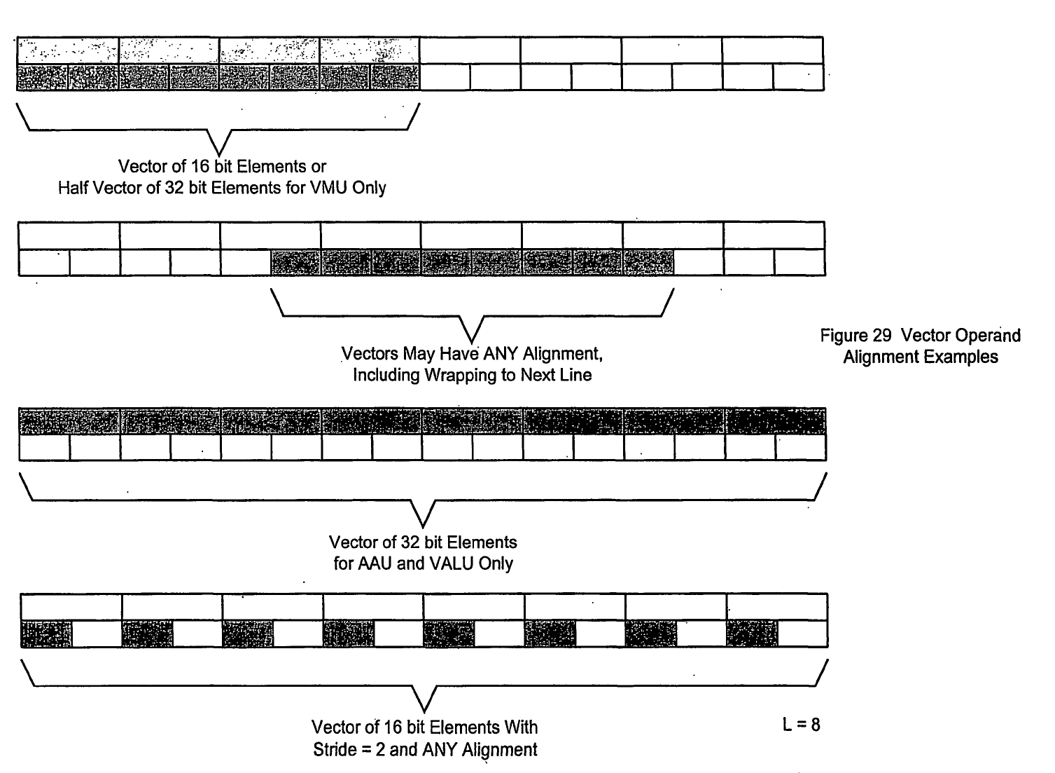

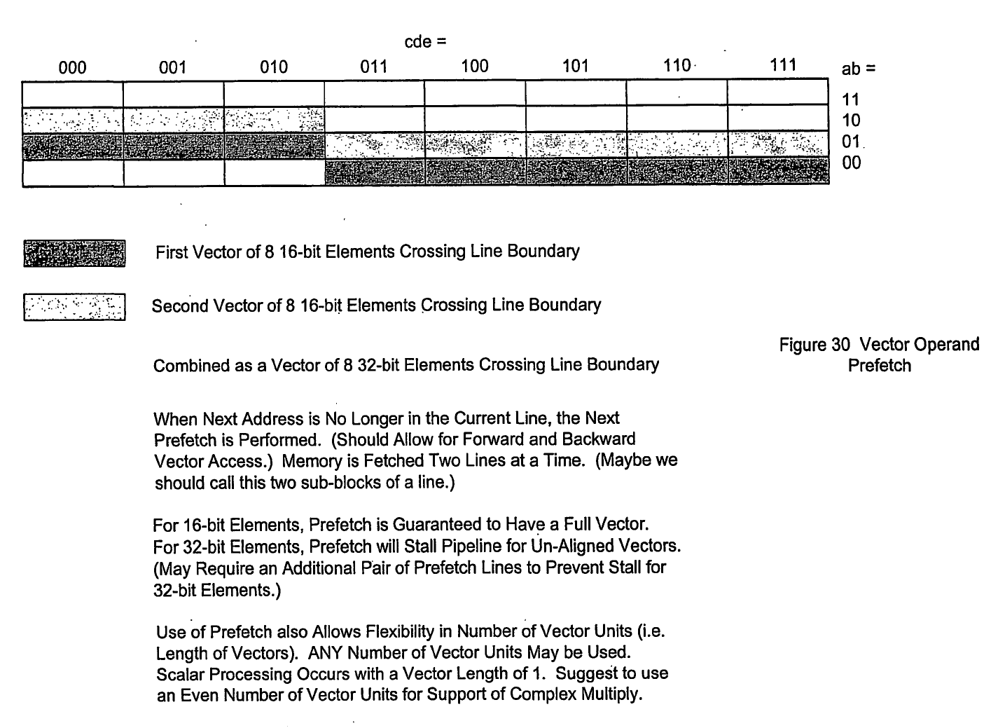

FIGS. 29 and 30 shows possible vector alignments and strides. (Note, strides have been replaced by a generic operand conversion operation.)

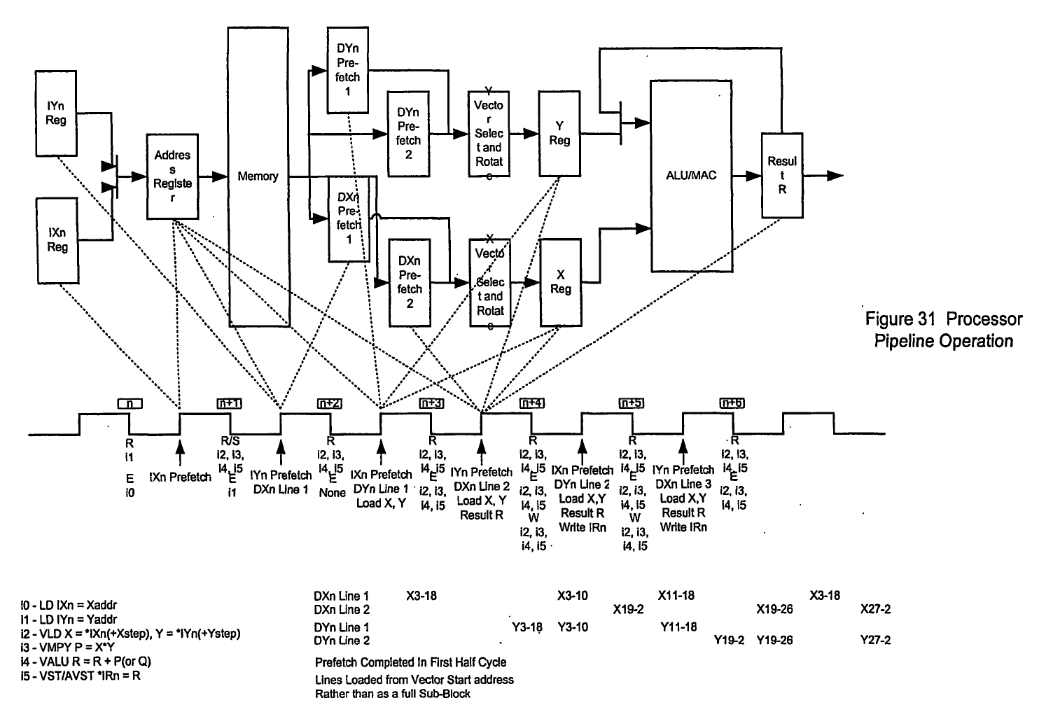

FIG. 31 shows the registers, timing, prefetching and pipeline operations for the vector processor. The timing shown assumes prefetches from memory begin with the start address of the vector rather from the beginning of the line containing the start address of the vector. This imposes additional memory circuit duplication as discussed in Section 5.4.2.

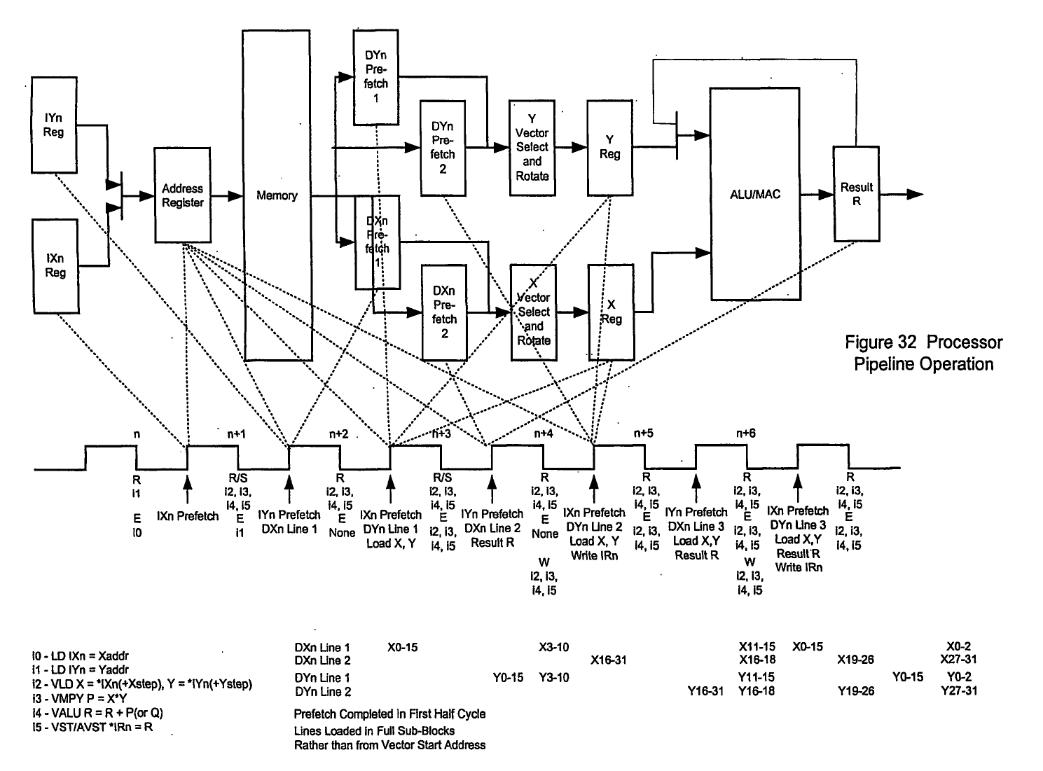

FIG. 32 shows the same set of operations on the vector processor but assumes the memory addressed from the line containing the start address of the vector. This only causes one additional pipeline stall.

A device as described herein may therefore implement a method of providing a vector of data as a vector processor operand. The method may comprise obtaining a line of data containing at least a vector of data to be provided as the vector processor operand, providing the line of data to a rotator network along with a starting position of said vector of data within the line, the rotator network having respective outputs coupled to vector processor operand data inputs, and controlling the rotator network in accordance with the starting position of the vector of data to output the first and subsequent data elements of the vector of data to first and subsequent operand data inputs of the vector processor.

A related method may comprise obtaining at least a portion of a first line of vector data containing at least a portion of a vector processor operand, obtaining at least a portion of a second line of vector data containing at least a remaining portion of said vector processor operand, providing the at least a portion of said first line of vector data and the at least a portion of said second line of vector data to a rotator network along with a starting position of said vector data, the rotator network having respective outputs coupled to vector processor operand data inputs, and controlling the rotator network in accordance with the starting position of the vector data to output the first and subsequent vector data elements to first and subsequent operand data inputs of the vector processor.

A device as described herein may also implement a method to read a vector of data for a vector processor operand. The method may comprise reading into a local memory device a series of lines from a larger memory, obtaining from the local memory device at least a portion of a first line containing a portion of a vector processor operand, obtaining from the local memory device at least a portion of a second line containing a remaining portion of the vector processor operand, providing the at least a portion of the first line of vector data and the at least a portion of the second line of vector data to a rotator network along with a starting position of the vector data, the rotator network having respective outputs coupled to vector processor operand data inputs, and controlling the rotator network in accordance with the starting position of the vector data to output first and subsequent vector data elements to first and subsequent vector processor operand data inputs.

5.6 Bulk Memory Transfer

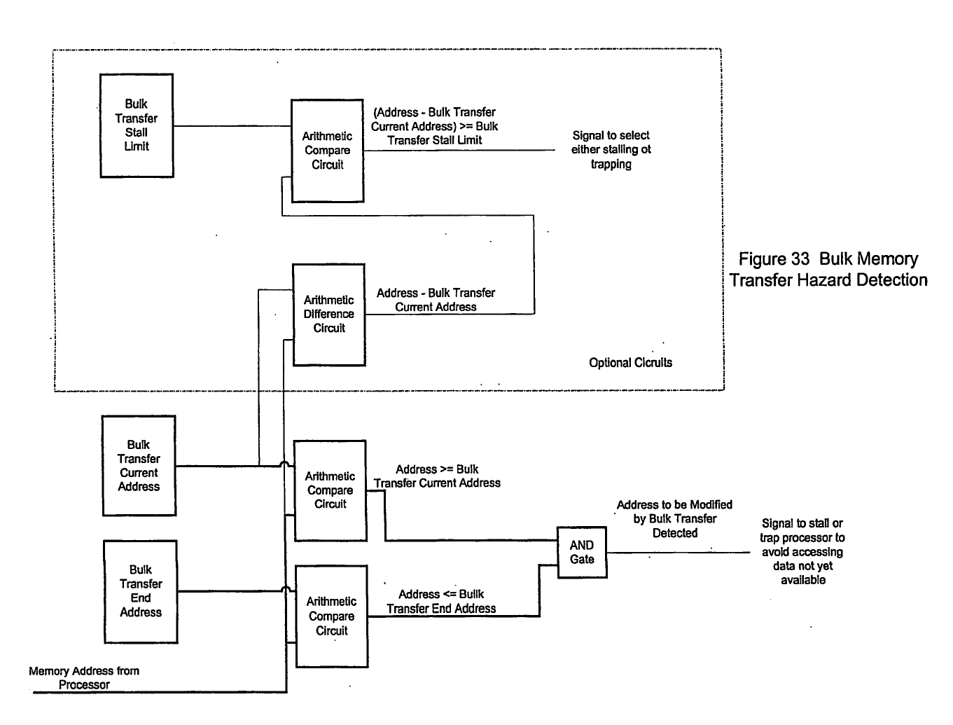

A processor-controlled means is used for performing bulk transfer of data to/from external SDRAM or RAMBUS memory. Hardware means are implemented for generating a stall (or processor trap) automatically for accesses to blocks of memories currently being loaded by the bulk-transfer mechanism as shown in FIG. 33. The bulk-transfer hardware would identify the starting and ending address (or starting address and length which can be used to derive the ending address). As the bulk transfer proceeds, the current bulk-transfer address would be continuously updated. If any address being referenced by the processor is between the current bulk-transfer address and the ending address, a detection signal would be generated and the processor would either stall or trap. The servicing mode may be done either statically by a configuration bit or dynamically such that the processor would stall if the distance between the current bulk-transfer address and the referenced address is less than a configurable value. Otherwise, the processor traps so that the non-ideal situation could be identified for the programmer and perhaps improved in the implementation of the algorithms.

A device as described herein may therefore provide an indication of a processor attempt to access an address yet to be loaded or stored. The device may comprise a current bulk transfer address register storing a current bulk transfer address, an ending bulk transfer address register storing an ending bulk transfer address, a comparison circuit coupled to the current bulk transfer address register and the ending bulk transfer address register, and to the processor, to provide a signal to the processor indicating whether an address received from the processor is between the current bulk transfer address and the ending bulk transfer address. The device may further produce a stall signal for stalling the processor until transfer to the address received from the processor is complete, or an interrupt signal for interrupting the processor to inform the processor that data at the address is unavailable.

A related device may comprise a current bulk transfer address register storing a current bulk transfer address, and a comparison circuit coupled to the current bulk transfer address register and to the processor to provide a signal to the processor indicating whether a difference between the current bulk transfer address and an address received from the processor is within a specified stall range. The signal produced by the device may be a stall signal for stalling the processor until transfer to the address received from the processor is complete, or an interrupt signal for interrupting the processor to inform the processor that data at the address is unavailable.

### Section 6. Program/Execution Control

6.1 Overview

This section describes the program sequencer and conditional execution controls of the TOVEN Process r Family. The programmer sequencer is responsible for the execution control flow of the program. It responds to conditional operations, forms code loops, and is responsible for servicing interrupts. The conditional execution control is implemented in the form of guarded operations. An element-based guard is used for vector operations allowing individualized element execution control. Most of the other instructions use a scalar guard to enable or disable their execution.

6.2 Program Sequencer

6.2.1 Loop Control Instructions

The TOVEN repeats instruction sequences using a zero-overhead loop mechanism. The loop counter may be specified as:

1) As a specific loop iteration count

2) As a specified number of vector elements to be processed

3) According to an address pointer used in circular buffer operations

The register used to load the loop-counter determines the loop-counter mode. The loop-counter registers are named LCOUNT, VCOUNT and ACOUNT respectively. Loops may be nested up to the hardware limits.

With a specific loop iteration count (LCOUNT), a program can be designed to work in multiples of the hardware elements. If hardware supports a vector length of 8, the loop can be specified as ⅛^{th} of the number of words in the vector. This form of loop control is also well suited for non-vector operations and hence is called an Ordinary Loop Mechanism.

Using the vector word count (VCOUNT), the loop is specified as the number words in the vector and decremented according to the number of words processed by the hardware per loop iteration. The number of words processed in the last loop iteration may need to be automatically adjusted to process only the remaining words (each hardware element processes a word). This occurs by temporarily changing the number of vector processor elements enabled in register L representing a lesser number of enabled elements for the last loop iteration. After the last iteration, the original value of L may be restored. This mechanism allows software implementations to be independent of the number of hardware elements and is referred to as the Vector Loop Mechanism.

Using the address element count (ACOUNT), the loop is terminated when a match value is equal to the specified address register. Within the loop, the specified vector address register will be incremented or decremented and if circular, the address register will once again reach the same value. The loop hardware will monitor the specified address register until it matches the match value. The setting of the ACOUNT register transfers the match value from the specified address register and indicates which address register to monitor for a matching address. When the loop nears the end of the circular data, the last iteration may require an adjusted count When the absolute difference between the match count (ACOUNT) and specified address register is less than the number of vector processor elements enabled in register L, then the value of L would need to be temporarily adjusted to the absolute difference. Again once the loop completes, the original value of L may be restored.

In general, hardware may be implemented to allow many different registers to be monitored by ACOUNT and the loop may continue until the register equals the match value. The effect on final loop iteration may however be less predictable if the registered being monitored does not reflect the number of elements left to be processed. Another register, MCOUTNT, could be used for matching a count value with no effect on vector length remaining to be processed.

The loop counters are loaded using:

LDR LCOUNT, [register, immediate]

LDR VCOUNT, [register, immediate]

LDR ACOUNT, [address register]

The zero overhead loop is started using:

DO target UNITIL CE

A device as described herein may therefore implement a method for performing a vector operation on all data elements of a vector, comprising: setting a loop counter to a number of vector data elements to be processed, performing one or more vector operations on vector data elements of the vector, determining a number of vector data elements processed by the vector operations, subtracting the number of vector data elements processed from the loop counter, determining, after subtraction, whether additional vector data elements remain to be processed, and if additional vector data elements remain to be processed, performing further vector operations on remaining data elements of the vector. The method may further include reducing a number of vector data elements processed by the vector processor to accommodate a partial vector of data elements on a last loop iteration.

A related method for reducing a number of operations performed for a last iteration of a processing loop may comprise setting a loop counter to a number of vector data elements to be processed, performing one or more vector operations on data elements of the vector, determining a number of vector data elements processed by the vector operations, subtracting the number of vector data elements processed from the loop counter, determining, after subtraction, whether additional vector data elements remain to be processed, and if additional vector data elements remain to be processed, and the number of additional vector data elements to be processed is less than a full vector of data elements, reducing one of available elements used to perform the vector operations and vector data elements available for the last loop iteration.

A device as described herein may also implement a method for performing a loop operation. The method may comprise storing, in a match register, a value to be compared to a monitored register, designating a register as the monitored register, comparing the value stored in the match register with a value stored in the monitored register, and responding to a result of the comparison in accordance with a program-specified condition by one of branching or repeating a desired sequence of program instructions, thereby forming a program loop. The program specified condition may be one of equal to, not equal to, less than, less than or equal to, greater than, or greater than or equal to. The register to be monitored may be an address register. The program-specified condition may be an absolute difference between the value stored in the match register and the value stored in the address register, and responding to the result of the comparison may further comprise reducing a number of vector data elements to be processed on a last iteration of a loop.

6.2.2 Vector Conditional Skip Instruction

The TOVEN provides a skip instruction to avoid the execution of a block of code. Using conditional element execution, elements will not be updated or written based on a conditional. The skip instruction could be used in case all of the elements will not be updated or written. This is much like a conditional branch instruction in a conventional processor. The difference is that the branch is not taken if one or more vector elements will be updated or written based on the conditional.

[D, E, T, F].SKIP target

The “D” refers to skip if all vector units are disabled. The “E, T and F” refer to the same conditions used by the VALU and VST instructions.

| Conditional Execution | VEM | VCM |
|---|---|---|
| Disable (D) | 0 | — |
| Enable (E) | 1 | — |
| True (T) | 1 | 1 |
| False (F) | 1 | 0 |

The advantage of such branch instruction is it allows skipping of code when no elements would be updated or written. The assumption is that all the instructions of a block being skipped will be conditionally executed on the same condition as the skip instruction. Executing the instructions of the block would have little effect if the skip instruction were not used (except for possible side effects of pointer incrementing and if this is important, the skip instruction should not be used).

With this assumption, the skip instruction execution may be delayed until the element conditions are known. Subsequent instructions may follow in the pipeline and must execute if the skip is not taken. It would also be acceptable if the instructions executed even if the skip instruction is taken. The premise is that the instructions would be predicated on the same conditional such that the executing the instructions would have no significant effect as the elements are disabled.

A device as described herein may therefore perform a method comprising receiving an instruction, determining whether a vector satisfies a condition specified in the instruction, and, if the vector satisfies the condition specified in the instruction, branching to a new instruction. The condition may comprise a vector element condition specified in at least one of a vector enable mask and a vector condition mask.

6.3 Guarded Operations

6.3.1 Vector Element Guarded Operations

Vector mode instructions may be conditionally executed on an element-by-element basis using the Vector Enable Mask (VEM) and the Vector Conditional Mask (VCM). The Enable condition, E, executes if the corresponding bit in the Vector Enable Mask is one. The True condition, T, executes if the corresponding bits in both the Vector Enable Mask and Vector Conditional Mask are one. The False condition, F, executes if the corresponding bit in the Vector Enable Mask is a one and the Vector Conditional Mask is a zero. If no condition is specified, the instruction executes on all elements.

| Conditional Execution | VEM | VCM |
|---|---|---|
| None | — | — |
| Enable (E) | 1 | — |
| True (T) | 1 | 1 |
| False (F) | 1 | 0 |

The VEM and VCM masks may be set by instructions, which evaluate a specified element condition code, and if present, the bit corresponding to the element is set in the selected mask. The instructions, “SVEM” and “SVCM”, set the bits in VEM and VCM respectively.

For the purposes of nesting element conditional, the VEM mask may be pushed onto a software stack. Then a logical combination of VEM and VCM may be written as a new VEM. The common logical combinations would be I) VEM & VCM, 2) VEM & VCM, or 3) ˜VEM. (“˜” is a bitwise AND, and “˜” is a bitwise NOT.) The first and second combinations are equivalent to “True” and “False” from the above table respectively. The last combination is equivalent to NOT “Enable”. Additional combinations such as 1) VCM and 2) ˜VCM may also prove useful for certain algorithms. The instructions are:

| | | |
|---|---|---|
| MVCM | // VEM = VCM | Move VCM to VEM |
| AVCM | // VEM = VEM & VCM | Set VEM to VEM and VCM |
| ANVCM | // VEM = VEM & ˜VCM | Set VEM to VEM and not VCM |
| NVEM | // VEM = ˜VEM | Set VEM to not VEM |
| NVCM | // VEM = ˜VCM | Set VEM to not VCM |
| MVEM | // VCM = VEM | Set VCM to VEM |

Once the element conditional code section is competed, the prior VEM may be popped from the software stack and processing may continue. For consistency, VCM may also be saved on a software stack via a push and pop. Pushing/popping is performed using the standard scalar LD/ST instructions using the stack pointer, SP.

Accordingly, a method in a device as described herein may conditionally perform operations on elements of a vector. The method may comprise generating a vector enable mask comprising a plurality of bits, each bit corresponding to a respective element of a vector, generating a vector conditional mask comprising a plurality of bits, each bit corresponding to a respective element of a vector, and, for each of the elements, applying logic to the vector enable mask bit and vector conditional mask bit that correspond to that element to determine if an operation is to be performed for that element. The logic may require the vector enable bit corresponding to an element to be set to enable an operation on the corresponding element to be performed.

A related method as described herein may nest conditional controls for elements of a vector. The method may comprise generating a vector enable mask comprising a plurality of bits, each bit corresponding to a respective element of a vector, generating a vector conditional mask comprising a plurality of bits, each bit corresponding to a respective element of a vector, saving the vector enable mask to a temporary storage location, generating a nested vector enable mask comprising a logical combination of the vector enable mask with the vector conditional mask, and using the nested vector enable mask as a vector enable mask for a subsequent vector operation. The logical combination may use a bitwise “and” operation, a bitwise “or” operation, a bitwise “not” operation, or a bitwise “pass” operation.

An alternative method may comprise generating a vector enable mask comprising a plurality of bits, each bit corresponding to a respective element of a vector, generating a vector conditional mask comprising a plurality of bits, each bit corresponding to a respective element of a vector, saving the vector enable mask to a temporary storage location, generating a nested vector enable mask by performing a bitwise “and” of the vector enable mask with the vector conditional mask, and using the nested vector enable mask as a vector enable mask for a subsequent vector operation.

A further alternative method may comprise generating a vector enable mask comprising a plurality of bits, each bit corresponding to a respective element of a vector, generating a vector conditional mask comprising a plurality of bits, each bit corresponding to a respective element of a vector, saving the vector enable mask to a temporary storage location, generating a nested vector enable mask by performing a bitwise “and” of the vector enable mask with a bitwise “not” of the vector conditional mask, and using the nested vector enable mask as a vector enable mask for a subsequent vector operation.

6.3.2 Scalar Guarded Operations

Non-Vector mode instructions may be conditionally executed using the Scalar Guard. When the Scalar Guard if used, True enables the execution of most non-vector mode instructions. The Scalar Guard condition may be set by an instruction that evaluates a specified scalar condition code and if present, sets the Scalar Guard condition. The instruction, “SSG”, is used to evaluate a specified scalar condition and set the Scalar Guard condition accordingly. Scalar conditions used are the standard NE, EQ, LE, GT, GE, LT, NOT AV, VA, NOT AC, AC and a few others. (The scalar conditions may be obtained from a specified vector element using “GETSTS”.) The current Scalar Guard may be complemented using the instruction, “NSG”.

The Scalar Guard may also be set from a bit-wise OR of all the elements using a logical combination of the Vector Guard Masks, VEM and VCM, via the instruction “OSG”. For the OSG instruction, the following vector conditions are evaluated:

| Conditional Execution | VEM | VCM |
|---|---|---|
| Disable (D) | 0 | — |
| Enable (E) | 1 | — |
| True (T) | 1 | 1 |
| False (F) | 1 | 0 |

6.4 Interrupt Servicing

The interrupts in the TOVEN are handled by fetching instructions from an interrupt handler vector associated with the interrupt source. The instructions at this location are responsible for 1) disabling further interrupts using the instruction “DI” and 2) calling the actual interrupt service routine. The original program counter is not updated for processing this one-cycle interrupt dispatch. Superscalar execution is exploited by knowing in advance that the selected instructions will be executed as a single group in a single cycle. This permits conventional processor instructions to perform all of the functions required as part of the interrupt context switching.

The call to the actual interrupt service routine will function as a normal call and will save the original PC (unmodified by the fetching or execution of the one-cycle interrupt dispatch). The returning process may again exploit the superscalar features where it can be ensured that certain multiple instructions may be executed as a group in a single processor cycle. In this case, the instructions sequence should be at least 1) instruction barrier “RBAR” to force an instruction grouping break, 2) enable interrupts using “EI” and 3) return from subroutine to return to the original program. Multiple levels of interrupt priority may be handled by pushing and popping an interrupt source mask within the body of the interrupt routine and then re-enabling overall interrupts.

The processor hardware required to service interrupts may be significantly reduced with this approach. The response to an interrupt requires fetching a group of instructions from a fixed location according to the interrupt source and disabling PC counter changes for the one cycle only. Normal processor instructions as explained above perform the actual entry into the interrupt service routine.

A device as described herein may therefore implement a method of processing interrupts. The method may comprise monitoring an interrupt line for a signal indicating an interrupt to the superscalar processor, upon detection of an interrupt signal, fetching a group of instructions to be executed in response to the interrupt, and inhibiting in hardware an address update of a program counter, and executing the group of instructions. The group of instructions may include an instruction to disable further interrupts and an instruction to call a routine.

6.5 Instruction Fetching/Grouping/Decoding

The TOVEN Processor fetches and dispatches multiple instructions per clock cycle using superscalar concepts. The instruction processing hardware implements data hazard detection and instruction grouping for the processor. The processor uses a superscalar in-order issue in-order execution instruction model. Before an instruction is able to run concurrently with previous sampled instructions it must be free of data hazards and grouping violations. Even though the TOVEN processor implements an in-order issue in-order execution, which greatly reduces number of dependencies/hazards, there are still a number of dependencies and hazards that must be avoided. The instruction grouper is where this dependency and hazard detection processing is performed.

Unique to the TOVEN is its use of prefetch line buffers and unaligned vector read hardware. The support of reading from unaligned vectors as applied to the instruction fetching allows any arbitrary starting address for the set of instructions being fetched, referred to as the “window of instructions”. Traditional superscalar processors would read a set of instructions from a line in a cache. If the instructions being fetched are near the end of the cache's line, only a partial set of instructions will be supplied to the superscalar instruction decoder/grouper. The TOVEN has provisions for reading a window of instructions from multiple line buffers and delivering a full set of instructions to the grouping logic every time.

The instruction decoding process consists of instruction grouping, routing and decoding. The input (an eight instruction window) is supplied by the instruction fetch unit The output, comprising of various registers and constants, is fed into the first formal pipeline stage. Based upon the eight instructions of the window, the grouping logic determines how many of these instructions can run concurrently, or be placed within the same group (eight being the maximum size of a group). The routing logic then delivers each instruction within the group, consisting of one to eight instructions, to its respective decoder. Based upon the current mode of the processor, Vector or Register, as determined by the group of instructions, the decoded instructions, control-signals and constants are fed into the first stage of the pipeline. The entire grouping, routing and decoding process is accomplished in two clock cycles with one cycle for the grouping and another for the routing and decoding.

6.5.1 Instruction Prefetch/Fetch Units

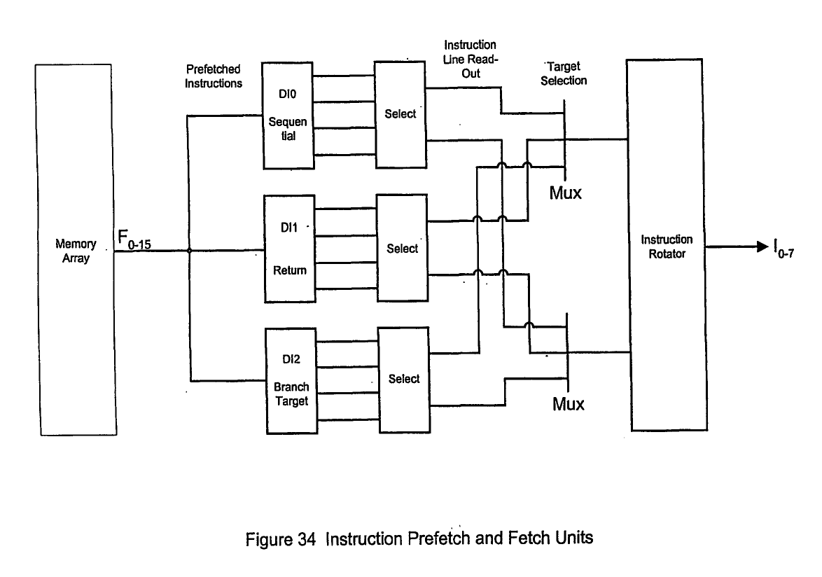

The TOVEN uses a prefetch mechanism similar to that used for reading vector data operands as shown in FIG. 34. Instruction memory is read at least one line at a time where a line is typically twice the instruction window in length. The instructions are saved in a set of prefetch registers that may hold at least two lines of instructions. Additional sets of lines may be used to hold instructions belonging to a processor return address and/or predicted instructions for a change in control address due to a branch or call. The fetching hardware obtains the instructions partially from one line and the rest from the other. As a line is emptied, the prefetch mechanism will refill with sequential instructions unless there is a change of control via a call, branch or return.

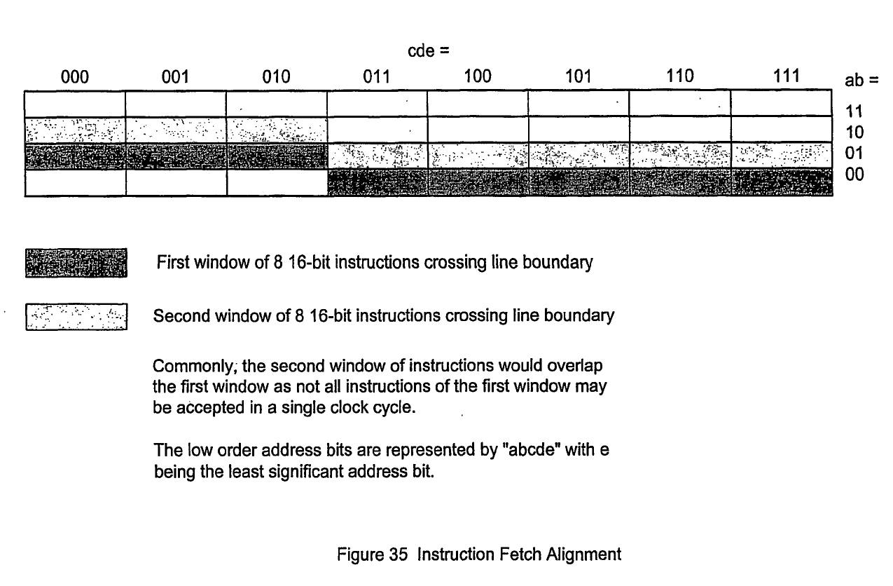

The instruction fetching mechanism obtains instructions from either of two lines or even some from each line. These instructions are in order but not necessarily beginning with the first instruction in a first position. FIG. 35 illustrates an example alignment.

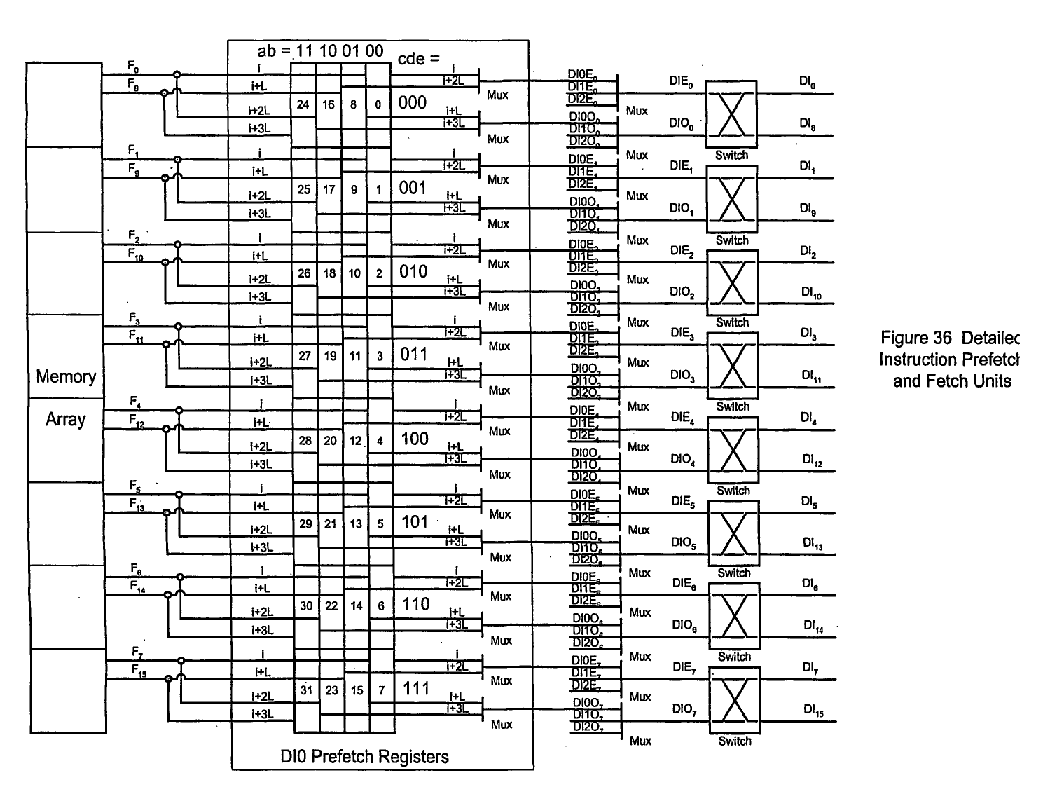

The first vector of instructions begins at address “00011” (0x03). The hardware reads prefetch line locations 3 to 7 from the first line and then locations 0 to 2 from the second line. The logic in FIG. 36 is used to select the data from either a first line or a second line. Logic is suggested to support multiple sets of Din registers allowing for multiple instruction targets such as sequential, return to a caller, and for a branch/call destination. The rightmost column of the device perform and exchange inputs for the necessary elements in order to place the 8 target instructions into positions DI₀ to DI₇ thereby forming the instruction window. The other outputs, DI₈ to DI₁₅ are not needed by further logic. An alternative implementation may be used to eliminate this unused logic path.

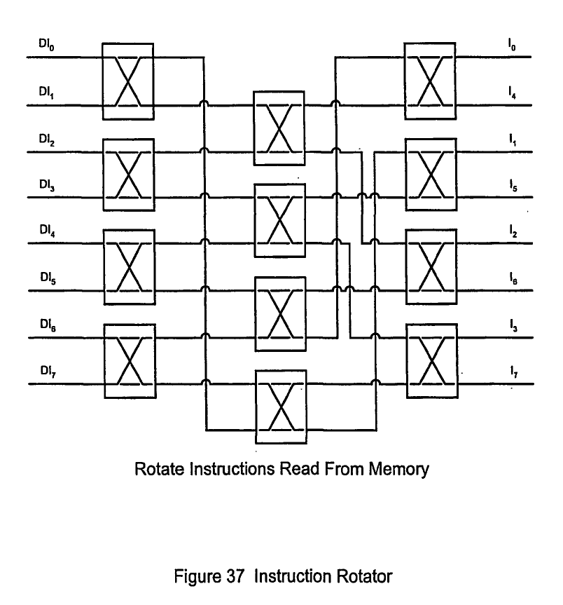

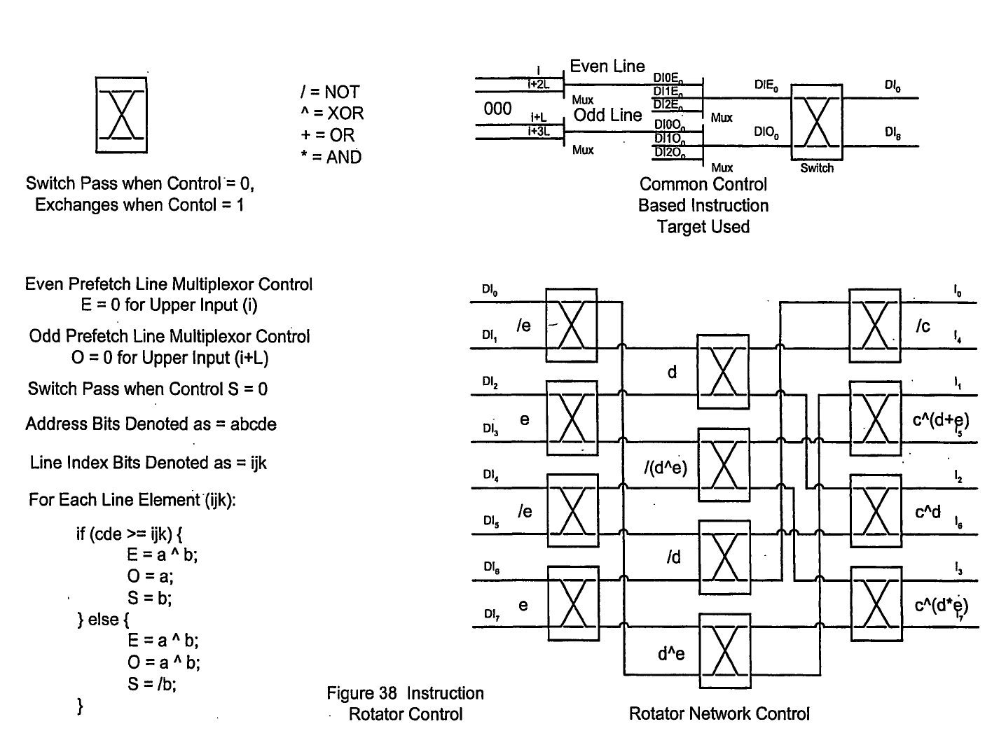

Once the group of eight instructions is produced, they need to be aligned so that the first instruction of the window is positioned as the first position of the instruction grouping and decoding stage. The instruction router is shown in FIG. 37 and its control logic is shown in FIG. 38.

Accordingly, a processor as described herein may implement a method to deliver an instruction window, comprising a set of instructions, to a superscalar instruction decoder. The method may comprise fetching two adjacent lines of instructions that together contain a set of instructions to be delivered to the superscalar instruction decoder, each of the lines being at least the size of the set of instructions to be delivered, and reordering the positions of instructions of the two adjacent lines so as to position first and subsequent elements of the set of instructions to be delivered into first and subsequent positions corresponding to first and subsequent positions of the superscalar instruction decoder. Reordering the positions of the instructions may involve rotating the positions of said instructions within the two adjacent lines. The first line may comprise a portion of the set of instructions and the second line may comprise a remaining portion of the set of instructions.

Alternatively, the method may obtain a line of instructions containing at least a set of instructions to be provided to the superscalar instruction decoder, provide the line of instructions to a rotator network along with a starting position f said set of instructions within the line, the rotator network having respective outputs coupled to inputs of a superscalar instruction decoder, and control the rotator network in accordance with the starting position of the set of instructions to output the first and subsequent instructions of the set of instructions to first and subsequent inputs of the superscalar decoder.

In a further alternative, the method may obtain at least a portion of a first line of instructions containing at least a portion of a set of instructions to be delivered to the superscalar instruction decoder, obtain at least a portion of a second line of instructions containing at least a remaining portion of said set of instructions, provide the first and second lines of instructions to a rotator network along with a starting position of the set of instructions, the rotator network having respective outputs coupled to inputs of a superscalar instruction decoder, and control the rotator network in accordance with the starting position of the set of instructions to output the first and subsequent instructions of the set of instructions to first and subsequent inputs of the superscalar decoder. Each line may contain the same number of instruction words as contained in an instruction window, or may contain more instruction words than contained in an instruction window.

Similarly, a processor as described herein may comprise a memory storing lines of superscalar instructions, a rotator for receiving at least portions of two lines of superscalar instructions that together contain a set of instructions, and a superscalar decoder having a set of inputs for receiving corresponding first and subsequent instructions of a superscalar instruction window, the rotator network providing the first and subsequent superscalar instructions of the instruction window from within the at least portions of two lines of instructions to the corresponding inputs of the superscalar decoder. The rotator may comprise a set of outputs corresponding in number to the number of superscalar instructions in a superscalar instruction window, and further corresponding to positions of instructions within the at least portions of two lines of instructions within the rotator. The rotator network may reorder the instructions of the at least portions of two lines of superscalar instructions within the rotator network to associate the first and subsequent superscalar instructions of the superscalar instruction window with first and subsequent outputs of the rotator network coupled to corresponding inputs of the superscalar decoder. The rotator network may reorder the positions of the instructions by rotating the instructions of the at least portions of two lines within the rotator. The reordering may be performed in accordance with a known position of a first instruction of the instruction window within the at least portions of two lines.

6.5.2 Instruction Grouping

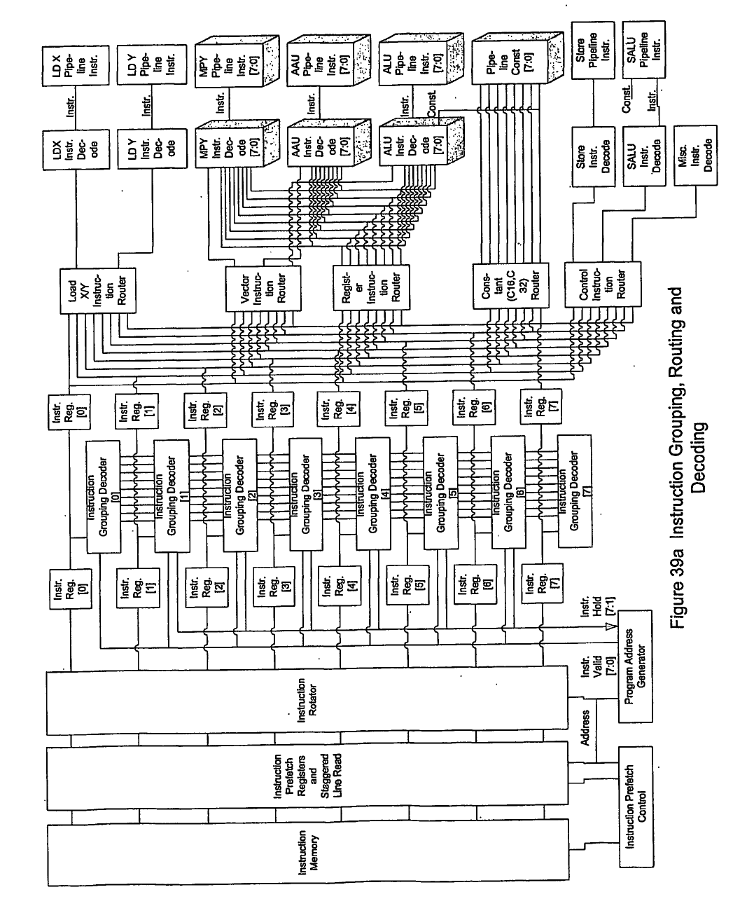

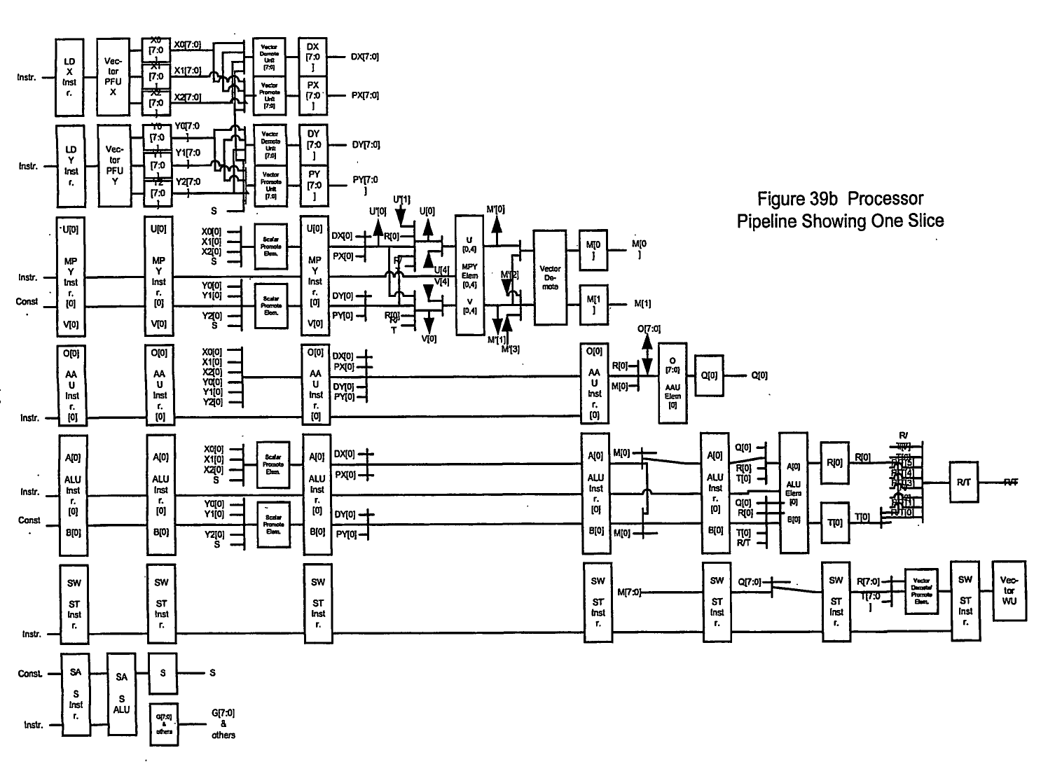

Each instruction of the window is evaluated by an instruction grouping decoder. Each grouping decoder is composed of a series of sub-decoders. The sub-decoders determine the various attributes of the current instruction such as type, source registers, destination registers, etc. The attributes of each instruction propagate vertically down through the grouping decoders. Based upon the attributes of previously evaluated instructions, each grouping decoder performs hazard detection. If a grouping decoder detects a hazard, the “hold signal” for that particular grouping decoder is asserted. This implies that instructions prior to the instruction's grouping decoder that generated the hold will run concurrently together. The first instruction will never generate a hold as it has priority through all possible hazards. The seven hold signals related to instructions two through eight are sent to the program address generator instructing the next instruction window to start with the first instruction held. FIGS. 39a and 39b shows the top-level instruction grouping, routing and decoding.

6.53 Instruction Routing

The input to the instruction router is a group of up to eight instructions from the instruction grouping decoders. The grouping decoders also forward some of their decoded outputs including the seven hold signals, constant indications and destination registers. The router delivers the individual instructions and constants of a group to their respective decoding units. Up to eight instructions may be provided to the router. The router determines, based upon the hold signals, which instructions to mask. Other control signals coming into the router, along with the hold signals, determine where to deliver the contents of the group.

The router can be considered as five components: (1) the load instruction router, (2) the vector instruction router, (3) the register instruction router, (4) the constant router and (S) the control instruction router.

The router is implemented via a set of very simple logic consisting of AND and OR (or NAND) gates and wiring. The first level of gates is enabled by various input signals including (but not limited to) hold signals, constant information, and register destination. The inputs to the decoders are signals which are simply ORed (or NANDed) together as unused paths will be idled to a particular value.

6.5.3.1 Load Instruction Router

The load instruction router directs the instructions to the appropriate X, Y or Other load decoder. (The Other load decoder is not shown on FIG. 39.) The routing depends on the type of operand being loaded. The hazard detection of the grouping logic has already determined that at most one load instruction is sent to each decoder.

6.5.3.2 Vector Instruction Router

The vector instruction router is used when the grouping logic has established a group of one or more vector instructions. Vector and register instructions may not be mixed as the functional units of the pipeline are scheduled as “slices” in Register mode and as a vector computational unit in Vector mode.

The vector instruction router functions on at most three instructions (one for each of the three computational units, VMU, AAU and VALU) for any cycle. Each functional unit within a computational unit has an instruction decoder. The vector unit delivers the same instruction to all instruction decoders of a computational unit

6.5.3.3 Register Instruction Router

The register instruction router is used when the grouping logic has established a group of one or more register instructions. Vector and register instructions may not be mixed as the functional units of the pipeline are scheduled as “slices” in Register mode and as a vector computational unit in Vector mode.

The register instruction router functions on one to eight instructions (one for each hardware slice of the vector processor) for any cycle. Each functional unit of the slice (a VMU element, an AAU element, and a VALU element) may receive the instruction pertaining to the slice. In a preferred embodiment, all three functional units associated with a slice will receive the same instruction. The functional units selected by the instruction will further operate on the instruction and perform an operation as instructed. In another preferred embodiment, only the functional units required for an operation will receive an instruction while the other functional units in the slice will be idled.

6.5.3.4 Constant Router

The constant router is a series of multiplexors used to deliver a 16-bit or 32-bit constant to the formal pipeline. Only Register mode instructions may have a constant If a constant is not used, it is delivered as zeros allowing the instruction decoder to simply OR in its shorter Habit constant contained within a register mode instruction. The constant router uses information from the grouping decoder to direct the deliver of the constant to the appropriate hardware slice.

6.5.3.5 Control Instruction Router

The control instruction router is responsible for routing all of the other instructions including store instructions and SALU instructions.

6.5.4 Instruction Decoding

Once the instructions are routed according to its functional unit in either Vector or Register mode, the decoders operate on the instruction to encode the operation for the pipeline. Through this process, the group of superscalar instructions (either Vector or Register) is converted into a very wide instruction word where each functional unit of the vector hardware may be controlled individually. The decoders receiving no instructions place no-ops into their respective field of the very wide instruction word. For vector mode, the very wide instruction word may contain instructions for each functional unit as they are programmed together through a computational unit instruction. In register mode, it is possible to designate an independent operation on each slice of the vector hardware. The grouping decoder avoids all hazards related to conflicts in register mode.

Accordingly, a vector processor as described herein may perform both vector processing and superscalar register processing. In general this processing may comprise fetching instructions from an instruction stream, where the instruction stream comprises vector instructions and register instructions. The type of a fetched instruction is determined, and if the fetched instruction is a vector instruction, the instruction is routed to decoders of the vector processor in accordance with functional units used by the vector instruction. If the fetched instruction is a register instruction, a vector element slice of the vector processor that is associated with the register instruction is determined, one or more functional units that are associated with the register instruction are determined, and the register instruction is routed to the functional units of the vector element slice. These functional units may be instruction decoders associated with said functional units and said vector element slice.

A vector processor as described above may comprise a plurality of vector element slices, each comprising a plurality of functional units, and a plurality of instruction decoders, each associated with a functional unit of one of the vector element slices, for providing instructions to an associated functional unit. The vector processor may further comprise a vector instruction router for routing a vector instruction to all instruction decoders associated with functional units used by said vector instruction, and a register instruction router for routing a register instruction to instruction decoders associated with a vector element slice and functional units associated with the register instruction.

A vector processor as described herein may also create Very Long Instruction Words (VLIW) from component instructions. In general this processing may comprise fetching a set of instructions from an instruction stream, the instruction stream comprising VLIW component instructions, and identifying VLIW component instructions according to their respective functional units. The processing may further comprise determining a group of VLIW component instructions that may be assigned to a single VLIW, and assigning the component instructions of the group to a specific positions of a VLIW instruction according to their respective functional units. Identifying VLIW component instructions may be preceded by determining whether each of fetched instructions is a VLIW component instruction. Determining whether a fetched instruction is a VLIW component instruction may be based on an instruction type and an associated functional unit of the instruction, and instruction types may include vector instructions, register instructions, load instructions or control instructions. The component instructions may include vector instructions and register instructions.

A vector processor that forms Very Long Instruction Words (VLIW) from VLIW component instructions of an instruction stream as described herein may be designed by defining a set of VLIW component instructions, each component instruction being associated with a functional unit of the vector processor, defining grouping rules for VLIW component instructions that associate component instructions that may be executed in parallel, and defining associations between VLIW component instructions and specific positions of a VLIW instruction based on the functional unit of the component instruction.

A vector processor as described herein that forms Very Long Instruction Words (VLIW) from VLIW component instructions of an instruction stream may comprise a plurality of vector element slices, each comprising a plurality of functional units, and a plurality of instruction decoders, each associated with a functional unit of one of the vector element slices, for providing instructions to an associated functional unit. The processor may further include a plurality of routers, each associated with a type of said functional units, for routing instructions to a decoder associated with a functional unit of the routed instruction, a plurality of pipeline registers, each corresponding to a type of said functional units, for storing instructions provided by instruction decoders corresponding to the same type of functional unit, and a plurality of instruction grouping decoders, for receiving instructions from an instruction stream and providing groups of VLIW component instructions of said stream to said plurality of routers. The VLIW instruction is comprised of the instructions stored in the respective pipeline registers.

### Section 7. Vector Length and Memory Width

The number of vector processors and associated width of memory may be rather flexibly selected. This is not an obvious situation and will be explained in the following sections. The flexibility in selection of vector length and memory width is appreciated when one needs just a little more performance without being forced to consider doubling of the hardware.

7.1 Selection of Vector Length

The obvious choice for the number of vector processors and width of memory is any power of 2, such as 8, 16 or 32. Any number of vector processors may be used as shown in Table 7-1 (we suggest use of an even number to accommodate special operations such as 32-bit multiplies and complex multiplies). A subset of the outputs of the rotation network (used to rotate the un-aligned vector read from memory to be aligned when presented to the processors), would be used if there are fewer processors than a power of 2. Note, the size/depth of the rotation network must be based on the power of two greater than or equal to number of processors.

TABLE 7-1
Vector Element/Memory Width Selections

| Vector Elements | Memory Width |
|---|---|
| 2 | 2 |
| 4 | 4 |
| 6 | 7 |
| 8 | 8 |
| 10 | 11 |
| 12 | 13 |
| 14 | 15 |
| 16 | 16 |
| 18 | 19 |
| 20 | 22 |
| 22 | 23 |
| 24 | 25 |
| 26 | 27 |
| 28 | 29 |
| 30 | 31 |
| 32 | 32 |

(Table may be continued if necessary)

7.2 Memory Width

The memory width may be rather flexibly selected. The choice of a power of 2 width is used for the convenience of mapping an address to a line and to a word within the line. With power of 2 width, the address is mapped simply by using some bits to select the line and other bits to select the word in the line. Use of non-power of 2 width requires a more elaborate mapping procedure.

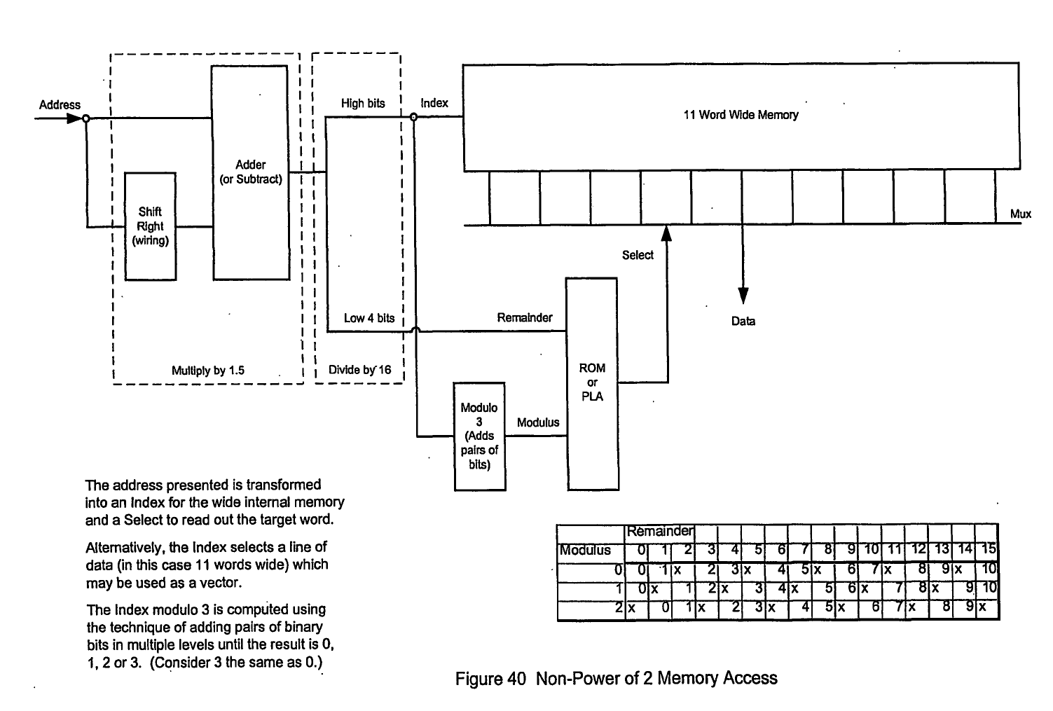

For the purposes of illustration, an example using an 11 word-wide memory line was developed and shown in FIG. 40. The mapping process consists of the step of multiplying the address by a binary fractional number between 1 and 2. This operation may be performed by adding. (or subtracting) a shifted version of the address. The address is then divided by a power of 2 (16 in this example) thereby splitting the address into an index and remainder. The index is used to access a line from the memory. A modulus of the index with respect to the modulo is also computed. Together, the modulus and the remainder are used in a programmable logic array PLA) or a ROM to determine the selector value for reading the desired word.

The values of modulo and the fractional multiplier are related. All fractional multipliers satisfying the range requirement are of the form numerator/denominator where the denominator is a power of 2. The spreadsheet illustrates some examples for the fractional multiplier in the first two columns, labeled “Numerator” and “Denominator”. The third column, labeled “Times”, is the actual fractional multiplier used to multiply the address. The fourth column, labeled “Divide”, is used for splitting the index from the remainder. The fifth column, labeled Repeats”, computes the periodicity of the addressing pattern. Its value is the product of “Denominator” and “Divide”. The sixth column, “Modulo”, is the same as the “Numerator”. The seventh column, labeled “Computed Width”, is the division of “Repeats” and “Modulo”. This number is truncated up (ceiling) in the eighth column, the labeled “Hardware Width”. The ninth column, labeled “Extra Space”, computes the unused space as an average per line.

TABLE 7-2
Computation of Memory Width and Processor Elements

| Fraction | | | | | | Computed | Hardware | Extra |
|---|---|---|---|---|---|---|---|---|
| Numerator | Denominator | Times | Divide | Repeats | Modulo | Width | Width | Space |
| 3 | 2 | 1.5 | 16 | 32 | 3 | 10.66667 | 11 | 0.333333 |
| 9 | 8 | 1.125 | 16 | 128 | 9 | 14.22222 | 15 | 0.777778 |
| 3 | 2 | 1.5 | 8 | 16 | 3 | 5.333333 | 6 | 0.666667 |
| 5 | 4 | 1.25 | 16 | 64 | 5 | 12.8 | 13 | 0.2 |
| 7 | 4 | 1.75 | 16 | 64 | 7 | 9.142857 | 10 | 0.857143 |

The example shown in FIG. 40 uses the first row of the Table 7-2. The fractional multiplier is 3/2 which is easily implemented by an adder which uses a right shifted input of the first operand for the second operand. The resulting address is then split with the low four bits used as the remainder and the upper bits as the index into the memory. This effective implements a divide by 16. The pattern of remainder values is repetitive and in this example repeats after 32 addresses. Within each pattern of remainder values, the value of modulo (which is the numerator of 3/2, or in this case the value 3), governs the number of remainder values. Together, the modulus (computed from the index and modulo) and the remainder determine a mapping to select a data memory word from the line read from memory.

Obviously, this may also be used for controlling which word to write into memory. Further, in addition to selecting a single data word, this may be used for selecting the start address of a vector. This is of particular interest for a vector processor.

The spreadsheets enumerate the addressing process for each of the 5 combinations of numerator and denominator. These implement the procedures as described above. A modification for the alternative procedures given below is quite straightforward.

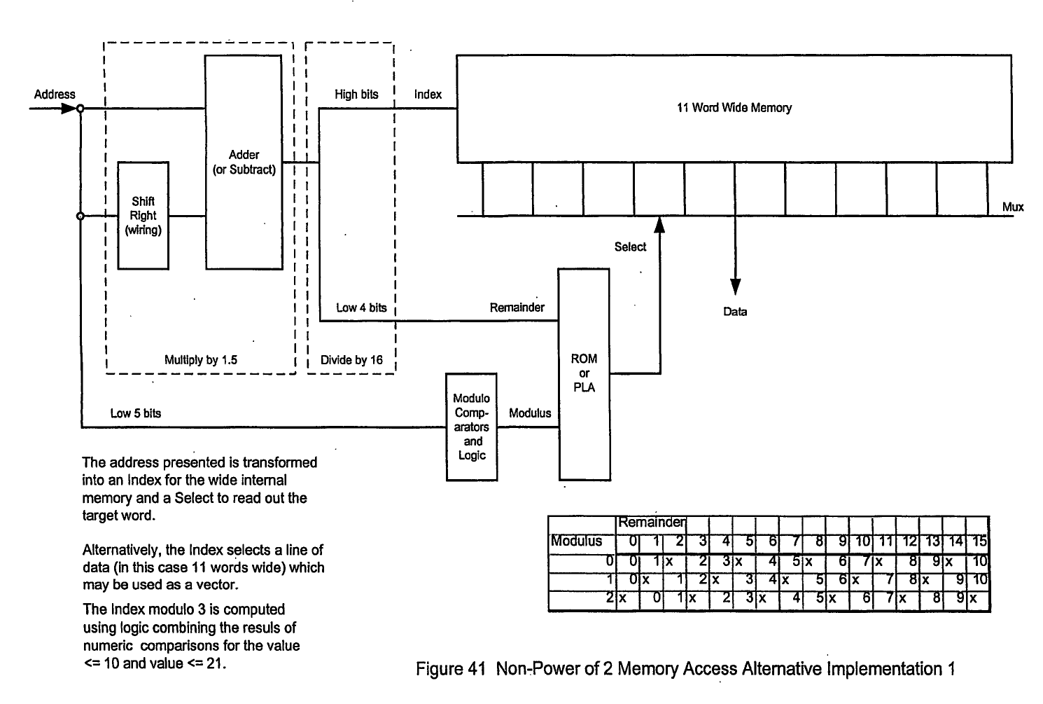

Alternative implementations may use the knowledge of the periodicity of the addressing pattern. The first alternative implementation suggested in FIG. 41 uses the low 5 bits of the original address (the periodicity of this solution is 32) and determines the “Modulus” as if it was computed from “Index”. This requires only two compares for less than or equal to (or just less than or the complementary greater than compares) for the values 10 and 21. If the low 32 bits are less than or equal to 10 in numeric value, the Modulus would be 0. If the low 32 bits are greater than 10, but less than or equal to 21 in numeric value, the Modulus would be 1. Otherwise, the Modulus is 2. This Modulus may be used in the same PLA or ROM as before.

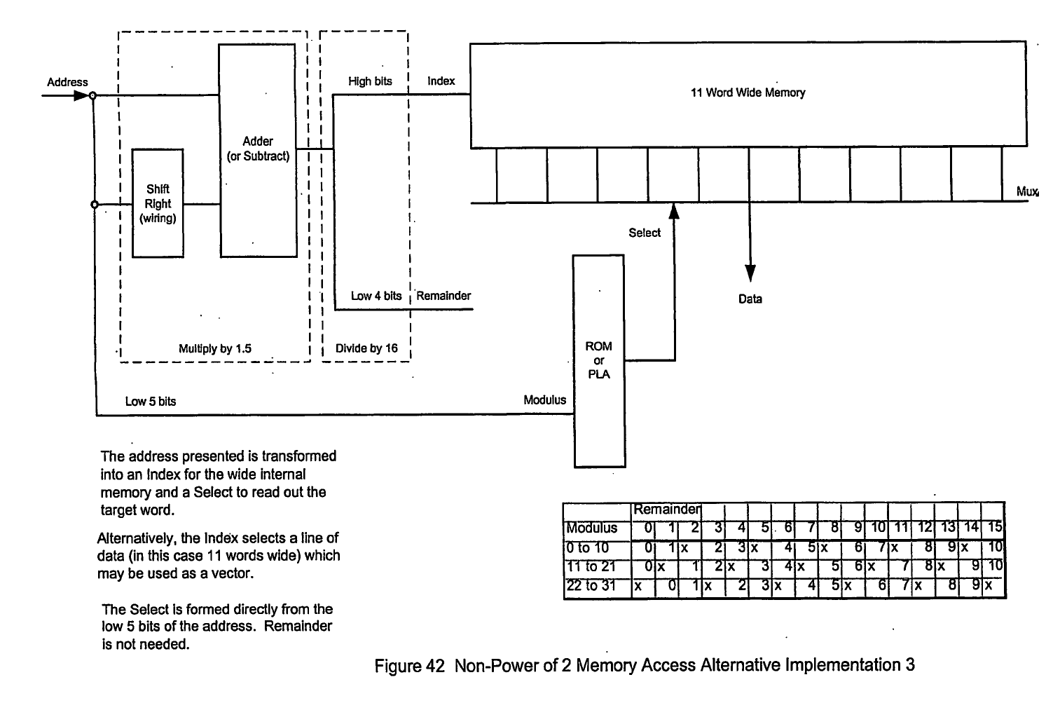

The second alternative implementation, shown in FIG. 42, applies the low 5 bits of the address directly to the PLA or ROM. The Modulus computation is eliminated in this case. In fact, the “Remainder” bits are redundant to the full information encoded in the low 5 bits of the address. Only the low 5 bits of the address are needed to select the desired word from the memory.

7.3 Selection Choices

The use of the fractional memory mapping techniques designed above allows many choices for the word width. Simply using common fractional multipliers from 9/8 to 15/8 and a divide by 16 allows for 9, 10, 11, 12, 13 and 15 word-wide memory. The only choice missing is 14 and with 16 being so close, this would probably be a better choice than 15. Using same fractional multipliers with a divide by 16 allows for 18, 19, 20, 22, 24, 26 and 29 word-wide memory.

Unless no space is lost (only for powers of 2), the number of vector processors, i.e. the vector length, must be less than the memory width using the fractional mapping technique. This is a result of the occasional unused word of a line. The hardware use to read and deliver a vector in the proper order must compensate for this unused word.

7.4 Modified Router Network

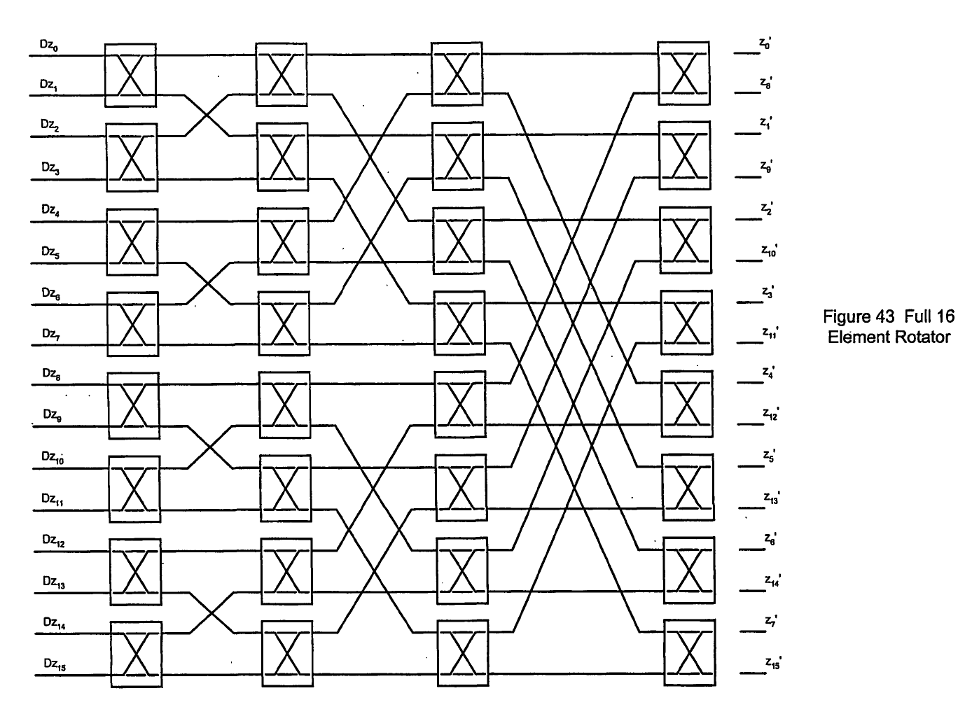

When the rotator network is not presented with a full power of two inputs and outputs, a reduced complexity router may be used. The reduced complexity router is derived from the nearest largest router. In addition to reducing the router complexity, a simple circuit is used to reposition neighboring elements over an “unused” word in a line skipped because of the fractional memory mapping. FIG. 43 shows a full interconnection network for 16 inputs and 16 outputs that would be used for routing 16 memory words to up to 16 vector-processing units.

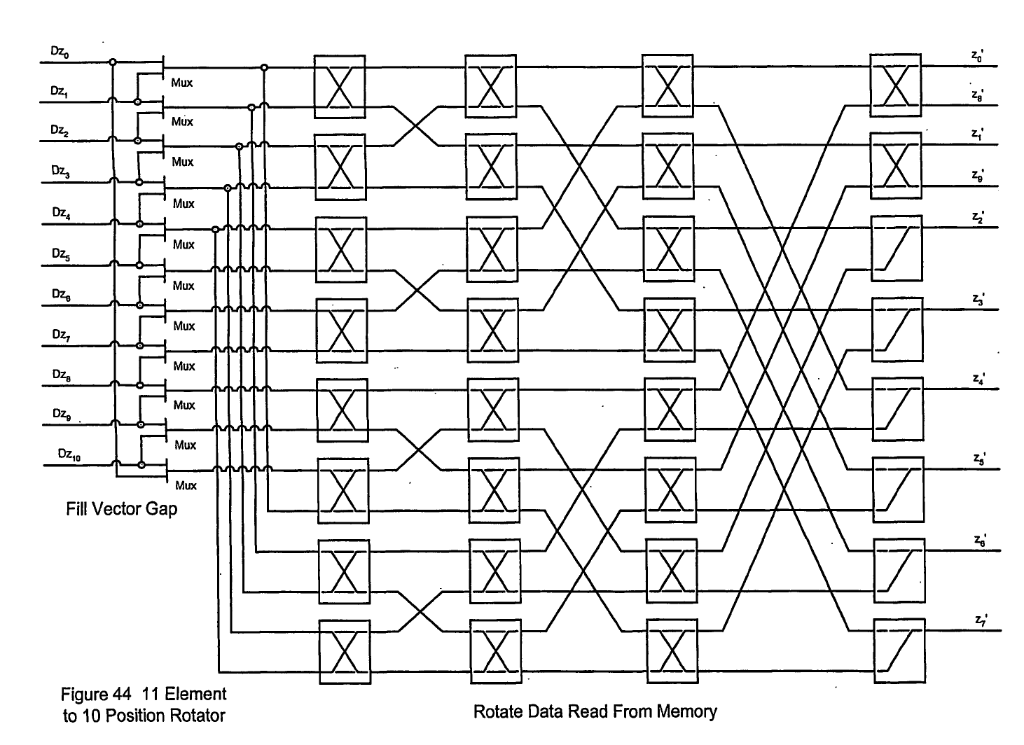

FIG. 44 shows the reduced complexity router formed by retaining 11 inputs and 10 outputs. This figure also shows the logic for filling the gap in a vector due to an unused word in a line and the connection to a routing network for delivering the data to the vector processor units. This example works with the fractional mapping hardware shown in FIG. 40,41 or 42. The memory line width is 11 words (times 2 actually since double length vectors are fetched). The number of processors is 10. The required concurrent interconnections have been analyzed and all alignments of the vector start address to the nominal vector processor units can be concurrently accommodated.

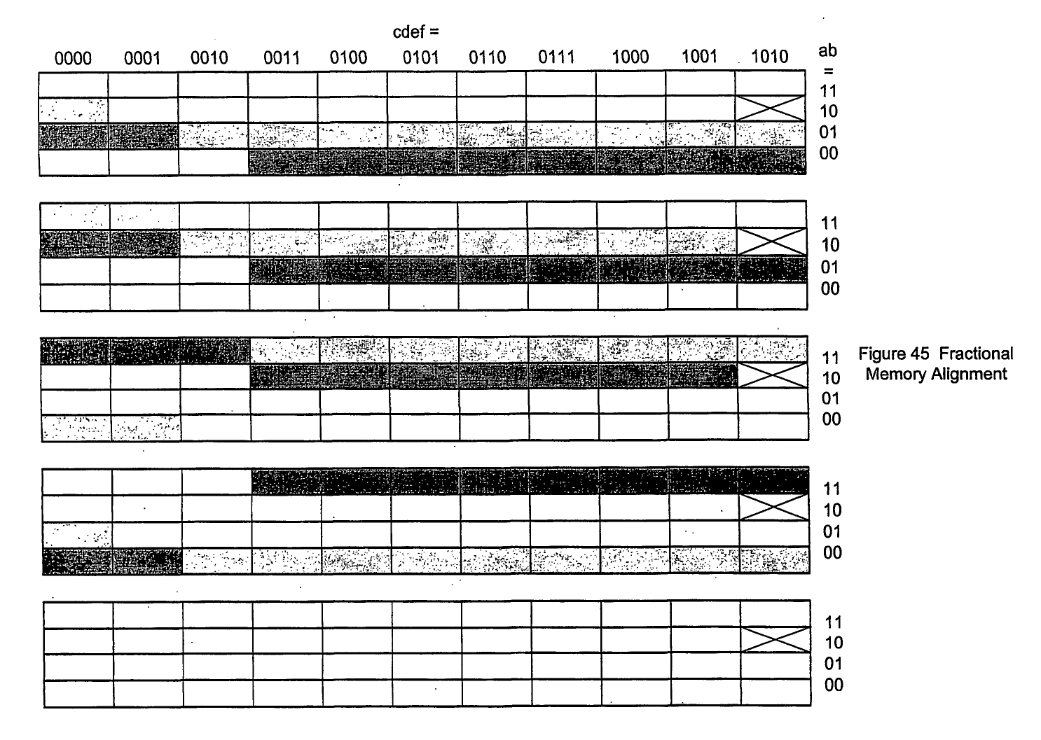

FIG. 45 shows the fractional memory mapping alignment for a exemplar vector access including the effect of the unused vector location (indicated by a “x” across the memory cell).

7.5 Algorithm Description

Mathematically; the process to determine combination of Memory width and number of Processor elements is the following:

1) Choose a Numerator (N)

2) Choose a Denominator (D) where D<N and D is a power of 2

3) Choose a Divide Factor (F) as a power of 2

4) The pattern of mapping addresses to lines and offsets will Repeat (R) every D*F

5) The Modulo is equal to N

6) The Memory width (M) is ceiling ((D*F)/N)

7) The number of Processors (P) is floor ((D*F)/N) and P<M except for P, M as a power of 2

Inputs

N—Numerator

D—Denominator (a power of 2) and less than N

F—Divide Factor (a power of 2)

Outputs

R—Repeat periodicity

M—Memory width

P—Number of processor elements

Algorithm

R=D*F

M=ceiling ((D*F)/N)

P=floor ((D*F)/N)

The process to convert linear addresses to a memory line number and offset within line is the following:

1. The Address (A) is multiplied by N/D which should be formed by adding/subtracting a shifted version of A to itself.

2. Form a Line Number (L) by “dividing” ((A*N)/D) by F where F is a power of 2 and the division is simply selecting higher order address bits

3. Either of the following:

A. Form an Offset (O) as ((A mod R) mod ceiling (R/N))

B. Create an Offset look-up table using the values 0 to (R−1) as an Index (I) (selected directly from the low bits of A as R is a power of 2) and producing the value (I mod ceiling (R/N)) as the output value.

C. Create a Programmable or Fixed Function Logic Array to perform the equivalent of the look-up table.

Inputs

N—Numerator

D—Denominator (a power of 2) and less than N

F—Divide Factor (a power of 2)

R—Repeat periodicity

A—Address to be mapped

Outputs

L—Line Number

O—Offset within Line

Algorithm

| | |
|---|---|
| L = ((A * N) / D) / F | /* Division performed by shifting since |
| | D and F are powers of 2 */ |

| | |
|---|---|
| O = ((A mod R) mod ceiling (R / N)) | /* (A mod R) is computed |

by isolating low order
bits of A as R is
a power of 2 */

Conventions

ceiling (Q) returns the next larger whole integer of the parameter, Q

floor (Q) returns the integer value of the parameter, Q, discarding any fractional values

A mod B returns the remainder of A/B.

This simple process forms a line number without significant computations avoiding all multiplications and divisions. It only requires additional and shifts. The offset is also easily computed and may be generated by a fixed function Programmable Logic Array (PLA) or a small look-up table (ROM). The use of an actual division at run-time can be completely avoided.

Accordingly, a processor as described herein may implement a method to address a memory line of a non-power of 2 multi-word wide memory in response to a linear address. The method may involve shifting the linear address by a fixed number of bit positions, and using high order bits of a sum of the shifted linear address and the unshifted linear address to address a memory line. The linear address may be shifted to the right or the left to achieve the desired position.

As shown in FIG. 40, in an alternative method, the method may involve shifting the linear address by a fixed number of bit positions, adding the shifted linear address to the unshifted linear address to form an intermediate address, retaining a subset of high order address bits of the intermediate address as a modulo index, and using low order address bits of the intermediate address and the modulo index in a conversion process to obtain a starting position within a selected memory line. The conversion process may use a look-up table or a logic array.

As shown in FIG. 41, in a further alternative method, the method may involve shifting the linear address by a fixed number of bit positions, adding the shifted linear address to the unshifted linear address to form an intermediate address, retaining a subset of low order address bits of the intermediate address as a modulo index, and using the modulo index in a conversion process to obtain a starting position within a selected memory line.

As shown in FIG. 42, in an alternative method, the method may involve isolating a subset of low order address bits of the linear address as a modulo index, and using the modulo index in a conversion process to obtain a starting position within a selected memory line.

What is claimed is:

1. A method of performing both vector processing and superscalar register processing in a vector processor, comprising:
fetching instructions from an instruction stream, the instruction stream comprising vector instructions and register instructions;
determining a type of a fetched instruction;
if the fetched instruction is a vector instruction, routing the vector instruction to decoders of the vector processor in accordance with functional units used by the vector instruction; and
if the fetched instruction is a register instruction, determining a vector element slice of the vector processor that is associated with the register instruction, determining one or more functional units that are associated with the register instruction, and routing the register instruction to said functional units of the vector element slice.

2. The method claimed in claim 1, wherein routing the register instruction to functional units of the vector element slice comprises routing the register instruction to instruction decoders associated with said functional units and said vector element slice.

3. A vector processor for providing both vector processing and superscalar register processing, comprising:
a plurality of vector element slices, each comprising a plurality of functional units;
a plurality of instruction decoders, each associated with a functional unit of one of said vector element slices, for providing instructions to an associated functional unit;
a vector instruction router for routing a vector instruction to all instruction decoders associated with functional units used by said vector instruction; and
a register instruction router for routing a register instruction to instruction decoders associated with a vector element slice and functional units associated with said register instruction.

4. A method in a vector processor for creating Very Long Instruction Words (VLIW) from component instructions, comprising:
fetching a set of instructions from an instruction stream, the instruction stream comprising VLIW component instructions;
identifying said VLIW component instructions according to their respective functional units;
determining a group of VLIW component instructions that may be assigned to a single VLIW; and,
assigning the component instructions of the group to a specific positions of a VLIW instruction according to their respective functional units.

5. The method claimed in claim 4, wherein identifying VLIW component instructions is preceded by determining whether each of fetched instructions is a VLIW component instruction.

6. The method claimed in claim 5, wherein determining whether a fetched instruction is a VLIW component instruction is based on an instruction type and an associated functional unit of the instruction, and
wherein instruction types of said instructions comprise vector instructions and register instructions.

7. The method claimed in claim 6, wherein said instruction types further comprise load instructions and control instructions.

8. The method claimed in claim 4, wherein said component instructions include vector instructions.

9. The method claimed in claim 4, wherein said component instructions include register instructions.

10. A method of designing a vector processor that forms Very Long Instruction Words (VLIW) from VLIW component instructions of an instruction stream, comprising:
defining a set of VLIW component instructions, each component instruction being associated with a functional unit of the vector processor;
defining grouping rules for VLIW component instructions that associate component instructions that may be executed in parallel; and,
defining associations between VLIW component instructions and specific positions of a VLIW instruction based on the functional unit of the component instruction.

11. A vector processor that forms Very Long Instruction Words (VLIW) from VLIW component instructions of an instruction stream, comprising:
a plurality of vector element slices, each comprising a plurality of functional units;
a plurality of instruction decoders, each associated with a functional unit of one of said vector element slices, for providing instructions to an associated functional unit;
a plurality of routers, each associated with a type of said functional units, for routing instructions to a decoder associated with a functional unit of the routed instruction;
a plurality of pipeline registers, each corresponding to a type of said functional units, for storing instructions provided by instruction decoders corresponding to the same type of functional unit, and
a plurality of instruction grouping decoders, for receiving instructions from an instruction stream and providing groups of VLIW component instructions of said stream to said plurality of routers,
wherein a VLIW instruction is comprised of instructions stored in respective pipeline registers.

12. A method to deliver an instruction window, comprising a set of instructions, to a superscalar instruction decoder comprising:
fetching two adjacent lines of instructions that together contain a set of instructions to be delivered to the superscalar instruction decoder, each of said lines being at least the size of the set of instructions to be delivered; and,
reordering the positions of instructions of the two adjacent lines so as to position first and subsequent elements of the set of instructions to be delivered into first and subsequent positions corresponding to first and subsequent positions of the superscalar instruction decoder.

13. The method claimed in claim 12, wherein reordering the positions of said instructions comprises rotating the positions of said instructions within the two adjacent lines.

14. The method claimed in claim 12, wherein the first line comprises a portion of said set of instructions and the second line comprising a remaining portion of said set of instructions.

15. A method to deliver a set of instructions to a superscalar instruction decoder comprising:
obtaining a line of instructions containing at least a set of instructions to be provided to the superscalar instruction decoder;
providing the line of instructions to a rotator network along with a starting position of said set of instructions within the line, the rotator network having respective outputs coupled to inputs of a superscalar instruction decoder; and,
controlling the rotator network in accordance with the starting position of the set of instructions to output the first and subsequent instructions of the set of instructions to first and subsequent inputs of the superscalar decoder.

16. A method to deliver an instruction window, comprising a set of instructions, to a superscalar instruction decoder comprising:
obtaining at least a portion of a first line of instructions containing at least a portion of a set of instructions to be delivered to the superscalar instruction decoder;
obtaining at least a portion of a second line of instructions containing at least a remaining portion of said set of instructions;
providing the first and second lines of instructions to a rotator network along with a starting position of said set of instructions, the rotator network having respective outputs coupled to inputs of a superscalar instruction decoder; and,
controlling the rotator network in accordance with the starting position of the set of instructions to output the first and subsequent instructions of the set of instructions to first and subsequent inputs of the superscalar decoder.

17. The method claimed in claim 16, wherein each line contains the same number of instruction words as contained in an instruction window.

18. The method claimed in claim 16, wherein each line contains more instruction words than contained in an instruction window.

19. An apparatus for providing instruction windows, comprising sets of instructions, to a superscalar instruction decoder, comprising:
a memory storing lines of superscalar instructions;
a rotator for receiving at least portions of two lines of superscalar instructions that together contain a set of instructions; and
a superscalar decoder having a set of inputs for receiving corresponding first and subsequent instructions of a superscalar instruction window,
the rotator network providing the first and subsequent superscalar instructions of the instruction window from within the at least portions of two lines of instructions to the corresponding inputs of the superscalar decoder.

20. The apparatus claimed in claim 19, wherein the rotator comprises a set of outputs corresponding in number to the number of superscalar instructions in a superscalar instruction window, the outputs further corresponding to positions of instructions within the at least portions of two lines of instructions within the rotator, and
wherein the rotator network reorders the instructions of the at least portions of two lines of superscalar instructions within the rotator network to associate the first and subsequent superscalar instructions of the superscalar instruction window with first and subsequent outputs of the rotator network coupled to corresponding inputs of the superscalar-decoder.

20. The apparatus claimed in claim 19, wherein the rotator reorders the positions of said instructions by rotating the instructions of the at least portions of two lines within the rotator.

21. The apparatus claimed in claim 19, wherein said reordering is performed in accordance with a known position of a first instruction of the instruction window within the at least portions of two lines.

22. A method to address a memory line of a non-power of 2 multi-word wide memory in response to a linear address comprising:
shifting the linear address by a fixed number of bit positions; and
using high order bits of a sum of the shifted linear address and the unshifted linear address to address a memory line.

23. The method claimed in claim 22, wherein the linear address is shifted to the right.

24. A method to obtain a starting position of a non-power of 2 multi-word wide memory in response to a linear address comprising:
shifting the linear address by a fixed number of bit positions;
adding the shifted linear address to the unshifted linear address to form an intermediate address;
retaining a subset of high order address bits of the intermediate address as a modulo index; and,
using low order address bits of the intermediate address and said modulo index in a conversion process to obtain a starting position within a selected memory line.

25. The method claimed in claim 24, wherein said conversion process uses a look-up table.

26. The method claimed in claim 24, wherein said conversion process uses a logic array.

27. A method to obtain a starting position of a non-power of 2 multi-word wide memory in response to a linear address comprising:
shifting the linear address by a fixed number of bit positions;
adding the shifted linear address to the unshifted linear address to form an intermediate address;
retaining a subset of low order address bits of the intermediate address as a modulo index; and,
using said modulo index in a conversion process to obtain a starting position within a selected memory line.

28. A method to obtain a starting position of a non-power of 2 multi-word wide memory in response to a linear address comprising:
isolating a subset of low order address bits of the linear address as a modulo index; and,
using said modulo index in a conversion process to obtain a starting position within a selected memory line.

29. A device for performing an operation on first and second operand data having respective operand formats, comprising:
a first hardware register specifying a type attribute representing an operand format of the first data;
a second hardware register specifying a type attribute representing an operand format of the second data;
an operand matching logic circuit determining a common operand format to be used for both of the first and second data in performing said operation based on the first type attribute of the first data and the second type attribute of the second data; and
a functional unit performing the operation in accordance with the common operand type.

30. A method of providing data to be operated on by an operation, comprising:
specifying an operation type attribute representing an operation format of the operation;
specifying in a hardware register an operand type attribute representing an operand format of data to be used by the operation;
determining an operand conversion to be performed on the data to enable performance of the operation in accordance with said operation format based on said operation format and the operand format of the data; and
performing the determined operand conversion.

31. The method claimed in claim 30, wherein said operation type attribute is specified in a hardware register.

32. The method claimed in claim 30, wherein said operation type attribute is specified in a processor instruction.

33. The method claimed in claim 30, wherein said operation format is an operation operand format.

34. The method claimed in claim 30, wherein said operation format is an operation result format.

35. A method in a computer for providing an operation that is independent of data operand types, comprising:
specifying in a hardware register an operation type attribute representing an operation format;
specifying in a hardware register an operand type attribute representing a data operand format; and,
performing said operation in a functional unit of the computer in accordance with the specified operation type attribute and the specified operand type attribute.

36. The method claimed in claim 35, wherein said operation format is an operation operand format.

37. The method claimed in claim 35, wherein said operation format is an operation result format.

38. A method in a computer for providing an operation that is independent of data operand type, comprising:
specifying in a hardware register an operand type attribute representing a data operand format of said data operand; and,
performing said operation in a functional unit of the computer in accordance with the specified operand type attribute.

39. A method in a computer for providing an operation that is independent of data operand types, comprising:
specifying in a first hardware register an operand type attribute representing an operand format of a first data operand;
specifying in a second hardware register an operand type attribute representing an operand format of a second data operand;
determining in an operand matching logic circuit a common operand format to be used for both of the first and second data in performing said operation based on the first type attribute of the first data and the second type attribute of the second data;
performing said operation in a functional unit of the computer in accordance with the determined common operand.

40. A method for performing operand conversion in a computer device, comprising:
specifying in a hardware register an original operand type attribute representing an original operand format of operand data;
specifying in a hardware register a converted operand type attribute representing a converted operand format to which the operand data is to be converted; and,
converting the data from the original operand format to the converted operand format in an operand format conversion logic circuit in accordance with the original operand type attribute and the converted operand type attribute.

41. The method claimed in claim 40, wherein said operand conversion occurs automatically when a standard computational operation is requested.

42. The method claimed in claim 40, wherein said operand conversion implements sign extension for an operand having an original operand type attribute indicating a signed operand.

43. The method claimed in claim 40, wherein said operand conversion implements zero fill for an operand having an original operand type attribute indicating an unsigned operand.

44. The method claimed in claim 40, wherein said operand conversion implements positioning for an operand having an original operand type attribute indicating operand position.

45. The method claimed in claim 40, wherein said operand conversion implements positioning for an operand in accordance with a converted operand type attribute indicating a converted operand position.

46. The method claimed in claim 40, wherein said operand conversion implements one of fractional, integer and exponential conversion for an operand according to said original operand type attribute.

47. The method claimed in claim 40, wherein said operand conversion implements one of fractional, integer and exponential conversion for an operand according to said converted operand type attribute.

48. A method to conditionally perform operations on elements of a vector, comprising:
generating a vector enable mask comprising a plurality of bits, each bit corresponding to a respective element of a vector;
generating a vector conditional mask comprising a plurality of bits, each bit corresponding to a respective element of a vector; and,
for each of said elements, applying logic to the vector enable mask bit and vector conditional mask bit that correspond to that element to determine if an operation is to be performed for that element.

49. The method claimed in claim 49, wherein said logic requires the vector enable bit corresponding to an element to be set to enable an operation on the corresponding element to be performed.

50. A method to nest conditional controls for elements of a vector comprising:
generating a vector enable mask comprising a plurality of bits, each bit corresponding to a respective element of a vector;
generating a vector conditional mask comprising a plurality of bits, each bit corresponding to a respective element of a vector;
saving the vector enable mask to a temporary storage location;
generating a nested vector enable mask comprising a logical combination of the vector enable mask with the vector conditional mask; and
using the nested vector enable mask as a vector enable mask for a subsequent vector operation.

51. The method claimed in claim 50, wherein a logical combination uses a bitwise “and” operation.

52. The method claimed in claim 50, wherein a logical combination uses a bitwise “or” operation.

53. The method claimed in claim 50, wherein a logical combination uses a bitwise “not” operation.

54. The method claimed in claim 50, wherein a logical combination uses a bitwise “pass” operation.

55. A method to nest conditional controls for elements of a vector comprising:
generating a vector enable mask comprising a plurality of bits, each bit corresponding to a respective element of a vector;
generating a vector conditional mask comprising a plurality of bits, each bit corresponding to a respective element of a vector;
saving the vector enable mask to a temporary storage location;
generating a nested vector enable mask by performing a bitwise “and” of the vector enable mask with the vector conditional mask; and
using the nested vector enable mask as a vector enable mask for a subsequent vector operation.

56. A method to nest conditional controls for elements of a vector comprising:
generating a vector enable mask comprising a plurality of bits, each bit corresponding to a respective element of a vector;
generating a vector conditional mask comprising a plurality of bits, each bit corresponding to a respective element of a vector;
saving the vector enable mask to a temporary storage location;
generating a nested vector enable mask by performing a bitwise “and” of the vector enable mask with a bitwise “not” of the vector conditional mask; and
using the nested vector enable mask as a vector enable mask for a subsequent vector operation.

57. A method to improve responsiveness to program control operations in a processor with a long pipeline comprising:
providing a separate computational unit designed for program control operations;
positioning said separate computational unit early in the pipeline thereby reducing delays; and,
using said separate computation unit to produce a program control result early in the pipeline to control the execution address of a processor.

58. A method to improve the responsiveness to an operand address computation in a processor with a long pipeline comprising:
providing a separate computational unit designed for operand address computations;
positioning said separate computational unit early in the pipeline thereby reducing delays; and,
using said separate computation unit to produce a result early in the pipeline to be used as an operand address.

59. A vector processor comprising:
a vector of multipliers computing multiplier results; and
an array adder computational unit computing an arbitrary linear combination of said multiplier results.

60. The vector processor claimed in claim 59, wherein the array adder computational unit has a plurality of numeric inputs that are added, subtracted or ignored according to a control vector comprising the numeric values 1, −1 and 0, respectively.

61. The vector processor claimed in claim 59, wherein said array adder computational unit comprises at least 4 inputs.

62. The method claimed in claim 59, wherein said array adder computational unit comprises at least 8 inputs.

63. The method claimed in claim 59, wherein said array adder computational unit comprises at least 4 outputs.

64. A device for providing an indication of a processor attempt to access an address yet to be loaded or stored, comprising:
a current bulk transfer address register storing a current bulk transfer address;
an ending bulk transfer address register storing an ending bulk transfer address;
a comparison circuit coupled to the current bulk transfer address register and the ending bulk transfer address register, and to said processor, to provide a signal to the processor indicating whether an address received from the processor is between the current bulk transfer address and the ending bulk transfer address.

65. The device claimed in claim 64, wherein the device further produces a stall signal for stalling the processor until transfer to the address received from the processor is complete.

66. The device claimed in claim 64, wherein said the device further produces an interrupt signal for interrupting the processor to inform the processor that data at the address is unavailable.

67. A device for providing an indication of a processor attempt to access an address yet to be loaded or stored, comprising:
a current bulk transfer address register storing a current bulk transfer address;
a comparison circuit coupled to the current bulk transfer address register and to the processor to provide a signal to the processor indicating whether a difference between the current bulk transfer address and an address received from the processor is within a specified stall range.

68. The device claimed in claim 67, wherein the signal is a stall signal for stalling the processor until transfer to the address received from the processor is complete.

69. The device claimed in claim 67, wherein the signal is an interrupt signal for interrupting the processor to inform the processor that data at the address is unavailable.

70. A method of controlling processing in a vector processor, comprising:
receiving an instruction to perform a vector operation using one or more vector data operands; and
determining a number of vector data elements of the one or more vector data operands to be processed by the vector operation based on a number of vector data elements that constitute each vector data operand and a number of hardware elements available to perform the vector operation.

71. A method of controlling processing in a vector processor, comprising:
receiving instructions to perform a plurality of vector operations, each vector operation using one or more vector data operands;
for each of the plurality of vector operations, determining a number of vector data elements of each of the one or more vector data operands to be processed by the vector operation based on a number of vector data elements that constitute each vector data operand of the operation and a number of hardware elements available to perform the vector operation; and
determining a number of vector data elements to be processed by all of said plurality of operations by comparing the number of vector data elements to be processed for each respective vector operation.

72. A method in a vector processor to perform a vector operation on all data elements of a vector, comprising:
setting a 1 op counter to a number of vector data elements to be processed;
performing one or more vector operations on vector data elements of said vector;
determining a number of vector data elements processed by said vector operations;
subtracting the number of vector data elements processed from the loop counter;
determining, after said subtraction, whether additional vector data elements remain to be processed; and
if additional vector data elements remain to be processed, performing further vector operations on remaining data elements of said vector.

73. The method claimed in claim 72, further comprising reducing a number of vector data elements processed by said vector processor to accommodate a partial vector of data elements on a last loop iteration.

74. A method in a vector processor to reduce a number of operations performed for a last iteration of a processing loop, comprising:
setting a loop counter to a number of vector data elements to be processed;
performing one or more vector operations on data elements of said vector;
determining a number of vector data elements processed by said vector operations;
subtracting the number of vector data elements processed from the loop counter;
determining, after said subtraction, whether additional vector data elements remain to be processed; and
if additional vector data elements remain to be processed, and the number of additional vector data elements to be processed is less than a full vector of data elements, reducing one of available elements used to perform said vector operations and vector data elements available for the last loop iteration.

75. A method of controlling processing in a vector processor, comprising:
performing one or more vector operations on data elements of a vector;
determining a number of data elements processed by said vector operations; and
updating an operand address register by an amount corresponding to the number of data elements processed.

76. A method of performing a loop operation, comprising:
storing, in a match register, a value to be compared to a monitored register;
designating a register as said monitored register;
comparing the value stored in the match register with a value stored in the monitored register, and
responding to a result of said comparison in accordance with a program-specified condition by one of branching or repeating a desired sequence of program instructions, thereby forming a program loop.

77. The method claimed in claim 76, wherein said program specified condition is one of equal to, not equal to, less than, less than or equal to, greater than, or greater than or equal to.

78. The method claimed in claim 76, wherein said register to be monitored is an address register.

79. The method claimed in claim 76, wherein said program-specified condition is an absolute difference between the value stored in the match register and the value stored in the address register; and
wherein responding to the result of the comparison further comprises reducing a number of vector data elements to be processed on a last iteration of a loop.

80. A method of processing interrupts in a superscalar processor, comprising:
monitoring an interrupt line for a signal indicating an interrupt to the superscalar processor;
upon detection of an interrupt signal, fetching a group of instructions to be executed in response to the interrupt, and inhibiting in hardware an address update of a program counter; and
executing the group of instructions.

81. The method claimed in claim 80, wherein said group of instructions includes an instruction to disable further interrupts and an instruction to call a routine.

82. A method in a vector processor, comprising:
receiving an instruction;
determining whether a vector satisfies a condition specified in the instruction; and
if the vector satisfies the condition specified in the instruction, branching to a new instruction.

83. The method claimed in claim 82, wherein said condition comprises a vector element condition specified in at least one of a vector enable mask and a vector condition mask.

84. A method of providing a vector of data as a vector processor operand, comprising:
obtaining a line of data containing at least a vector of data to be provided as the vector processor operand;
providing the line of data to a rotator network along with a starting position of said vector of data within the line, the rotator network having respective outputs coupled to vector processor operand data inputs; and,
controlling the rotator network in accordance with the starting position of the vector of data to output the first and subsequent data elements of the vector of data to first and subsequent operand data inputs of the vector processor.

85. A method of providing a vector of data as a vector processor operand, comprising:
obtaining at least a portion of a first line of vector data containing at least a portion of a vector processor operand;
obtaining at least a portion of a second line of vector data containing at least a remaining portion of said vector processor operand;
providing the at least a portion of said first line of vector data and the at least a portion of said second line of vector data to a rotator network along with a starting position of said vector data, the rotator network having respective outputs coupled to vector processor operand data inputs; and,
controlling the rotator network in accordance with the starting position of the vector data to output the first and subsequent vector data elements to first and subsequent operand data inputs of the vector processor.

86. A method to read a vector of data for a vector processor operand comprising:
reading into a local memory device a series of lines from a larger memory;
obtaining from said local memory device at least a portion of a first line containing a portion of a vector processor operand;
obtaining from said local memory device at least a portion of a second line containing a remaining portion of said vector processor operand;
providing the at least a portion of said first line of vector data and the at least a portion of said second line of vector data to a rotator network along with a starting position of said vector data, the rotator network having respective outputs coupled to vector processor operand data inputs; and,
controlling the rotator network in accordance with the starting position of the vector data to output first and subsequent vector data elements to first and subsequent vector processor operand data inputs.
